(19) United States
(12) Patent Application Publication
(10) Pub. No.: US 2025/0224599 A1
(43) Pub. Date: Jul. 10, 2025

(54) VARIABLE MAGNIFICATION OPTICAL SYSTEM AND IMAGING APPARATUS

(71) Applicant: FUJIFILM Corporation, Tokyo (JP)

(72) Inventors: Takuya TANAKA, Saitama-shi (JP); Masato KONDO, Saitama-shi (JP); Masaru YONEZAWA, Saitama-shi (JP); Taiga NODA, Saitama-shi (JP)

(73) Assignee: FUJIFILM Corporation, Tokyo (JP)

(21) Appl. No.: 19/090,299

(22) Filed: Mar. 25, 2025

Related U.S. Application Data
(63) Continuation of application No. PCT/JP2023/033225, filed on Sep. 12, 2023.

(30) Foreign Application Priority Data
Sep. 27, 2022 (JP) 2022-154077

(51) Int. Cl. G02B 15/14; G02B 15/16

(52) U.S. Cl. CPC G02B 15/1441; G02B 15/16

(57) ABSTRACT

A variable magnification optical system consists of, in order from an object side, a first lens group having a positive refractive power, a second lens group having a negative refractive power, an intermediate group, and a final lens group having a refractive power. The intermediate group consists of one or more and five or fewer lens groups. An aperture stop is disposed between a lens surface of the second lens group closest to the image side and a lens surface of the final lens group closest to the object side. The first lens group includes, in consecutive order from a position closest to the object side to an image side, a negative lens, and a positive lens. The variable magnification optical system satisfies a predetermined conditional expression.

### CROSS-REFERENCE TO RELATED APPLICATIONS

This application is a continuation application of International Application No. PCT/JP2023/033225, filed on Sep. 12, 2023, which claims priority from Japanese Patent Application No. 2022-154077, filed on Sep. 27, 2022. The entire disclosure of each of the above applications is incorporated herein by reference.

### BACKGROUND

### Technical Field

The disclosed technology relates to a variable magnification optical system and an imaging apparatus.

### Related Art

In the related art, zoom lenses according to JP2016-109720A, JP2016-109721A, and JP2021-009217A are known as variable magnification optical systems usable in an imaging apparatus such as a digital camera.

### SUMMARY

There is a demand for a variable magnification optical system that is configured to be reduced in size, has a small F-number in the entire magnification range, and has high optical performance in the entire magnification range. A level of such a demand is increasing every year.

The present disclosure provides a variable magnification optical system that is reduced in size, has a small F-number in the entire magnification range, and has high optical performance in the entire magnification range, and an imaging apparatus comprising the variable magnification optical system.

According to an aspect of the present disclosure, there is provided a variable magnification optical system consisting of, in order from an object side to an image side, a first lens group having a positive refractive power, a second lens group having a negative refractive power, an intermediate group, and a final lens group having a refractive power, in which the intermediate group consists of one or more and five or fewer lens groups, during changing magnification, a spacing between the first lens group and the second lens group changes, a spacing between the second lens group and the intermediate group changes, and a spacing between the intermediate group and the final lens group changes, in a case where the intermediate group consists of a plurality of lens groups, all spacings between adjacent lens groups in the intermediate group change during changing the magnification, an aperture stop is disposed between a lens surface of the second lens group closest to the image side and a lens surface of the final lens group closest to the object side, the first lens group includes, in consecutive order from a position closest to the object side to the image side, a first lens that is a negative lens, and a second lens that is a positive lens, and in a case where a distance on an optical axis from a surface of the first lens on the object side to the aperture stop in a state where an infinite distance object is in focus at a wide angle end is denoted by DDL1STw, a sum of a distance on the optical axis from the surface of the first lens on the object side to a lens surface of the final lens group closest to the image side and a back focus of the entire system as an air conversion distance in the state where the infinite distance object is in focus at the wide angle end is denoted by TLw, an open F-number in a state where the infinite distance object is in focus at a telephoto end is denoted by Fnot, a focal length of the entire system in the state where the infinite distance object is in focus at the telephoto end is denoted by ft, a focal length of the entire system in the state where the infinite distance object is in focus at the wide angle end is denoted by fw, the back focus of the entire system as the air conversion distance at the wide angle end is denoted by Bfw, and a maximum half angle of view in the state where the infinite distance object is in focus at the telephoto end is denoted by ot, Conditional Expressions (1), (2), and (3) are satisfied, which are represented by

$$0 < DDL 1 STw / TLw < 0.5 , \qquad ( 1 )$$

$$0.5 < Fnot / ( ft / fw ) < 1.3 , and \qquad ( 2 )$$

$$0.15 < Bfw / ( ft \times tan ω t ) < 2. \qquad ( 3 )$$

The variable magnification optical system of the aspect preferably satisfies Conditional Expression (4) represented by

$$1 < fw / ( ft \times tan ω t ) < 1.4 . \qquad ( 4 )$$

In a case where a focal length of the first lens group is denoted by f1, and a combined focal length of an optical system from the first lens to the aperture stop in the state where the infinite distance object is in focus at the wide angle end is denoted by fL1STw, the variable magnification optical system of the aspect preferably satisfies Conditional Expression (5) represented by

$$- 6.6 < f 1 / fL 1 STw < - 1.5 . \qquad ( 5 )$$

In a case where a focal length of the first lens group is denoted by f1, and a focal length of the first lens is denoted by fL1, the variable magnification optical system of the aspect preferably satisfies Conditional Expression (6) represented by

$$- 0.9 < f 1 / fL 1 < - 0.05 . \qquad ( 6 )$$

In a case where a combined focal length of an optical system from the first lens to the aperture stop in the state where the infinite distance object is in focus at the wide angle end is denoted by fL1STw, the variable magnification optical system of the aspect preferably satisfies Conditional Expression (7) represented by

$$- 1.4 < fw / fL 1 STw < - 0.3 . \qquad ( 7 )$$

In a case where a combined focal length of an optical system from the first lens to the aperture stop in the state where the infinite distance object is in focus at the wide angle end is denoted by fL1STw, a focal length of the first lens group is denoted by f1, and a focal length of the first lens is denoted by fL1, the variable magnification optical system of the aspect preferably satisfies Conditional Expressions (4), (5), (6), and (7) represented by

$$1 < fw / ( ft \times tan ω t ) < 1.4 , \qquad ( 4 )$$

$$- 6.6 < f 1 / fL 1 STw < - 1.5 , \qquad ( 5 )$$

$$- 0.9 < f 1 / fL 1 < - 0.05 , and \qquad ( 6 )$$

$$- 1.4 < fw / fL 1 STw < - 0.3 . \qquad ( 7 )$$

The variable magnification optical system of the aspect preferably satisfies Conditional Expression (8) represented by

$$2 < TLw / ( ft \times tan ω t ) < 9. \qquad ( 8 )$$

In a case where a lateral magnification of the second lens group in the state where the infinite distance object is in focus at the telephoto end is denoted by β2t, and a lateral magnification of the second lens group in the state where the infinite distance object is in focus at the wide angle end is denoted by β2w, the variable magnification optical system of the aspect preferably satisfies Conditional Expression (9) represented by

$$1.1 < β 2 t / β 2 w < 3. \qquad ( 9 )$$

In a case where a spacing on the optical axis between the first lens group and the second lens group in the state where the infinite distance object is in focus at the wide angle end is denoted by DDG12w, a spacing on the optical axis between the first lens group and the second lens group in the state where the infinite distance object is in focus at the telephoto end is denoted by DDG12t, and a sum of the distance on the optical axis from the surface of the first lens on the object side to the lens surface of the final lens group closest to the image side and the back focus of the entire system as the air conversion distance in the state where the infinite distance object is in focus at the telephoto end is denoted by TLt, the variable magnification optical system of the aspect preferably satisfies Conditional Expression (10) represented by

$$0.1 < \vert DDG 12 w - DDG 12 t \vert / TL t < 0.3 . \qquad ( 10 )$$

In a case where a focal length of the first lens group is denoted by f1, the variable magnification optical system of the aspect preferably satisfies Conditional Expression (11) represented by

$$0.2 < DDL 1 STw / f 1 < 0.8 . \qquad ( 11 )$$

In a case where a maximum half angle of view in the state where the infinite distance object is in focus at the wide angle end is denoted by ow, the variable magnification optical system of the aspect preferably satisfies Conditional Expression (12) represented by

$$3 < DDL 1 STw / \{ ( fw \times tan ω w ) \times log ( ft / fw ) \} < 9. \qquad ( 12 )$$

The variable magnification optical system of the aspect preferably satisfies Conditional Expression (13) represented by

$$3 < TLw / fw < 8. \qquad ( 13 )$$

In a case where a sum of the distance on the optical axis from the surface of the first lens on the object side to the lens surface of the final lens group closest to the image side and the back focus of the entire system as the air conversion distance in the state where the infinite distance object is in focus at the telephoto end is denoted by TLt, the variable magnification optical system of the aspect preferably satisfies Conditional Expression (14) represented by

$$1.5 < TLt / ft < 3. \qquad ( 14 )$$

In a case where a sum of the distance on the optical axis from the surface of the first lens on the object side to the lens surface of the final lens group closest to the image side and the back focus of the entire system as the air conversion distance in the state where the infinite distance object is in focus at the telephoto end is denoted by TLt, the variable magnification optical system of the aspect preferably satisfies Conditional Expression (15) represented by

$$5 < TLt / ( ft \times tan ω t ) < 11. \qquad ( 15 )$$

In a case where a focal length of the first lens group is denoted by f1, the variable magnification optical system of the aspect preferably satisfies Conditional Expression (16) represented by

$$3 < f 1 / fw < 7. \qquad ( 16 )$$

In a case where a focal length of the first lens group is denoted by f1, and a focal length of the second lens group is denoted by f2, the variable magnification optical system of the aspect preferably satisfies Conditional Expression (17) represented by

$$3 < f 1 / ( - f 2 ) < 9. \qquad ( 17 )$$

In a case where a focal length of the first lens group is denoted by f1, the variable magnification optical system of the aspect preferably satisfies Conditional Expression (18) represented by

$$2 < f 1 / ( ft / Fnot ) < 7. \qquad ( 18 )$$

In a case where a focal length of the first lens group is denoted by f1, the variable magnification optical system of the aspect preferably satisfies Conditional Expression (19) represented by

$$1.8 < f 1 / {( fw \times ft )}^{1 / 2} < 4.2 . \qquad ( 19 )$$

In a case where a distance on the optical axis from the surface of the first lens on the object side to a paraxial entrance pupil position in the state where the infinite distance object is in focus at the wide angle end is denoted by Denw, and a maximum half angle of view in the state where the infinite distance object is in focus at the wide angle end is denoted by ow, the variable magnification optical system of the aspect preferably satisfies Conditional Expression (20) represented by

$$2 < Denw / \{ ( fw \times tan ω w ) \times log ( ft / fw ) \} < 4.5 . \qquad ( 20 )$$

In a case where a distance on the optical axis from the surface of the first lens on the object side to a paraxial entrance pupil position in the state where the infinite distance object is in focus at the wide angle end is denoted by Denw, the variable magnification optical system of the aspect preferably satisfies Conditional Expression (21) represented by

$$0.5 < Denw / {( fw \times ft )}^{1 / 2} < 1. \qquad ( 21 )$$

In a case where a center thickness of the first lens is denoted by dl, a distance on the optical axis from the lens surface of the first lens group closest to the object side to a paraxial entrance pupil position in the state where the infinite distance object is in focus at the wide angle end is denoted by Denw, and a maximum half angle of view in the state where the infinite distance object is in focus at the wide angle end is denoted by ow, the variable magnification optical system of the aspect preferably satisfies Conditional Expression (22) represented by

$$0.04 < d 1 / ( Denw \times tan ω w ) < 0.09 . \qquad ( 22 )$$

In a case where a distance on the optical axis from an image plane to a paraxial exit pupil position in the state where the infinite distance object is in focus at the wide angle end is denoted by Dexw, a sign of Dexw is positive for the distance on the image side and is negative for the distance on the object side with reference to the image plane, and in a case where an optical member not having a refractive power is disposed between the image plane and the paraxial exit pupil position, and Dexw is calculated using the air conversion distance for the optical member, the variable magnification optical system of the aspect preferably satisfies Conditional Expression (23) represented by

$$0.65 < fw / Dexw < - 0.2 . \qquad ( 23 )$$

In a case where an effective diameter of the surface of the first lens on the object side is denoted by EDf, and an effective diameter of the lens surface of the final lens group closest to the image side is denoted by EDr, the variable magnification optical system of the aspect preferably satisfies Conditional Expression (24) represented by

$$1.5 < EDf / EDr < 3. \qquad ( 24 )$$

In a case where an effective diameter of the surface of the first lens on the object side is denoted by EDf, the variable magnification optical system of the aspect preferably satisfies Conditional Expression (25) represented by

$$0.35 < EDf / TLw < 0.65 . \qquad ( 25 )$$

The variable magnification optical system of the aspect preferably satisfies Conditional Expression (26) represented by

$$2.2 < ft / fw < 4.8 . \qquad ( 26 )$$

In a case where a refractive index with respect to a d line for the first lens is denoted by NdL1, and an Abbe number based on the d line for the first lens is denoted by νdL1, the variable magnification optical system of the aspect preferably satisfies Conditional Expressions (27), (28), and (29) represented by

$$1.8 < NdL 1 < 2.01 , \qquad ( 27 )$$

$$15 < vdL 1 < 45 , and \qquad ( 28 )$$

$$2 < NdL 1 + 0.01 \times vdL 1 < 2.5 . \qquad ( 29 )$$

In a case where a refractive index with respect to a d line for the second lens is denoted by NdL2, and an Abbe number based on the d line for the second lens is denoted by νdL2, the variable magnification optical system of the aspect preferably satisfies Conditional Expressions (30), (31), and (32) represented by

$$1.43 < NdL 2 < 1.81 , \qquad ( 30 )$$

$$45 < vdL 2 < 96 , and \qquad ( 31 )$$

$$2 < NdL 2 + 0.01 \times vdL 2 < 2.5 . \qquad ( 32 )$$

It is preferable that the variable magnification optical system includes at least one focus group that moves during changing the magnification and during focusing, and in a case where a focal length of a focus group having a smallest absolute value of a focal length among the focus groups included in the variable magnification optical system is denoted by ffoc, and a focal length of the intermediate group in the state where the infinite distance object is in focus at the telephoto end is denoted by fMt, the variable magnification optical system of the aspect satisfies Conditional Expression (33) represented by

$$0.3 < \vert ffoc / fMt \vert < 4. \qquad ( 33 )$$

It is preferable that the variable magnification optical system of the aspect includes at least one focus group that moves during changing the magnification and during focusing, and in a case where a lateral magnification of a focus group having a largest absolute value of a focal length among the focus groups included in the variable magnification optical system in the state where the infinite distance object is in focus at the telephoto end is denoted by βft, and a combined lateral magnification of all lenses on the image side with respect to the focus group having the largest absolute value of the focal length in the state where the infinite distance object is in focus at the telephoto end is denoted by βfRt, the variable magnification optical system of the aspect satisfies Conditional Expression (34) represented by

$$1 < \vert ( 1 - {βft}^{2} ) \times β {fRt}^{2} \vert < 8. \qquad ( 34 )$$

One lens group among the lens groups included in the intermediate group may be configured to be a focus group that moves during changing the magnification and during focusing.

The focus group may be configured to consist of one positive lens and two negative lenses. In this configuration, in a case where a negative lens closest to the image side in the focus group is an aspherical lens, and in a case where a paraxial curvature radius of a surface of the aspherical lens on the object side is denoted by Rcnf, a paraxial curvature radius of a surface of the aspherical lens on the image side is denoted by Rcnr, a curvature radius of the surface of the aspherical lens on the object side at a position of a maximum effective diameter is denoted by Rynf, and a curvature radius of the surface of the aspherical lens on the image side at a position of a maximum effective diameter is denoted by Rynr, the variable magnification optical system of the aspect preferably satisfies Conditional Expression (35) represented by

$$0.1 < ( 1 / Rcnf - 1 / Rcnr ) / ( 1 / Rynf - 1 / Rynr ) < 3. \qquad ( 35 )$$

The focus group may be configured to consist of one negative lens and two positive lenses. In this configuration, in a case where a positive lens closest to the image side in the focus group is an aspherical lens, and in a case where a paraxial curvature radius of a surface of the aspherical lens on the object side is denoted by Rcpf, a paraxial curvature radius of a surface of the aspherical lens on the image side is denoted by Rcpr, a curvature radius of the surface of the aspherical lens on the object side at a position of a maximum effective diameter is denoted by Rypf, and a curvature radius of the surface of the aspherical lens on the image side at a position of a maximum effective diameter of the image side surface is Rypr, the variable magnification optical system of the aspect preferably satisfies Conditional Expression (36) represented by

$$- 120 < ( 1 / Rcpf - 1 / Rcpr ) / ( 1 / Rypf - 1 / Rypr ) < - 3. \qquad ( 36 )$$

The focus group may be configured to consist of one positive lens and one negative lens.

The focus group may be configured to consist of one negative lens. In this configuration, in a case where the negative lens of the focus group is an aspherical lens, and in a case where a paraxial curvature radius of a surface of the aspherical lens on the object side is denoted by Rcsnf, a paraxial curvature radius of a surface of the aspherical lens on the image side is Rcsnr, a curvature radius of the surface of the aspherical lens on the object side at a position of a maximum effective diameter is denoted by Rysnf, and a curvature radius of the surface of the aspherical lens on the image side at a position of a maximum effective diameter is denoted by Rysnr, the variable magnification optical system of the aspect preferably satisfies Conditional Expression (37) represented by

$$0.1 < ( 1 / Rcsnf - 1 / Rcsnr ) / ( 1 / Rysnf - 1 / Rysnr ) < 3.5 . \qquad ( 37 )$$

Two lens groups among the lens groups included in the intermediate group may be configured to be focus groups that move by changing a mutual spacing during changing the magnification and during focusing.

In a case where, out of the two lens groups which are the focus groups, a lens group disposed on the object side is referred to as an object side focus group, and a lens group disposed on the image side is referred to as an image side focus group, the object side focus group may be configured to consist of one negative lens and one positive lens, and the image side focus group may be configured to consist of one positive lens.

In this configuration, in a case where the positive lens of the image side focus group is an aspherical lens, and in a case where a paraxial curvature radius of a surface of the aspherical lens on the object side is denoted by Rcipf, a paraxial curvature radius of a surface of the aspherical lens on the image side is denoted by Rcipr, a curvature radius of the surface of the aspherical lens on the object side at a position of a maximum effective diameter is denoted by Ryipf, and a curvature radius of the surface of the aspherical lens on the image side at a position of a maximum effective diameter is denoted by Ryipr, the variable magnification optical system of the aspect preferably satisfies Conditional Expression (38) represented by

$$1 < ( 1 / Rcipf - 1 / Rcipr ) / ( 1 / Ryipf - 1 / Ryipr ) < 100. \qquad ( 38 )$$

In a case where, out of the two lens groups which are the focus groups, a lens group disposed on the object side is referred to as an object side focus group, and a lens group disposed on the image side is referred to as an image side focus group, the object side focus group may be configured to consist of one positive lens and one negative lens, and the image side focus group may be configured to consist of one negative lens.

In a case where the negative lens of the image side focus group is an aspherical lens, and in a case where a paraxial curvature radius of a surface of the aspherical lens on the object side is denoted by Rcinf, a paraxial curvature radius of a surface of the aspherical lens on the image side is Rcinr, a curvature radius of the surface of the aspherical lens on the object side at a position of a maximum effective diameter is denoted by Ryinf, and a curvature radius of the surface of the aspherical lens on the image side at a position of a maximum effective diameter is denoted by Ryinr, the variable magnification optical system of the aspect preferably satisfies Conditional Expression (39) represented by

$$0.1 < ( 1 / Rcinf - 1 / Rcinr ) / ( 1 / Ryinf - 1 / Ryinr ) < 3.5 . \qquad ( 39 )$$

The variable magnification optical system of the aspect may be configured to include a plurality of lens groups that move on the same moving path during changing the magnification from the wide angle end to the telephoto end.

The intermediate group preferably includes the aperture stop at the position closest to the object side.

The intermediate group may be configured to consist of, in order from the object side to the image side, a lens group having a positive refractive power, and a lens group having a negative refractive power, and the final lens group may be configured to have a positive refractive power.

The final lens group may be configured to be fixed with respect to an image plane during changing the magnification.

In a case where the final lens group consists of one positive lens that is an aspherical lens, and in a case where a paraxial curvature radius of a surface of the aspherical lens on the object side is denoted by RcEpf, a paraxial curvature radius of a surface of the aspherical lens on the image side is denoted by RcEpr, a curvature radius of the surface of the aspherical lens on the object side at a position of a maximum effective diameter is denoted by RyEpf, and a curvature radius of the surface of the aspherical lens on the image side at a position of a maximum effective diameter is denoted by RyEpr, the variable magnification optical system of the aspect preferably satisfies Conditional Expression (40) represented by

$$0.1 < \vert ( 1 / RcEpf - 1 / RcEpr ) / ( 1 / RyEpf - 1 / RyEpr ) \vert < 5. \qquad ( 40 )$$

The final lens group may be configured to move during changing the magnification.

The intermediate group may be configured to consist of, in order from the object side to the image side, a lens group having a positive refractive power, a lens group having a positive refractive power, and a lens group having a negative refractive power, and the final lens group may be configured to have a positive refractive power. In this configuration, the final lens group may be configured to move during changing the magnification.

The intermediate group may be configured to consist of, in order from the object side to the image side, a lens group having a positive refractive power, a lens group having a positive refractive power, and a lens group having a positive refractive power, and the final lens group may be configured to have a negative refractive power. In this configuration, the final lens group may be configured to move during changing the magnification.

The intermediate group may be configured to consist of, in order from the object side to the image side, a lens group having a positive refractive power, a lens group having a negative refractive power, and a lens group having a negative refractive power, and the final lens group may be configured to have a positive refractive power. In this configuration, the final lens group may be configured to move during changing the magnification.

The intermediate group may be configured to consist of, in order from the object side to the image side, a lens group having a positive refractive power, a lens group having a positive refractive power, a lens group having a positive refractive power, and a lens group having a positive refractive power, and the final lens group may be configured to have a negative refractive power. In this configuration, the final lens group may be configured to move during changing the magnification.

The intermediate group may be configured to consist of, in order from the object side to the image side, a lens group having a positive refractive power, a lens group having a positive refractive power, a lens group having a negative refractive power, and a lens group having a positive refractive power, and the final lens group may be configured to have a negative refractive power. In this configuration, the final lens group may be configured to move during changing the magnification.

The intermediate group may be configured to consist of, in order from the object side to the image side, a lens group having a positive refractive power, a lens group having a positive refractive power, a lens group having a negative refractive power, and a lens group having a negative refractive power, and the final lens group may be configured to have a positive refractive power. In this configuration, the final lens group may be configured to move during changing the magnification.

The intermediate group may be configured to consist of, in order from the object side to the image side, a lens group having a positive refractive power, a lens group having a positive refractive power, a lens group having a negative refractive power, a lens group having a negative refractive power, and a lens group having a positive refractive power, and the final lens group may be configured to have a negative refractive power. In this configuration, the final lens group may be configured to move during changing the magnification.

According to another aspect of the present disclosure, there is provided an imaging apparatus comprising the variable magnification optical system according to the aspect of the present disclosure.

In the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the illustrated constituents.

The term “group having a positive refractive power” and the expression “a group has a positive refractive power” in the present specification mean that the entire group has a positive refractive power. Similarly, the term “group having a negative refractive power” and the expression “a group has a negative refractive power” mean that the entire group has a negative refractive power. The terms “first lens group”, “second lens group”, “lens group”, “final lens group”, and “focus group” in the present specification are not limited to a configuration consisting of a plurality of lenses and may be a configuration consisting of only one lens.

A compound aspherical lens (a lens functioning as one aspherical lens as a whole, in which a spherical lens and a film of an aspherical shape formed on the spherical lens are configured to be integrated with each other) is not regarded as a cemented lens and is handled as one lens. Unless otherwise specified, a sign of a refractive power and a surface shape related to a lens including an aspherical surface in a paraxial region are used. For a sign of the curvature radius, a sign of the curvature radius of a surface having a convex shape facing the object side is positive, and a sign of the curvature radius of a surface having a convex shape facing the image side is negative.

In the present specification, the term “entire system” means the variable magnification optical system. The term “focal length” used in the conditional expressions is a paraxial focal length. Unless otherwise specified, the term “distance on the optical axis” used in the conditional expressions is a geometrical distance. Unless otherwise specified, values used in the conditional expressions are values based on the d line in the state where the infinite distance object is in focus.

The terms “d line”, “C line”, “F line”, and “g line” according to the present specification mean bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

According to the present disclosure, a variable magnification optical system that is reduced in size, has a small F-number in the entire magnification range, and has high optical performance in the entire magnification range, and an imaging apparatus comprising the variable magnification optical system can be provided.

### BRIEF DESCRIPTION OF THE DRAWINGS

FIG. 1 is a diagram that corresponds to a variable magnification optical system of Example 1 and that illustrates a cross-sectional view and a moving path of a configuration of a variable magnification optical system according to one embodiment.

FIG. 2 is a diagram for describing symbols of conditional expressions.

FIG. 3 is a diagram for describing positions of an effective diameter and a maximum effective diameter.

FIG. 4 is each aberration diagram of the variable magnification optical system of Example 1.

FIG. 5 is a diagram illustrating a cross-sectional view and a moving path of a configuration of a variable magnification optical system of Example 2.

FIG. 6 is each aberration diagram of the variable magnification optical system of Example 2.

FIG. 7 is a diagram illustrating a cross-sectional view and a moving path of a configuration of a variable magnification optical system of Example 3.

FIG. 8 is each aberration diagram of the variable magnification optical system of Example 3.

FIG. 9 is a diagram illustrating a cross-sectional view and a moving path of a configuration of a variable magnification optical system of Example 4.

FIG. 10 is each aberration diagram of the variable magnification optical system of Example 4.

FIG. 11 is a diagram illustrating a cross-sectional view and a moving path of a configuration of a variable magnification optical system of Example 5.

FIG. 12 is each aberration diagram of the variable magnification optical system of Example 5.

FIG. 13 is a diagram illustrating a cross-sectional view and a moving path of a configuration of a variable magnification optical system of Example 6.

FIG. 14 is each aberration diagram of the variable magnification optical system of Example 6.

FIG. 15 is a diagram illustrating a cross-sectional view and a moving path of a configuration of a variable magnification optical system of Example 7.

FIG. 16 is each aberration diagram of the variable magnification optical system of Example 7.

FIG. 17 is a diagram illustrating a cross-sectional view and a moving path of a configuration of a variable magnification optical system of Example 8.

FIG. 18 is each aberration diagram of the variable magnification optical system of Example 8.

FIG. 19 is a diagram illustrating a cross-sectional view and a moving path of a configuration of a variable magnification optical system of Example 9.

FIG. 20 is each aberration diagram of the variable magnification optical system of Example 9.

FIG. 21 is a diagram illustrating a cross-sectional view and a moving path of a configuration of a variable magnification optical system of Example 10.

FIG. 22 is each aberration diagram of the variable magnification optical system of Example 10.

FIG. 23 is a diagram illustrating a cross-sectional view and a moving path of a configuration of a variable magnification optical system of Example 11.

FIG. 24 is each aberration diagram of the variable magnification optical system of Example 11.

FIG. 25 is a diagram illustrating a cross-sectional view and a moving path of a configuration of a variable magnification optical system of Example 12.

FIG. 26 is each aberration diagram of the variable magnification optical system of Example 12.

FIG. 27 is a diagram illustrating a cross-sectional view and a moving path of a configuration of a variable magnification optical system of Example 13.

FIG. 28 is each aberration diagram of the variable magnification optical system of Example 13.

FIG. 29 is a diagram illustrating a cross-sectional view and a moving path of a configuration of a variable magnification optical system of Example 14.

FIG. 30 is each aberration diagram of the variable magnification optical system of Example 14.

FIG. 31 is a diagram illustrating a cross-sectional view and a moving path of a configuration of a variable magnification optical system of Example 15.

FIG. 32 is each aberration diagram of the variable magnification optical system of Example 15.

FIG. 33 is a diagram illustrating a cross-sectional view and a moving path of a configuration of a variable magnification optical system of Example 16.

FIG. 34 is each aberration diagram of the variable magnification optical system of Example 16.

FIG. 35 is a diagram illustrating a cross-sectional view and a moving path of a configuration of a variable magnification optical system of Example 17.

FIG. 36 is each aberration diagram of the variable magnification optical system of Example 17.

FIG. 37 is a diagram illustrating a cross-sectional view and a moving path of a configuration of a variable magnification optical system of Example 18.

FIG. 38 is each aberration diagram of the variable magnification optical system of Example 18.

FIG. 39 is a diagram illustrating a cross-sectional view and a moving path of a configuration of a variable magnification optical system of Example 19.

FIG. 40 is each aberration diagram of the variable magnification optical system of Example 19.

FIG. 41 is a diagram illustrating a cross-sectional view and a moving path of a configuration of a variable magnification optical system of Example 20.

FIG. 42 is each aberration diagram of the variable magnification optical system of Example 20.

FIG. 43 is a perspective view of a front surface side of an imaging apparatus according to one embodiment.

FIG. 44 is a perspective view of a rear surface side of the imaging apparatus according to one embodiment.

### DETAILED DESCRIPTION

Hereinafter, an embodiment of the present disclosure will be described with reference to the drawings.

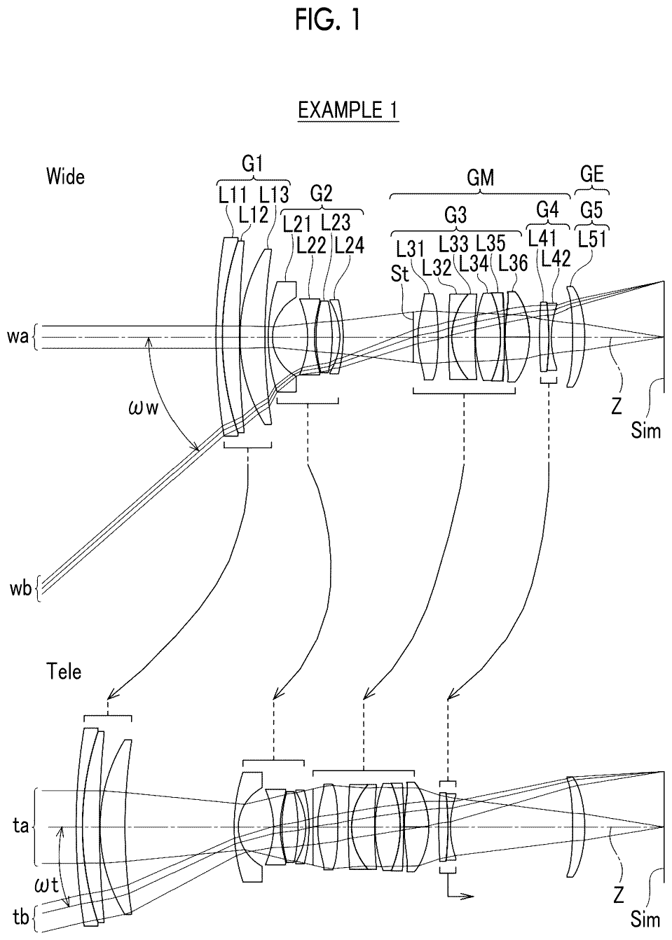

FIG. 1 illustrates a cross-sectional view and a moving path of a configuration of a variable magnification optical system according to one embodiment of the present disclosure. In FIG. 1, a wide angle end state is illustrated in an upper part labeled “Wide”, and a telephoto end state is illustrated in a lower part labeled “Tele”. The example illustrated in FIG. 1 corresponds to a variable magnification optical system of Example 1. FIG. 1 illustrates a state where an infinite distance object is in focus, in which a left side is an object side and a right side is an image side. FIG. 1 also illustrates an on-axis luminous flux wa and a luminous flux wb of a maximum half angle of view ωw at a wide angle end and an on-axis luminous flux ta and a luminous flux tb of a maximum half angle of view ωt at a telephoto end.

The variable magnification optical system of the present disclosure consists of, in order from the object side to the image side along an optical axis Z, a first lens group G1 having a positive refractive power, a second lens group G2 having a negative refractive power, an intermediate group GM, and a final lens group GE having a refractive power. The intermediate group GM consists of one or more and five or fewer lens groups. Forming the first lens group G1 as a lens group having a positive refractive power can reduce a total length and thus, achieves an advantage in achieving both of size reduction and a high zoom ratio. Forming the first lens group G1 as a lens group having a positive refractive power reduces a height of a ray incident on the second lens group G2 and thus, achieves an advantage in suppressing fluctuation of aberrations during changing magnification.

The aperture stop St is disposed between a lens surface of the second lens group G2 closest to the image side and a lens surface of the final lens group GE closest to the object side. This configuration enables size reduction of a stop unit and thus, achieves an advantage in size reduction of the entire optical system.

During changing the magnification, a spacing between the first lens group G1 and the second lens group G2 changes, a spacing between the second lens group G2 and the intermediate group GM changes, and a spacing between the intermediate group GM and the final lens group GE changes. In a case where the intermediate group GM consists of a plurality of lens groups, all spacings between adjacent lens groups in the intermediate group GM change during changing the magnification. Changing spacings between a plurality of groups during changing the magnification achieves an advantage in suppressing various aberrations in the entire magnification range.

The terms “first lens group G1”, “second lens group G2”, “lens groups” included in the intermediate group GM, and “final lens group GE” in the present specification mean parts that are constituents of the variable magnification optical system and that include at least one lens separated by air spacings which change during changing the magnification. During changing the magnification, each lens group is moved or fixed in lens group units, and a mutual spacing between lenses in each lens group does not change. That is, in the present specification, one lens group means a group in which, during changing the magnification, a spacing with respect to an adjacent group changes, and all spacings between adjacent lenses in the group do not change. The term “lens group” may include a constituent not having a refractive power, such as an aperture stop St, other than a lens.

For example, the variable magnification optical system illustrated in FIG. 1 consists of, in order from the object side to the image side, the first lens group G1, the second lens group G2, a third lens group G3, a fourth lens group G4, and a fifth lens group G5. In the example in FIG. 1, the intermediate group GM consists of the third lens group G3 and the fourth lens group G4, and the final lens group GE consists of the fifth lens group G5.

For example, each lens group in FIG. 1 is configured as follows. The first lens group G1 consists of, in order from the object side to the image side, three lenses including lenses L11 to L13. The second lens group G2 consists of, in order from the object side to the image side, four lenses including lenses L21 to L24. The third lens group G3 consists of, in order from the object side to the image side, the aperture stop St and six lenses including lenses L31 to L36. The fourth lens group G4 consists of, in order from the object side to the image side, two lenses including lenses L41 and L42. The fifth lens group G5 consists of one lens that is a lens L51. The aperture stop St in FIG. 1 does not indicate a shape and a size and indicates a position in an optical axis direction.

In the example in FIG. 1, during changing the magnification, the first lens group G1, the second lens group G2, the third lens group G3, and the fourth lens group G4 move along the optical axis Z by changing spacings with respect to adjacent lens groups, and the fifth lens group G5 is fixed with respect to an image plane Sim. In FIG. 1, for lens groups that move, an arrow between the upper part and the lower part indicates a schematic moving path of each lens group during changing the magnification from the wide angle end to the telephoto end.

In the variable magnification optical system of the present disclosure, the first lens group G1 includes, in consecutive order from a position closest to the object side to the image side, a first lens that is a negative lens, and a second lens that is a positive lens. This configuration facilitates correction of the aberrations in the first lens group G1 and thus, achieves an advantage in suppressing fluctuation of the aberrations during changing the magnification. Disposing the negative lens at the position closest to the object side facilitates correction of the aberrations in a case where a focal length at the wide angle end is reduced. In the example in FIG. 1, the lens L11 corresponds to the first lens, and the lens L12 corresponds to the second lens.

For example, the first lens group G1 can be configured to consist of, in order from the object side to the image side, a negative lens, a positive lens, and a positive lens. For example, the second lens group G2 may be configured to consist of, in order from the object side to the image side, a negative lens, a negative lens, a positive lens, and a negative lens.

The intermediate group GM consists of, in order from the object side to the image side, a lens group having a positive refractive power, and a lens group having a negative refractive power, and the final lens group GE can be configured to have a positive refractive power. Doing so achieves an advantage in achieving both of simplification of a lens drive mechanism and high performance.

The intermediate group GM preferably includes the aperture stop St at the position closest to the object side. Doing so can bring the aperture stop St and the first lens group G1 close to each other and thus, can reduce a distance from a lens surface of the first lens group G1 closest to the object side to an entrance pupil position. This achieves an advantage in reducing a diameter of the first lens group G1.

The final lens group GE may be configured to be fixed with respect to the image plane Sim during changing the magnification. Doing so can simplify the lens drive mechanism.

The final lens group GE may be configured to consist of one positive lens that is an aspherical lens. Doing so achieves an advantage in achieving both of simplification of the lens drive mechanism and high performance.

The variable magnification optical system of the present disclosure may be configured to include at least one focus group that moves during changing the magnification and during focusing. Focusing is performed by moving the focus group. In the example in FIG. 1, the focus group consists of the fourth lens group G4. A bracket and a rightward arrow under the fourth lens group G4 in FIG. 1 indicate that the fourth lens group G4 is the focus group that moves to the image side during focusing from the infinite distance object to a nearest object. While the fourth lens group G4 functions as the focus group in the entire magnification range, the bracket and the arrow indicating the focus group are provided in only the lower part of FIG. 1 in order to avoid complication of the drawing.

One lens group among the lens groups included in the intermediate group GM may be configured to be the focus group that moves during changing the magnification and focusing. Disposing the focus group in the intermediate group GM enables size reduction of the focus group and achieves an advantage in size reduction of the entire optical system.

For example, as illustrated in FIG. 1, the focus group may be configured to consist of one positive lens and one negative lens. Doing so reduces the number of lenses of the focus group, and this achieves an advantage in simplifying a mechanism for controlling the focus group and facilitates fast focusing.

Alternatively, the focus group may be configured to consist of one negative lens. Doing so further reduces the number of lenses of the focus group, and this achieves an advantage in simplifying the mechanism for controlling the focus group and facilitates faster focusing. The negative lens of the focus group may be configured to be an aspherical lens. Doing so can suppress fluctuation of the aberrations during focusing and thus, achieves an advantage in achieving high performance.

The focus group may be configured to consist of one positive lens and two negative lenses. Doing so can suppress fluctuation of the aberration during focusing and thus, achieves an advantage in achieving high performance. The negative lens closest to the image side in the focus group may be configured to be an aspherical lens. Doing so can suppress fluctuation of the aberrations during focusing and thus, achieves an advantage in achieving high performance.

The focus group may be configured to consist of one negative lens and two positive lenses. Doing so can suppress fluctuation of the aberration during focusing and thus, achieves an advantage in achieving high performance. The positive lens closest to the image side in the focus group may be configured to be an aspherical lens. Doing so can suppress fluctuation of the aberrations during focusing and thus, achieves an advantage in achieving high performance.

Two lens groups among the lens groups included in the intermediate group GM may be configured to be the focus groups that move by changing a mutual spacing during changing the magnification and during focusing. Disposing the focus groups in the intermediate group GM enables size reduction of the focus group and achieves an advantage in size reduction of the entire optical system. Performing focusing using two lens groups by adopting a floating focus method can favorably suppress fluctuation of the aberration during focusing.

In the configuration in which two lens groups among the lens groups included in the intermediate group GM are the focus groups that move by changing the mutual spacing during changing the magnification and during focusing, a lens group disposed on the object side out of the two lens groups which are the focus groups will be referred to as an object side focus group, and a lens group disposed on the image side out of the two lens groups will be referred to as an image side focus group.

The object side focus group may be configured to consist of one negative lens and one positive lens, and the image side focus group may be configured to consist of one positive lens. Doing so can suppress fluctuation of the aberration during focusing and thus, achieves an advantage in achieving high performance. The positive lens of the image side focus group may be configured to be an aspherical lens. Doing so can suppress fluctuation of the aberrations during focusing and thus, achieves an advantage in achieving high performance.

The object side focus group may be configured to consist of one positive lens and one negative lens, and the image side focus group may be configured to consist of one negative lens. Doing so can suppress fluctuation of the aberration during focusing and thus, achieves an advantage in achieving high performance. The negative lens of the image side focus group may be configured to be an aspherical lens. Doing so can suppress fluctuation of the aberrations during focusing and thus, achieves an advantage in achieving high performance.

Next, preferable configurations related to conditional expressions of the variable magnification optical system of the present disclosure will be described. In the following description related to the conditional expressions, in order to avoid redundant description, the same symbol will be used for the same definition to partially omit duplicate descriptions of the symbol. Hereinafter, the “variable magnification optical system of the present disclosure” will be simply referred to as the “variable magnification optical system” in order to avoid redundant description.

The variable magnification optical system preferably satisfies Conditional Expression (1). A distance on the optical axis from a surface of the first lens on the object side to the aperture stop St in a state where the infinite distance object is in focus at the wide angle end is denoted by DDL1STw. A sum of a distance on the optical axis from the surface of the first lens on the object side to a lens surface of the final lens group GE closest to the image side and a back focus of the entire system as an air conversion distance in the state where the infinite distance object is in focus at the wide angle end is denoted by TLw. The term “back focus of the entire system as the air conversion distance” means an air conversion distance on the optical axis from a lens surface of the entire system closest to the image side to the image plane Sim. TLw denotes the total length in the state where the infinite distance object is in focus at the wide angle end. Ensuring that a corresponding value of Conditional Expression (1) is not less than or equal to its lower limit prevents an excessively short distance between the aperture stop St and the first lens group G1 and thus, also prevents an excessively short distance from the surface of the first lens on the object side to the entrance pupil position. This facilitates suppression of fluctuation of the aberrations during changing the magnification. Ensuring that the corresponding value of Conditional Expression (1) is not greater than or equal to its upper limit prevents an excessively long distance between the aperture stop St and the first lens group G1 and thus, prevents an excessively long distance from the surface of the first lens on the object side to the entrance pupil position. This can suppress an increase in the diameter of the first lens group G1 and thus, facilitates size reduction. In order to obtain more favorable characteristics, the variable magnification optical system more preferably satisfies Conditional Expression (1-1), further preferably satisfies Conditional Expression (1-2), yet further preferably satisfies Conditional Expression (1-3), and still more preferably satisfies Conditional Expression (1-4).

$$0 < DDL 1 STw / TLw < 0.5 \qquad ( 1 )$$

$$0.05 < DDL 1 STw / TLw < 0.46 \qquad ( 1 - 1 )$$

$$0.1 < DDL 1 STw / TLw < 0.43 \qquad ( 1 - 2 )$$

$$0.15 < DDL 1 STw / TLw < 0.41 \qquad ( 1 - 3 )$$

$$0.2 < DDL 1 STw / TLw < 0.39 \qquad ( 1 - 4 )$$

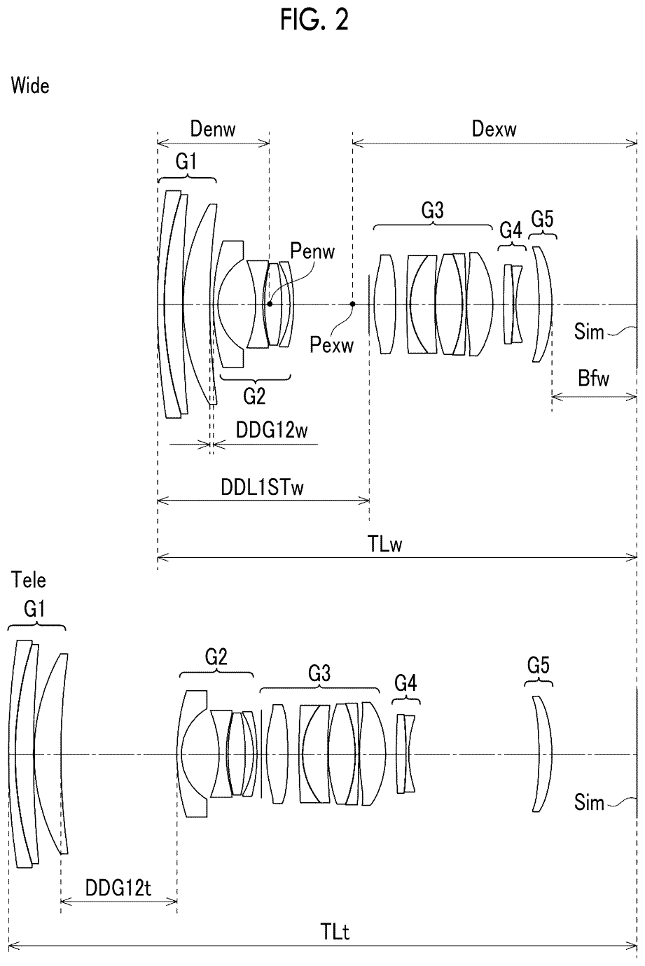

FIG. 2 illustrates a cross-sectional view of the variable magnification optical system in FIG. 1 and, for example, illustrates the distance DDL1STw and the total length TLw in the variable magnification optical system. In FIG. 2, the wide angle end state is illustrated in an upper part labeled “Wide”, and the telephoto end state is illustrated in a lower part labeled “Tele”.

The variable magnification optical system preferably satisfies Conditional Expression (2). An open F-number in a state where the infinite distance object is in focus at the telephoto end is denoted by Fnot. A focal length of the entire system in the state where the infinite distance object is in focus at the telephoto end is denoted by ft. A focal length of the entire system in the state where the infinite distance object is in focus at the wide angle end is denoted by fw. Ensuring that a corresponding value of Conditional Expression (2) is not less than or equal to its lower limit achieves an advantage in size reduction of the entire optical system or an advantage in suppressing various aberrations particularly at the telephoto end. Ensuring that the corresponding value of Conditional Expression (2) is not greater than or equal to its upper limit facilitates maintaining of a small F-number at the telephoto end and thus, achieves an advantage in obtaining sufficient brightness at the telephoto end. In order to obtain more favorable characteristics, the variable magnification optical system more preferably satisfies Conditional Expression (2-1), further preferably satisfies Conditional Expression (2-2), yet further preferably satisfies Conditional Expression (2-3), and still more preferably satisfies Conditional Expression (2-4).

$$0.5 < Fnot / ( ft / fw ) < 1.3 \qquad ( 2 )$$

$$0.6 < Fnot / ( ft / fw ) < 1.2 \qquad ( 2 - 1 )$$

$$0.7 < Fnot / ( ft / fw ) < 1.2 \qquad ( 2 - 2 )$$

$$0.8 < Fnot / ( ft / fw ) < 1.1 \qquad ( 2 - 3 )$$

$$0.9 < Fnot / ( ft / fw ) < 1.1 \qquad ( 2 - 4 )$$

The variable magnification optical system preferably satisfies Conditional Expression (3). The back focus of the entire system as the air conversion distance at the wide angle end is denoted by Bfw. A maximum half angle of view in the state where the infinite distance object is in focus at the telephoto end is denoted by ot. Here, tan denotes a tangent. For example, FIG. 2 illustrates the back focus Bfw. Ensuring that a corresponding value of Conditional Expression (3) is not less than or equal to its lower limit prevents an excessively short back focus and thus, facilitates attachment of a mount replacement mechanism. Ensuring that the corresponding value of Conditional Expression (3) is not greater than or equal to its upper limit prevents an excessively long back focus and thus, facilitates size reduction. In order to obtain more favorable characteristics, the variable magnification optical system more preferably satisfies Conditional Expression (3-1), further preferably satisfies Conditional Expression (3-2), yet further preferably satisfies Conditional Expression (3-3), and still more preferably satisfies Conditional Expression (3-4).

$$0.15 < Bfw / ( ft \times tan ω t ) < 2 \qquad ( 3 )$$

$$0.2 < Bfw / ( ft \times tan ω t ) < 1.7 \qquad ( 3 - 1 )$$

$$0.25 < Bfw / ( ft \times tan ω t ) < 1.4 \qquad ( 3 - 2 )$$

$$0.3 < Bfw / ( ft \times tan ω t ) < 1.1 \qquad ( 3 - 3 )$$

$$0.35 < Bfw / ( ft \times tan ω t ) < 0.8 \qquad ( 3 - 4 )$$

The variable magnification optical system preferably satisfies Conditional Expression (4). Ensuring that a corresponding value of Conditional Expression (4) is not less than or equal to its lower limit achieves an advantage in suppressing various aberrations. Ensuring that the corresponding value of Conditional Expression (4) is not greater than or equal to its upper limit facilitates obtaining of a wide angle of view at the wide angle end. In order to obtain more favorable characteristics, the variable magnification optical system more preferably satisfies Conditional Expression (4-1), further preferably satisfies Conditional Expression (4-2), yet further preferably satisfies Conditional Expression (4-3), and still more preferably satisfies Conditional Expression (4-4).

$$1 < fw / ( ft \times tan ω t ) < 1.4 \qquad ( 4 )$$

$$1.05 < fw / ( ft \times tan ω t ) < 1.35 \qquad ( 4 - 1 )$$

$$1.05 < fw / ( ft \times tan ω t ) < 1.3 \qquad ( 4 - 2 )$$

$$1.05 < fw / ( ft \times tan ω t ) < 1.25 \qquad ( 4 - 3 )$$

$$1.1 < fw / ( ft \times tan ω t ) < 1.2 \qquad ( 4 - 4 )$$

The variable magnification optical system preferably satisfies Conditional Expression (5). A focal length of the first lens group G1 is denoted by f1. A combined focal length of the optical system from the first lens to the aperture stop St in the state where the infinite distance object is in focus at the wide angle end is denoted by fL1STw. Ensuring that a corresponding value of Conditional Expression (5) is not less than or equal to its lower limit prevents an excessively weak refractive power of the first lens group G1 and thus, facilitates size reduction of the first lens group G1. Ensuring that the corresponding value of Conditional Expression (5) is not greater than or equal to its upper limit prevents an excessively strong refractive power of the first lens group G1 and thus, facilitates suppression of fluctuation of the aberrations during changing the magnification. In order to obtain more favorable characteristics, the variable magnification optical system more preferably satisfies Conditional Expression (5-1), further preferably satisfies Conditional Expression (5-2), yet further preferably satisfies Conditional Expression (5-3), and still more preferably satisfies Conditional Expression (5-4).

$$- 6.6 < f 1 / fL 1 STw < - 1.5 \qquad ( 5 )$$

$$- 6.2 < f 1 / fL 1 STw < - 1.8 \qquad ( 5 - 1 )$$

$$- 5.8 < f 1 / fL 1 STw < - 2.1 \qquad ( 5 - 2 )$$

$$- 5.4 < f 1 / fL 1 STw < - 2.4 \qquad ( 5 - 3 )$$

$$- 5 < f 1 / fL 1 STw < - 2.7 \qquad ( 5 - 4 )$$

In a case where a focal length of the first lens is denoted by fL1, the variable magnification optical system preferably satisfies Conditional Expression (6). Ensuring that a corresponding value of Conditional Expression (6) is not less than or equal to its lower limit prevents an excessively strong refractive power of the negative lens at the position closest to the object side and thus, facilitates suppression of a high-order aberration at the telephoto end. Alternatively, this prevents an excessively weak refractive power of the first lens group G1 and thus, facilitates size reduction of the first lens group G1. In the present specification, the term “high-order” related to aberrations means a fifth order or higher. Ensuring that the corresponding value of Conditional Expression (6) is not greater than or equal to its upper limit prevents an excessively strong refractive power of the first lens group G1 and thus, facilitates suppression of fluctuation of the aberrations during changing the magnification. Alternatively, this prevents an excessively weak refractive power of the negative lens at the position closest to the object side and thus, facilitates suppression of an axial chromatic aberration at the telephoto end. In order to obtain more favorable characteristics, the variable magnification optical system more preferably satisfies Conditional Expression (6-1), further preferably satisfies Conditional Expression (6-2), yet further preferably satisfies Conditional Expression (6-3), and still more preferably satisfies Conditional Expression (6-4).

$$- 0.9 < f 1 / fL 1 < - 0.05 \qquad ( 6 )$$

$$- 0.8 < f 1 / fL 1 < - 0.05 \qquad ( 6 - 1 )$$

$$- 0.7 < f 1 / fL 1 < - 0.1 \qquad ( 6 - 2 )$$

$$- 0.7 < f 1 / fL 1 < - 0.15 \qquad ( 6 - 3 )$$

$$- 0.6 < f 1 / fL 1 < - 0.2 \qquad ( 6 - 4 )$$

The variable magnification optical system preferably satisfies Conditional Expression (7). Ensuring that a corresponding value of Conditional Expression (7) is not less than or equal to its lower limit achieves an advantage in suppressing various aberrations. Ensuring that the corresponding value of Conditional Expression (7) is not greater than or equal to its upper limit facilitates obtaining of a wide angle of view at the wide angle end. In order to obtain more favorable characteristics, the variable magnification optical system more preferably satisfies Conditional Expression (7-1), further preferably satisfies Conditional Expression (7-2), yet further preferably satisfies Conditional Expression (7-3), and still more preferably satisfies Conditional Expression (7-4).

$$- 1.4 < f w / fL 1 STw < - 0.3 \qquad ( 7 )$$

$$- 1.3 < f w / fL 1 STw < - 0.4 \qquad ( 7 - 1 )$$

$$- 1.2 < f w / fL 1 STw < - 0.5 \qquad ( 7 - 2 )$$

$$- 1.1 < f w / fL 1 STw < - 0.6 \qquad ( 7 - 3 )$$

$$- 1 < f w / fL 1 STw < - 0.7 \qquad ( 7 - 4 )$$

The variable magnification optical system preferably satisfies Conditional Expression (8). Ensuring that a corresponding value of Conditional Expression (8) is not less than or equal to its lower limit facilitates suppression of various aberrations in the entire magnification range. Ensuring that the corresponding value of Conditional Expression (8) is not greater than or equal to its upper limit achieves an advantage in size reduction of the entire optical system. In order to obtain more favorable characteristics, the variable magnification optical system more preferably satisfies Conditional Expression (8-1), further preferably satisfies Conditional Expression (8-2), yet further preferably satisfies Conditional Expression (8-3), and still more preferably satisfies Conditional Expression (8-4).

$$2 < TLw / ( ft \times tan ω t ) < 9 \qquad ( 8 )$$

$$2.5 < TLw / ( ft \times tan ω t ) < 8 \qquad ( 8 - 1 )$$

$$3 < TLw / ( ft \times tan ω t ) < 7.5 \qquad ( 8 - 2 )$$

$$3.5 < TLw / ( ft \times tan ω t ) < 7 \qquad ( 8 - 3 )$$

$$4 < TLw / ( ft \times tan ω t ) < 6.5 \qquad ( 8 - 4 )$$

The variable magnification optical system preferably satisfies Conditional Expression (9). A lateral magnification of the second lens group G2 in the state where the infinite distance object is in focus at the telephoto end is denoted by β2t. A lateral magnification of the second lens group G2 in the state where the infinite distance object is in focus at the wide angle end is denoted by β2w. Ensuring that a corresponding value of Conditional Expression (9) is not less than or equal to its lower limit achieves an advantage in achieving a high zoom ratio. Ensuring that the corresponding value of Conditional Expression (9) is not greater than or equal to its upper limit achieves an advantage in suppressing fluctuation of the aberrations during changing the magnification. In order to obtain more favorable characteristics, the variable magnification optical system more preferably satisfies Conditional Expression (9-1), further preferably satisfies Conditional Expression (9-2), yet further preferably satisfies Conditional Expression (9-3), and still more preferably satisfies Conditional Expression (9-4).

$$1.1 < β 2 t / β 2 w < 3 \qquad ( 9 )$$

$$1.2 < β 2 t / β 2 w < 2.7 \qquad ( 9 - 1 )$$

$$1.2 < β 2 t / β 2 w < 2.4 \qquad ( 9 - 2 )$$

$$1.3 < β 2 t / β 2 w < 2.1 \qquad ( 9 - 3 )$$

$$1.3 < β 2 t / β 2 w < 1.9 \qquad ( 9 - 4 )$$

The variable magnification optical system preferably satisfies Conditional Expression (10). A spacing on the optical axis between the first lens group G1 and the second lens group G2 in the state where the infinite distance object is in focus at the wide angle end is denoted by DDG12w. A spacing on the optical axis between the first lens group G1 and the second lens group G2 in the state where the infinite distance object is in focus at the telephoto end is denoted by DDG12t. A sum of the distance on the optical axis from the surface of the first lens on the object side to the lens surface of the final lens group GE closest to the image side and the back focus of the entire system as the air conversion distance in the state where the infinite distance object is in focus at the telephoto end is denoted by TLt. TLt denotes the total length in the state where the infinite distance object is in focus at the telephoto end. For example, FIG. 2 illustrates the spacing DDG12w, the spacing DDG12t, and the total length TLt. Ensuring that a corresponding value of Conditional Expression (10) is not less than or equal to its lower limit achieves an advantage in securing an effective zoom ratio. Ensuring that the corresponding value of Conditional Expression (10) is not greater than or equal to its upper limit achieves an advantage in suppressing a change in a position of a centroid during changing the magnification. Alternatively, this achieves an advantage in suppressing a distortion during changing the magnification. In order to obtain more favorable characteristics, the variable magnification optical system more preferably satisfies Conditional Expression (10-1), further preferably satisfies Conditional Expression (10-2), yet further preferably satisfies Conditional Expression (10-3), and still more preferably satisfies Conditional Expression (10-4).

$$0.1 < \vert DDG 12 w - DDG 12 t \vert / TLt < 0.3 \qquad ( 10 )$$

$$0.12 < \vert DDG 12 w - DDG 12 t \vert / TLt < 0.28 \qquad ( 10 - 1 )$$

$$0.13 < \vert DDG 12 w - DDG 12 t \vert / TLt < 0.26 \qquad ( 10 - 2 )$$

$$0.15 < \vert DDG 12 w - DDG 12 t \vert / TLt < 0.23 \qquad ( 10 - 3 )$$

$$0.16 < \vert DDG 12 w - DDG 12 t \vert / TLt < 0.2 \qquad ( 10 - 4 )$$

The variable magnification optical system preferably satisfies Conditional Expression (11). Ensuring that a corresponding value of Conditional Expression (11) is not less than or equal to its lower limit prevents an excessively small movable range of the second lens group G2 during changing the magnification and thus, facilitates achieving of a high zoom ratio. Alternatively, this prevents an excessively weak refractive power of the first lens group G1 and thus, facilitates achieving of both of size reduction and a high zoom ratio. Ensuring that the corresponding value of Conditional Expression (11) is not greater than or equal to its upper limit prevents an excessively long distance from the surface of the first lens on the object side to the entrance pupil position on the wide angle side and thus, can suppress an increase in the diameter of the first lens group G1. This achieves an advantage in size reduction. Alternatively, this prevents an excessively strong refractive power of the first lens group G1 and thus, facilitates achieving of high performance. In order to obtain more favorable characteristics, the variable magnification optical system more preferably satisfies Conditional Expression (11-1), further preferably satisfies Conditional Expression (11-2), yet further preferably satisfies Conditional Expression (11-3), and still more preferably satisfies Conditional Expression (11-4).

$$0.2 < DDL 1 STw / f 1 < 0.8 \qquad ( 11 )$$

$$0.25 < DDL 1 STw / f 1 < 0.7 \qquad ( 11 - 1 )$$

$$0.25 < DDL 1 STw / f 1 < 0.65 \qquad ( 11 - 2 )$$

$$0.25 < DDL 1 STw / f 1 < 0.6 \qquad ( 11 - 3 )$$

$$0.3 < DDL 1 STw / f 1 < 0.55 \qquad ( 11 - 4 )$$

In a case where a maximum half angle of view in the state where the infinite distance object is in focus at the wide angle end is denoted by ow, the variable magnification optical system preferably satisfies Conditional Expression (12). Ensuring that a corresponding value of Conditional Expression (12) is not less than or equal to its lower limit prevents an excessively short distance from the surface of the first lens on the object side to the entrance pupil position on the wide angle side and thus, facilitates suppression of fluctuation of the aberrations during changing the magnification. Ensuring that the corresponding value of Conditional Expression (12) is not greater than or equal to its upper limit prevents an excessively long distance from the surface of the first lens on the object side to the entrance pupil position on the wide angle side and thus, can suppress an increase in the diameter of the first lens group G1. This achieves an advantage in size reduction. In order to obtain more favorable characteristics, the variable magnification optical system more preferably satisfies Conditional Expression (12-1), further preferably satisfies Conditional Expression (12-2), yet further preferably satisfies Conditional Expression (12-3), and still more preferably satisfies Conditional Expression (12-4).

$$3 < DDL 1 STw / \{ ( fw \times tan ω w ) \times log ( ft / fw ) \} < 9 \qquad ( 12 )$$

$$3.5 < DDL 1 STw / \{ ( fw \times tan ω w ) \times log ( ft / fw ) \} < 8 \qquad ( 12 - 1 )$$

$$3.5 < DDL 1 STw / \{ ( fw \times tan ω w ) \times log ( ft / fw ) \} < 7.5 \qquad ( 12 - 2 )$$

$$3.5 < DDL 1 STw / \{ ( fw \times tan ω w ) \times log ( ft / fw ) \} / < 7 \qquad ( 12 - 3 )$$

$$4 < DDL 1 STw / \{ ( fw \times tan ω w ) \times log ( ft / fw ) \} < 6.5 \qquad ( 12 - 4 )$$

The variable magnification optical system preferably satisfies Conditional Expression (13). Ensuring that a corresponding value of Conditional Expression (13) is not less than or equal to its lower limit facilitates suppression of various aberrations at the wide angle end. Ensuring that the corresponding value of Conditional Expression (13) is not greater than or equal to its upper limit facilitates reduction of the total length at the wide angle end. In order to obtain more favorable characteristics, the variable magnification optical system more preferably satisfies Conditional Expression (13-1), further preferably satisfies Conditional Expression (13-2), yet further preferably satisfies Conditional Expression (13-3), and still more preferably satisfies Conditional Expression (13-4).

$$3 < TLw / fw < 8 \qquad ( 13 )$$

$$3.5 < TLw / fw < 7.5 \qquad ( 13 - 1 )$$

$$3.5 < TLw / fw < 7 \qquad ( 13 - 2 )$$

$$4 < TLw / fw < 6.5 \qquad ( 13 - 3 )$$

$$4 < TLw / fw < 6 \qquad ( 13 - 4 )$$

The variable magnification optical system preferably satisfies Conditional Expression (14). Ensuring that a corresponding value of Conditional Expression (14) is not less than or equal to its lower limit facilitates suppression of various aberrations at the telephoto end. Ensuring that the corresponding value of Conditional Expression (14) is not greater than or equal to its upper limit facilitates reduction of the total length at the telephoto end. In order to obtain more favorable characteristics, the variable magnification optical system more preferably satisfies Conditional Expression (14-1), further preferably satisfies Conditional Expression (14-2), yet further preferably satisfies Conditional Expression (14-3), and still more preferably satisfies Conditional Expression (14-4).

$$1.5 < TLt / ft < 3 \qquad ( 14 )$$

$$1.65 < TLt / ft < 2.85 \qquad ( 14 - 1 )$$

$$1.8 < TLt / ft < 2.7 \qquad ( 14 - 2 )$$

$$1.95 < TLt / ft < 2.7 \qquad ( 14 - 3 )$$

$$2.05 < TLt / ft < 2.55 \qquad ( 14 - 4 )$$

The variable magnification optical system preferably satisfies Conditional Expression (15). Ensuring that a corresponding value of Conditional Expression (15) is not less than or equal to its lower limit can cause the on-axis luminous flux ta to gradually converge to the image plane Sim at the telephoto end and thus, can suppress the axial chromatic aberration that occurs during converging of the luminous flux. Ensuring that the corresponding value of Conditional Expression (15) is not greater than or equal to its upper limit facilitates reduction of the total length at the telephoto end. In order to obtain more favorable characteristics, the variable magnification optical system more preferably satisfies Conditional Expression (15-1), further preferably satisfies Conditional Expression (15-2), yet further preferably satisfies Conditional Expression (15-3), and still more preferably satisfies Conditional Expression (15-4).

$$5 < TLt / ( ft \times tan ω t ) < 11 \qquad ( 15 )$$

$$5.5 < TLt / ( ft \times tan ω t ) < 10.5 \qquad ( 15 - 1 )$$

$$6 < TLt / ( ft \times tan ω t ) < 10 \qquad ( 15 - 2 )$$

$$6 < TLt / ( ft \times tan ω t ) < 9 \qquad ( 15 - 3 )$$

$$6.5 < TLt / ( ft \times tan ω t ) < 8.5 \qquad ( 15 - 4 )$$

The variable magnification optical system preferably satisfies Conditional Expression (16). Ensuring that a corresponding value of Conditional Expression (16) is not less than or equal to its lower limit prevents an excessively strong refractive power of the first lens group G1 and thus, facilitates suppression of fluctuation of the aberrations during changing the magnification. Ensuring that the corresponding value of Conditional Expression (16) is not greater than or equal to its upper limit prevents an excessively weak refractive power of the first lens group G1 and thus, facilitates size reduction of the first lens group G1. In order to obtain more favorable characteristics, the variable magnification optical system more preferably satisfies Conditional Expression (16-1), further preferably satisfies Conditional Expression (16-2), yet further preferably satisfies Conditional Expression (16-3), and still more preferably satisfies Conditional Expression (16-4).

$$3 < f 1 / fw < 7 \qquad ( 16 )$$

$$3.5 < f 1 / fw < 6.5 \qquad ( 16 - 1 )$$

$$3.5 < f 1 / fw < 6 \qquad ( 16 - 2 )$$

$$4 < f 1 / fw < 6 \qquad ( 16 - 3 )$$

$$4 < f 1 / fw < 5.5 \qquad ( 16 - 4 )$$

In a case where a focal length of the second lens group G2 is denoted by f2, the variable magnification optical system preferably satisfies Conditional Expression (17). Ensuring that a corresponding value of Conditional Expression (17) is not less than or equal to its lower limit prevents an excessively weak refractive power of the second lens group G2 and thus, facilitates reduction of a moving amount of the second lens group G2 during changing the magnification. Ensuring that the corresponding value of Conditional Expression (17) is not greater than or equal to its upper limit prevents an excessively weak refractive power of the first lens group G1 and thus, facilitates suppression of an increase in size of the first lens group G1. In order to obtain more favorable characteristics, the variable magnification optical system more preferably satisfies Conditional Expression (17-1), further preferably satisfies Conditional Expression (17-2), yet further preferably satisfies Conditional Expression (17-3), and still more preferably satisfies Conditional Expression (17-4).

$$3 < f 1 / ( - f 2 ) < 9 \qquad ( 17 )$$

$$3.5 < f 1 / ( - f 2 ) < 8.5 \qquad ( 17 - 1 )$$

$$4 < f 1 / ( - f 2 ) < 8 \qquad ( 17 - 2 )$$

$$4 < f 1 / ( - f 2 ) < 7.5 \qquad ( 17 - 3 )$$

$$4.5 < f 1 / ( - f 2 ) < 7 \qquad ( 17 - 4 )$$

The variable magnification optical system preferably satisfies Conditional Expression (18). Ensuring that a corresponding value of Conditional Expression (18) is not less than or equal to its lower limit achieves an advantage in achieving high performance. Ensuring that the corresponding value of Conditional Expression (18) is not greater than or equal to its upper limit prevents an excessively weak refractive power of the first lens group G1 and thus, facilitates size reduction of the first lens group G1. In order to obtain more favorable characteristics, the variable magnification optical system more preferably satisfies Conditional Expression (18-1), further preferably satisfies Conditional Expression (18-2), yet further preferably satisfies Conditional Expression (18-3), and still more preferably satisfies Conditional Expression (18-4).

$$2 < f 1 / ( ft / Fnot ) < 7 \qquad ( 18 )$$

$$2.5 < f 1 / ( ft / Fnot ) < 6.5 \qquad ( 18 - 1 )$$

$$3 < f 1 / ( ft / Fnot ) < 6.5 \qquad ( 18 - 2 )$$

$$3.5 < f 1 / ( ft / Fnot ) < 6 \qquad ( 18 - 3 )$$

$$4 < f 1 / ( ft / Fnot ) < 6 \qquad ( 18 - 4 )$$

The variable magnification optical system preferably satisfies Conditional Expression (19). Ensuring that a corresponding value of Conditional Expression (19) is not less than or equal to its lower limit prevents an excessively strong refractive power of the first lens group G1 and thus, facilitates suppression of fluctuation of the aberrations during changing the magnification. Ensuring that the corresponding value of Conditional Expression (19) is not greater than or equal to its upper limit prevents an excessively weak refractive power of the first lens group G1 and thus, achieves an advantage in size reduction. In order to obtain more favorable characteristics, the variable magnification optical system more preferably satisfies Conditional Expression (19-1), further preferably satisfies Conditional Expression (19-2), yet further preferably satisfies Conditional Expression (19-3), and still more preferably satisfies Conditional Expression (19-4).

$$1.8 < f 1 / {( fw \times ft )}^{1 / 2} < 4.2 \qquad ( 19 )$$

$$1.9 < f 1 / {( fw \times ft )}^{1 / 2} < 4.1 \qquad ( 19 - 1 )$$

$$2 < f 1 / {( fw \times ft )}^{1 / 2} < 4 \qquad ( 19 - 2 )$$

$$2.1 < f 1 / {( fw \times ft )}^{1 / 2} < 3.9 \qquad ( 19 - 3 )$$

$$2.2 < f 1 / {( fw \times ft )}^{1 / 2} < 3.8 \qquad ( 19 - 4 )$$

The variable magnification optical system preferably satisfies Conditional Expression (20). A distance on the optical axis from the surface of the first lens on the object side to a paraxial entrance pupil position Penw in the state where the infinite distance object is in focus at the wide angle end is denoted by Denw. For example, FIG. 2 illustrates the distance Denw and the paraxial entrance pupil position Penw. Ensuring that a corresponding value of Conditional Expression (20) is not less than or equal to its lower limit prevents an excessively short distance from the surface of the first lens on the object side to the entrance pupil position on the wide angle side and thus, facilitates suppression of fluctuation of the aberrations during changing the magnification. Ensuring that the corresponding value of Conditional Expression (20) is not greater than or equal to its upper limit prevents an excessively long distance from the surface of the first lens on the object side to the entrance pupil position on the wide angle side and thus, can suppress an increase in the diameter of the first lens group G1. This achieves an advantage in size reduction. In order to obtain more favorable characteristics, the variable magnification optical system more preferably satisfies Conditional Expression (20-1), further preferably satisfies Conditional Expression (20-2), yet further preferably satisfies Conditional Expression (20-3), and still more preferably satisfies Conditional Expression (20-4).

$$2 < Denw / \{ ( fw \times tan ω w ) \times log ( ft / fw ) \} < 4.5 \qquad ( 20 )$$

$$2.2 < Denw / \{ ( fw \times tan ω w ) \times log ( ft / fw ) \} < 4.2 \qquad ( 20 - 1 )$$

$$2.4 < Denw / \{ ( fw \times tan ω w ) \times log ( ft / fw ) \} < 3.9 \qquad ( 20 - 2 )$$

$$2.4 < Denw / \{ ( fw \times tan ω w ) \times log ( ft / fw ) \} < 3.6 \qquad ( 20 - 3 )$$

$$2.6 < Denw / \{ ( fw \times tan ω w ) \times log ( ft / fw ) \} < 3.3 \qquad ( 20 - 4 )$$

The variable magnification optical system preferably satisfies Conditional Expression (21). Ensuring that a corresponding value of Conditional Expression (21) is not less than or equal to its lower limit prevents an excessively short distance from the surface of the first lens on the object side to the entrance pupil position and thus, facilitates suppression of fluctuation of the aberrations during changing the magnification. Ensuring that the corresponding value of Conditional Expression (21) is not greater than or equal to its upper limit prevents an excessively long distance from the surface of the first lens on the object side to the entrance pupil position and thus, can suppress an increase in the diameter of the first lens group G1. This achieves an advantage in size reduction. In order to obtain more favorable characteristics, the variable magnification optical system more preferably satisfies Conditional Expression (21-1), further preferably satisfies Conditional Expression (21-2), yet further preferably satisfies Conditional Expression (21-3), and still more preferably satisfies Conditional Expression (21-4).

$$0.5 < Denw / {( fw \times ft )}^{1 / 2} < 1 \qquad ( 21 )$$

$$0.55 < Denw / {( fw \times ft )}^{1 / 2} < 0.95 \qquad ( 21 - 1 )$$

$$0.6 < Denw / {( fw \times ft )}^{1 / 2} < 0.9 \qquad ( 21 - 2 )$$

$$0.65 < Denw / {( fw \times ft )}^{1 / 2} < 0.85 \qquad ( 21 - 3 )$$

$$0.7 < Denw / {( fw \times ft )}^{1 / 2} < 0.85 \qquad ( 21 - 4 )$$

In a case where a center thickness of the first lens is denoted by dl, the variable magnification optical system preferably satisfies Conditional Expression (22). Ensuring that a corresponding value of Conditional Expression (22) is not less than or equal to its lower limit achieves an advantage in securing strength of the first lens. Ensuring that the corresponding value of Conditional Expression (22) is not greater than or equal to its upper limit achieves an advantage in weight reduction of the first lens group G1. In order to obtain more favorable characteristics, the variable magnification optical system more preferably satisfies Conditional Expression (22-1), further preferably satisfies Conditional Expression (22-2), yet further preferably satisfies Conditional Expression (22-3), and still more preferably satisfies Conditional Expression (22-4).

$$0.04 < d 1 / ( Denw \times tan ω w ) < 0.09 \qquad ( 22 )$$

$$0.045 < d 1 / ( Denw \times tan ω w ) < 0.085 \qquad ( 22 - 1 )$$

$$0.05 < d 1 / ( Denw \times tan ω w ) < 0.085 \qquad ( 22 - 2 )$$

$$0.055 < d 1 / ( Denw \times tan ω w ) < 0.08 \qquad ( 22 - 3 )$$

$$0.055 < d 1 / ( Denw \times tan ω w ) < 0.075 \qquad ( 22 - 4 )$$

The variable magnification optical system preferably satisfies Conditional Expression (23). A distance on the optical axis from the image plane Sim to a paraxial exit pupil position Pexw in the state where the infinite distance object is in focus at the wide angle end is denoted by Dexw. A sign of Dexw is positive for the distance on the image side and is negative for the distance on the object side with respect to the image plane Sim. In a case where an optical member not having a refractive power is disposed between the image plane Sim and the paraxial exit pupil position Pexw, Dexw is calculated using the air conversion distance for the optical member. For example, FIG. 2 illustrates the distance Dexw and the paraxial exit pupil position Pexw. Ensuring that a corresponding value of Conditional Expression (23) is not less than or equal to its lower limit facilitates reduction of the total length and thus, achieves an advantage in size reduction. Ensuring that the corresponding value of Conditional Expression (23) is not greater than or equal to its upper limit facilitates reduction of an angle at which an off-axis principal ray is incident on the image plane Sim, and thus, achieves an advantage in securing an edge part light quantity. In order to obtain more favorable characteristics, the variable magnification optical system more preferably satisfies Conditional Expression (23-1), further preferably satisfies Conditional Expression (23-2), yet further preferably satisfies Conditional Expression (23-3), and still more preferably satisfies Conditional Expression (23-4).

$$0.65 < fw / Dexw < - 0.2 \qquad ( 23 )$$

$$0.6 < fw / Dexw < - 0.2 \qquad ( 23 - 1 )$$

$$0.55 < fw / Dexw < - 0.2 \qquad ( 23 - 2 )$$

$$0.55 < fw / Dexw < - 0.25 \qquad ( 23 - 3 )$$

$$0.5 < fw / Dexw < - 0.3 \qquad ( 23 - 4 )$$

The variable magnification optical system preferably satisfies Conditional Expression (24). An effective diameter of the surface of the first lens on the object side is denoted by EDf. An effective diameter of the lens surface of the final lens group GE closest to the image side is denoted by EDr. Ensuring that a corresponding value of Conditional Expression (24) is not less than or equal to its lower limit prevents an excessively small diameter of the first lens and thus, facilitates securing of a ratio of the edge part light quantity at the maximum image height. Alternatively, this prevents an excessively strong refractive power of the first lens group G1 for reducing the diameter of the first lens and thus, facilitates suppression of fluctuation of the aberrations during changing the magnification. Ensuring that the corresponding value of Conditional Expression (24) is not greater than or equal to its upper limit prevents an excessively large diameter of the first lens and thus, facilitates size reduction. In order to obtain more favorable characteristics, the variable magnification optical system more preferably satisfies Conditional Expression (24-1), further preferably satisfies Conditional Expression (24-2), yet further preferably satisfies Conditional Expression (24-3), and still more preferably satisfies Conditional Expression (24-4).

$$1.5 < EDf / EDr < 3 \qquad ( 24 )$$

$$1.6 < EDf / EDr < 2.8 \qquad ( 24 - 1 )$$

$$1.7 < EDf / EDr < 2.6 \qquad ( 24 - 2 )$$

$$1.8 < EDf / EDr < 2.4 \qquad ( 24 - 3 )$$

$$1.9 < EDf / EDr < 2.2 \qquad ( 24 - 4 )$$

In the present specification, twice a distance from an intersection between a lens surface and a ray passing through the most outer side of the lens surface to the optical axis Z among rays that are incident on the lens surface from the object side and that exit to the image side will be referred to as an “effective diameter” of the lens surface. The term “outer side” means an outer side in a diameter direction centered on the optical axis Z, that is, a side away from the optical axis Z. The “ray passing through the most outer side” is determined by considering the entire magnification range.

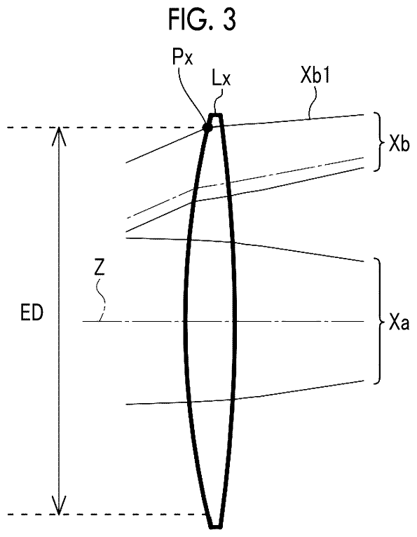

FIG. 3 illustrates an example of an effective diameter ED as a diagram for description. In FIG. 3, a left side is the object side, and a right side is the image side. FIG. 3 illustrates an on-axis luminous flux Xa and an off-axis luminous flux Xb that pass through a lens Lx. In the example in FIG. 3, a ray Xb1 that is an upper ray of the off-axis luminous flux Xb is the ray passing through the most outer side. Thus, in the example in FIG. 3, twice a distance from an intersection between a surface of the lens Lx on the object side and the ray Xb1 to the optical axis Z is the effective diameter ED of the surface of the lens Lx on the object side. A position of the intersection between the ray passing through the most outer side and the lens surface is a position Px of the maximum effective diameter. While the upper ray of the off-axis luminous flux Xb is the ray passing through the most outer side in the example in FIG. 3, which ray is the ray passing through the most outer side varies depending on the optical system.

The variable magnification optical system preferably satisfies Conditional Expression (25). Ensuring that a corresponding value of Conditional Expression (25) is not less than or equal to its lower limit achieves an advantage in reducing the total length. Ensuring that the corresponding value of Conditional Expression (25) is not greater than or equal to its upper limit facilitates reduction of the diameter of the first lens. In order to obtain more favorable characteristics, the variable magnification optical system more preferably satisfies Conditional Expression (25-1), further preferably satisfies Conditional Expression (25-2), yet further preferably satisfies Conditional Expression (25-3), and still more preferably satisfies Conditional Expression (25-4).

$$0.35 < EDf / TLw < 0.65 \qquad ( 25 )$$

$$0.38 < EDf / TLw < 0.62 \qquad ( 25 - 1 )$$

$$0.41 < EDf / TLw < 0.59 \qquad ( 25 - 2 )$$

$$0.41 < EDf / TLw < 0.56 \qquad ( 25 - 3 )$$

$$0.44 < EDf / TLw < 0.53 \qquad ( 25 - 4 )$$

The variable magnification optical system preferably satisfies Conditional Expression (26). Ensuring that a corresponding value of Conditional Expression (26) is not less than or equal to its lower limit prevents an excessively low zoom ratio and thus, can obtain value useful as the variable magnification optical system. Ensuring that the corresponding value of Conditional Expression (26) is not greater than or equal to its upper limit prevents an excessively high zoom ratio and thus, achieves an advantage in size reduction. In order to obtain more favorable characteristics, the variable magnification optical system more preferably satisfies Conditional Expression (26-1), further preferably satisfies Conditional Expression (26-2), yet further preferably satisfies Conditional Expression (26-3), and still more preferably satisfies Conditional Expression (26-4).

$$2.2 < ft / fw < 4.8 \qquad ( 26 )$$

$$2.35 < ft / fw < 4.4 \qquad ( 26 - 1 )$$

$$2.35 < ft / fw < 4 \qquad ( 26 - 2 )$$

$$2.5 < ft / fw < 3.6 \qquad ( 26 - 3 )$$

$$2.5 < ft / fw < 3.2 \qquad ( 26 - 4 )$$

In a case where a refractive index with respect to a d line for the first lens is denoted by NdL1, the variable magnification optical system preferably satisfies Conditional Expression (27). Ensuring that a corresponding value of Conditional Expression (27) is not less than or equal to its lower limit prevents an excessively small absolute value of a curvature radius of the first lens for securing a refractive power of the first lens necessary for correcting an aberration occurring in the positive lens constituting the first lens group G1. Consequently, this can suppress an increase in a high-order aberration of a spherical aberration at the telephoto end and thus, achieves an advantage in achieving high performance. Alternatively, ensuring that the corresponding value of Conditional Expression (27) is not less than or equal to its lower limit prevents an excessively weak refractive power and an excessively large outer diameter of the first lens and thus, prevents an excessively weak refractive power and an excessively large outer diameter of the positive lens of the first lens group G1. This facilitates size reduction of the first lens group G1. For an upper limit of Conditional Expression (27), it is general that as a refractive index of an optical material is increased, a relative density is increased, and an Abbe number is decreased. Thus, ensuring that the corresponding value of Conditional Expression (27) is not greater than or equal to its upper limit can suppress an increase in weight of the first lens having a large lens diameter and thus, facilitates weight reduction. This also facilitates correction of a lateral chromatic aberration at the wide angle end. In order to obtain more favorable characteristics, the variable magnification optical system more preferably satisfies Conditional Expression (27-1), further preferably satisfies Conditional Expression (27-2), yet further preferably satisfies Conditional Expression (27-3), and still more preferably satisfies Conditional Expression (27-4).

$$1.8 < NdL 1 < 2.01 \qquad ( 27 )$$

$$1.8 < NdL 1 < 1.96 \qquad ( 27 - 1 )$$

$$1.8 < NdL 1 < 1.91 \qquad ( 27 - 2 )$$

$$1.84 < NdL 1 < 1.96 \qquad ( 27 - 3 )$$

$$1.84 < NdL 1 < 1.91 \qquad ( 27 - 4 )$$

In a case where an Abbe number based on the d line for the first lens is denoted by νdL1, the variable magnification optical system preferably satisfies Conditional Expression (28). Ensuring that a corresponding value of Conditional Expression (28) is not less than or equal to its lower limit can suppress overcorrection of the axial chromatic aberration at the telephoto end. Alternatively, this prevents an excessively large difference in Abbe number between the positive lens and the negative lens constituting the first lens group G1 and thus, prevents an excessively weak refractive power of the first lens. Consequently, this facilitates correction of the lateral chromatic aberration at the wide angle end. Ensuring that the corresponding value of Conditional Expression (28) is not greater than or equal to its upper limit can suppress undercorrection of the axial chromatic aberration at the telephoto end. Alternatively, this prevents an excessively small difference in Abbe number between the positive lens and the negative lens constituting the first lens group G1 and thus, prevents an excessively strong refractive power of each lens constituting the first lens group G1. Consequently, this can suppress an increase in the high-order aberration of the spherical aberration at the telephoto end and thus, facilitates achieving of high performance. In order to obtain more favorable characteristics, the variable magnification optical system more preferably satisfies Conditional Expression (28-1), further preferably satisfies Conditional Expression (28-2), yet further preferably satisfies Conditional Expression (28-3), and still more preferably satisfies Conditional Expression (28-4).

$$15 < vdL 1 < 45 \qquad ( 28 )$$

$$15 < vdL 1 < 40 \qquad ( 28 - 1 )$$

$$15 < vdL 1 < 36 \qquad ( 28 - 2 )$$

$$18 < vdL 1 < 36 \qquad ( 28 - 3 )$$

$$20 < vdL 1 < 36 \qquad ( 28 - 4 )$$

The variable magnification optical system preferably satisfies Conditional Expression (29). Ensuring that a corresponding value of Conditional Expression (29) is not less than or equal to its lower limit enables selection of a material other than a material having a low refractive index and a small Abbe number and thus, facilitates correction of the lateral chromatic aberration at the wide angle end. Ensuring that the corresponding value of Conditional Expression (29) is not greater than or equal to its upper limit enables selection of a material other than a material having a high refractive index and a large Abbe number and thus, enables selection of a material not having a high relative density and facilitates weight reduction. Alternatively, this prevents an excessively small difference in Abbe number between the positive lens and the negative lens constituting the first lens group G1 and thus, prevents a strong refractive power of each lens constituting the first lens group G1. Consequently, this can suppress the high-order aberration of the spherical aberration at the telephoto end. In order to obtain more favorable characteristics, the variable magnification optical system more preferably satisfies Conditional Expression (29-1), further preferably satisfies Conditional Expression (29-2), yet further preferably satisfies Conditional Expression (29-3), and still more preferably satisfies Conditional Expression (29-4).

$$2 < NdL 1 + 0.01 \times vdL 1 < 2.5 \qquad ( 29 )$$

$$2 < NdL 1 + 0.01 \times vdL 1 < 2.35 \qquad ( 29 - 1 )$$

$$2.05 < NdL 1 + 0.01 \times vdL 1 < 2.35 \qquad ( 29 - 2 )$$

$$2 < NdL 1 + 0.01 \times vdL 1 < 2.2 \qquad ( 29 - 3 )$$

$$2.05 < NdL 1 + 0.01 \times vdL 1 < 2.2 \qquad ( 29 - 4 )$$

The variable magnification optical system preferably satisfies Conditional Expressions (27), (28), and (29) at the same time. The variable magnification optical system more preferably satisfies Conditional Expressions (27), (28), and (29) at the same time and at least one of Conditional Expression (27-1), (27-2), (27-3), (27-4), (28-1), (28-2), (28-3), (28-4), (29-1), (29-2), (29-3), or (29-4).

In a case where a refractive index with respect to a d line for the second lens is denoted by NdL2, the variable magnification optical system preferably satisfies Conditional Expression (30). Ensuring that a corresponding value of Conditional Expression (30) is not less than or equal to its lower limit prevents a small absolute value of a curvature radius of the positive lens constituting the first lens group G1 for securing a positive refractive power necessary for size reduction of the first lens group G1. Consequently, this can suppress an increase in the high-order aberration of the spherical aberration at the telephoto end and thus, facilitates achieving of high performance. Alternatively, this facilitates size reduction of the first lens group G1. For an upper limit of Conditional Expression (30), it is general that as a refractive index of an optical material is increased, a relative density is increased. Thus, ensuring that the corresponding value of Conditional Expression (30) is not greater than or equal to its upper limit can suppress an increase in weight of the lens and thus, facilitates weight reduction. In order to obtain more favorable characteristics, the variable magnification optical system more preferably satisfies Conditional Expression (30-1), further preferably satisfies Conditional Expression (30-2), yet further preferably satisfies Conditional Expression (30-3), and still more preferably satisfies Conditional Expression (30-4).

$$1.43 < NdL 2 < 1.81 \qquad ( 30 )$$

$$1.43 < NdL 2 < 1.76 \qquad ( 30 - 1 )$$

$$1.43 < NdL 2 < 1.71 \qquad ( 30 - 2 )$$

$$1.43 < NdL 2 < 1.66 \qquad ( 30 - 3 )$$

$$1.47 < NdL 2 < 1.61 \qquad ( 30 - 4 )$$

In a case where an Abbe number based on the d line for the second lens is denoted by νdL2, the variable magnification optical system preferably satisfies Conditional Expression (31). Ensuring that a corresponding value of Conditional Expression (31) is not less than or equal to its lower limit can suppress undercorrection of the axial chromatic aberration at the telephoto end. Alternatively, this prevents an excessively small difference in Abbe number between the positive lens and the negative lens constituting the first lens group G1 and thus, prevents an excessively strong refractive power of each lens constituting the first lens group G1. Consequently, this can suppress an increase in the high-order aberration of the spherical aberration at the telephoto end and thus, facilitates achieving of high performance. Ensuring that the corresponding value of Conditional Expression (31) is not greater than or equal to its upper limit can suppress overcorrection of the axial chromatic aberration at the telephoto end. Alternatively, this prevents an excessively large difference in Abbe number between the positive lens and the negative lens constituting the first lens group G1 and thus, prevents an excessively weak refractive power of the first lens. Consequently, this facilitates correction of the lateral chromatic aberration at the wide angle end. In order to obtain more favorable characteristics, the variable magnification optical system more preferably satisfies Conditional Expression (31-1), further preferably satisfies Conditional Expression (31-2), yet further preferably satisfies Conditional Expression (31-3), and still more preferably satisfies Conditional Expression (31-4).

$$45 < vdL 2 < 96 \qquad ( 31 )$$

$$45 < vdL 2 < 82 \qquad ( 31 - 1 )$$

$$45 < vdL 2 < 77 \qquad ( 31 - 2 )$$

$$45 < vdL 2 < 71 \qquad ( 31 - 3 )$$

$$49 < vdL 2 < 71 \qquad ( 31 - 4 )$$

The variable magnification optical system preferably satisfies Conditional Expression (32). Ensuring that a corresponding value of Conditional Expression (32) is not less than or equal to its lower limit enables selection of a material other than a material having a low refractive index and a small Abbe number and thus, can suppress an increase in the high-order aberration of the spherical aberration at the telephoto end. This facilitates achieving of high performance. Alternatively, this can suppress undercorrection of the axial chromatic aberration at the telephoto end. Ensuring that the corresponding value of Conditional Expression (32) is not greater than or equal to its upper limit enables selection of a material other than a material having a high refractive index and a large Abbe number and thus, enables selection of a material not having a high relative density and facilitates weight reduction. Alternatively, this can suppress overcorrection of the axial chromatic aberration at the telephoto end. In order to obtain more favorable characteristics, the variable magnification optical system more preferably satisfies Conditional Expression (32-1), further preferably satisfies Conditional Expression (32-2), yet further preferably satisfies Conditional Expression (32-3), and still more preferably satisfies Conditional Expression (32-4).

$$2 < NdL 2 + 0.01 \times vdL 2 < 2.5 \qquad ( 32 )$$

$$2.05 < NdL 2 + 0.01 \times vdL 2 < 2.45 \qquad ( 32 - 1 )$$

$$2.1 < NdL 2 + 0.01 \times vdL 2 < 2.4 \qquad ( 32 - 2 )$$

$$2.1 < NdL 2 + 0.01 \times vdL 2 < 2.35 \qquad ( 32 - 3 )$$

$$2.15 < NdL 2 + 0.01 \times vdL 2 < 2.35 \qquad ( 32 - 4 )$$

The variable magnification optical system preferably satisfies Conditional Expressions (30), (31), and (32) at the same time. The variable magnification optical system more preferably satisfies Conditional Expressions (30), (31), and (32) at the same time and at least one of Conditional Expression (30-1), (30-2), (30-3), (30-4), (31-1), (31-2), (31-3), (31-4), (32-1), (32-2), (32-3), or (32-4).

In the configuration in which the variable magnification optical system includes at least one focus group that moves during changing the magnification and during focusing, the variable magnification optical system preferably satisfies Conditional Expression (33). A focal length of the focus group having the smallest absolute value of the focal length among the focus groups included in the variable magnification optical system is denoted by ffoc. A focal length of the intermediate group GM in the state where the infinite distance object is in focus at the telephoto end is denoted by fMt. Ensuring that a corresponding value of Conditional Expression (33) is not less than or equal to its lower limit prevents an excessively strong refractive power of the focus group and thus, can suppress overcorrection of the aberrations during focusing. Ensuring that the corresponding value of Conditional Expression (33) is not greater than or equal to its upper limit prevents an excessively weak refractive power of the focus group and thus, can suppress undercorrection of the aberrations during focusing. In order to obtain more favorable characteristics, the variable magnification optical system more preferably satisfies Conditional Expression (33-1), further preferably satisfies Conditional Expression (33-2), yet further preferably satisfies Conditional Expression (33-3), and still more preferably satisfies Conditional Expression (33-4).

$$0.3 < \vert ffoc / fMt \vert < 4 \qquad ( 33 )$$

$$0.35 < \vert ffoc / fMt \vert < 3.5 \qquad ( 33 - 1 )$$

$$0.4 < \vert ffoc / fMt \vert < 3 \qquad ( 33 - 2 )$$

$$0.45 < \vert ffoc / fMt \vert < 2.5 \qquad ( 33 - 3 )$$

$$0.5 < \vert ffoc / fMt \vert < 2 \qquad ( 33 - 4 )$$

In the configuration in which the variable magnification optical system includes at least one focus group that moves during changing the magnification and during focusing, the variable magnification optical system preferably satisfies Conditional Expression (34). A lateral magnification of the focus group having the largest absolute value of the focal length among the focus groups included in the variable magnification optical system in the state where the infinite distance object is in focus at the telephoto end is denoted by βft. A combined lateral magnification of all lenses on the image side with respect to the focus group having the largest absolute value of the focal length in the state where the infinite distance object is in focus at the telephoto end is denoted by βfRt. Ensuring that a corresponding value of Conditional Expression (34) is not less than or equal to its lower limit prevents an excessively low ratio of a moving amount of the image plane to a unit moving amount of the focus group and thus, prevents an excessively large moving amount of the focus group during focusing. This achieves an advantage in achieving both of high performance and size reduction. Ensuring that the corresponding value of Conditional Expression (34) is not greater than or equal to its upper limit prevents an excessively high ratio of the moving amount of the image plane to the unit moving amount of the focus group and thus, achieves is an advantage in achieving both of manufacturing suitability and size reduction. In order to obtain more favorable characteristics, the variable magnification optical system more preferably satisfies Conditional Expression (34-1), further preferably satisfies Conditional Expression (34-2), yet further preferably satisfies Conditional Expression (34-3), and still more preferably satisfies Conditional Expression (34-4).

$$1 < \vert ( 1 - β {ft}^{2} ) \times β {fRt}^{2} \vert < 8 \qquad ( 34 )$$

$$1.3 < \vert ( 1 - β {ft}^{2} ) \times β {fRt}^{2} \vert < 7 \qquad ( 34 - 1 )$$

$$1.5 < \vert ( 1 - β {ft}^{2} ) \times β {fRt}^{2} \vert < 6 \qquad ( 34 - 2 )$$

$$1.7 < \vert ( 1 - β {ft}^{2} ) \times β {fRt}^{2} \vert < 5 \qquad ( 34 - 3 )$$

$$1.9 < \vert ( 1 - β {ft}^{2} ) \times β {fRt}^{2} \vert < 4 \qquad ( 34 - 4 )$$

In the configuration in which the focus group consists of one positive lens and two negative lenses, and the negative lens closest to the image side in the focus group is the aspherical lens, the variable magnification optical system preferably satisfies Conditional Expression (35) for the aspherical lens. A paraxial curvature radius of a surface of the aspherical lens on the object side is denoted by Rcnf. A paraxial curvature radius of a surface of the aspherical lens on the image side is denoted by Rcnr. A curvature radius of the surface of the aspherical lens on the object side at the position of the maximum effective diameter is denoted by Rynf. A curvature radius of the surface of the aspherical lens on the image side at the position of the maximum effective diameter is denoted by Rynr. Ensuring that a corresponding value of Conditional Expression (35) is not less than or equal to its lower limit prevents an excessively strong refractive power on an edge part side of the lens and thus, achieves an advantage in suppressing the distortion. Ensuring that the corresponding value of Conditional Expression (35) is not greater than or equal to its upper limit prevents an excessively weak refractive power on the edge part side of the lens and thus, achieves an advantage in correcting a field curvature and an astigmatism caused by an off-axis ray on the edge part side of the lens. In order to obtain more favorable characteristics, the variable magnification optical system more preferably satisfies Conditional Expression (35-1), further preferably satisfies Conditional Expression (35-2), yet further preferably satisfies Conditional Expression (35-3), and still more preferably satisfies Conditional Expression (35-4).

$$0.1 < ( 1 / Rcnf - 1 / Rcnr ) / ( 1 / Rynf - 1 / Rynr ) < 3 \qquad ( 35 )$$

$$0.15 < ( 1 / Rcnf - 1 / Rcnr ) / ( 1 / Rynf - 1 / Rynr ) < 2.5 \qquad ( 35 - 1 )$$

$$0.2 < ( 1 / Rcnf - 1 / Rcnr ) / ( 1 / Rynf - 1 / Rynr ) < 2 \qquad ( 35 - 2 )$$

$$0.25 < ( 1 / Rcnf - 1 / Rcnr ) / ( 1 / Rynf - 1 / Rynr ) < 1.5 \qquad ( 35 - 3 )$$

$$0.3 < ( 1 / Rcnf - 1 / Rcnr ) / ( 1 / Rynf - 1 / Rynr ) < 1 \qquad ( 35 - 4 )$$

In the configuration in which the focus group consists of one negative lens and two positive lenses, and the positive lens closest to the image side in the focus group is the aspherical lens, the variable magnification optical system preferably satisfies Conditional Expression (36) for the aspherical lens. A paraxial curvature radius of a surface of the aspherical lens on the object side is denoted by Rcpf. A paraxial curvature radius of a surface of the aspherical lens on the image side is denoted by Rcpr. A curvature radius of the surface of the aspherical lens on the object side at the position of the maximum effective diameter is denoted by Rypf. A curvature radius of the surface of the aspherical lens on the image side at the position of the maximum effective diameter is denoted by Rypr. Ensuring that a corresponding value of Conditional Expression (36) is not less than or equal to its lower limit prevents an excessively weak refractive power on an edge part side of the lens and thus, achieves an advantage in correcting the field curvature and the astigmatism caused by an off-axis ray on the edge part side of the lens. Ensuring that the corresponding value of Conditional Expression (36) is not greater than or equal to its upper limit prevents an excessively strong refractive power on the edge part side of the lens and thus, achieves an advantage in suppressing the distortion. In order to obtain more favorable characteristics, the variable magnification optical system more preferably satisfies Conditional Expression (36-1), further preferably satisfies Conditional Expression (36-2), yet further preferably satisfies Conditional Expression (36-3), and still more preferably satisfies Conditional Expression (36-4).

$$- 120 < ( 1 / Rcpf - 1 / Rcpr ) / ( 1 / Rypf - 1 / Rypr ) < - 3 \qquad ( 36 )$$

$$- 100 < ( 1 / Rcpf - 1 / Rcpr ) / ( 1 / Rypf - 1 / Rypr ) < - 6 \qquad ( 36 - 1 )$$

$$- 80 < ( 1 / Rcpf - 1 / Rcpr ) / ( 1 / Rypf - 1 / Rypr ) < - 9 \qquad ( 36 - 2 )$$

$$- 60 < ( 1 / Rcpf - 1 / Rcpr ) / ( 1 / Rypf - 1 / Rypr ) < - 12 \qquad ( 36 - 3 )$$

$$- 40 < ( 1 / Rcpf - 1 / Rcpr ) / ( 1 / Rypf - 1 / Rypr ) < - 15 \qquad ( 36 - 4 )$$

In the configuration in which the focus group consists of one negative lens, and the negative lens of the focus group is the aspherical lens, the variable magnification optical system preferably satisfies Conditional Expression (37) for the aspherical lens. A paraxial curvature radius of a surface of the aspherical lens on the object side is denoted by Rcsnf. A paraxial curvature radius of a surface of the aspherical lens on the image side is denoted by Rcsnr. A curvature radius of the surface of the aspherical lens on the object side at the position of the maximum effective diameter is denoted by Rysnf. A curvature radius of the surface of the aspherical lens on the image side at the position of the maximum effective diameter is denoted by Rysnr. Ensuring that a corresponding value of Conditional Expression (37) is not less than or equal to its lower limit prevents an excessively strong refractive power on an edge part side of the lens and thus, achieves an advantage in suppressing the distortion. Ensuring that the corresponding value of Conditional Expression (37) is not greater than or equal to its upper limit prevents an excessively weak refractive power on the edge part side of the lens and thus, achieves an advantage in correcting the field curvature and the astigmatism caused by an off-axis ray on the edge part side of the lens. In order to obtain more favorable characteristics, the variable magnification optical system more preferably satisfies Conditional Expression (37-1), further preferably satisfies Conditional Expression (37-2), yet further preferably satisfies Conditional Expression (37-3), and still more preferably satisfies Conditional Expression (37-4).

$$0.1 < ( 1 / Rcsnf - 1 / Rcsnr ) / ( 1 / Rysnf - 1 / Rysnr ) < 3.5 \qquad ( 37 )$$

$$0.2 < ( 1 / Rcsnf - 1 / Rcsnr ) / ( 1 / Rysnf - 1 / Rysnr ) < 3 \qquad ( 37 - 1 )$$

$$0.3 < ( 1 / Rcsnf - 1 / Rcsnr ) / ( 1 / Rysnf - 1 / Rysnr ) < 2.5 \qquad ( 37 - 2 )$$

$$0.4 < ( 1 / Rcsnf - 1 / Rcsnr ) / ( 1 / Rysnf - 1 / Rysnr ) < 2 \qquad ( 37 - 3 )$$

$$0.5 < ( 1 / Rcsnf - 1 / Rcsnr ) / ( 1 / Rysnf - 1 / Rysnr ) < 1.5 \qquad ( 37 - 4 )$$

In the configuration in which the image side focus group consists of one positive lens, and the positive lens of the image side focus group is the aspherical lens, the variable magnification optical system preferably satisfies Conditional Expression (38) for the aspherical lens. A paraxial curvature radius of a surface of the aspherical lens on the object side is denoted by Rcipf. A paraxial curvature radius of a surface of the aspherical lens on the image side is denoted by Rcipr. A curvature radius of the surface of the aspherical lens on the object side at the position of the maximum effective diameter is denoted by Ryipf. A curvature radius of the surface of the aspherical lens on the image side at the position of the maximum effective diameter is denoted by Ryipr. Ensuring that a corresponding value of Conditional Expression (38) is not less than or equal to its lower limit prevents an excessively strong refractive power on an edge part side of the lens and thus, achieves an advantage in suppressing the distortion. Ensuring that the corresponding value of Conditional Expression (38) is not greater than or equal to its upper limit prevents an excessively weak refractive power on the edge part side of the lens and thus, achieves an advantage in correcting the field curvature and the astigmatism caused by an off-axis ray on the edge part side of the lens. In order to obtain more favorable characteristics, the variable magnification optical system more preferably satisfies Conditional Expression (38-1), further preferably satisfies Conditional Expression (38-2), yet further preferably satisfies Conditional Expression (38-3), and still more preferably satisfies Conditional Expression (38-4).

$$1 < ( 1 / Rcipf - 1 / Rcipr ) / ( 1 / Ryipf - 1 / Ryipr ) < 100 \qquad ( 38 )$$

$$1.5 < ( 1 / Rcipf - 1 / Rcipr ) / ( 1 / Ryipf - 1 / Ryipr ) < 80 \qquad ( 38 - 1 )$$

$$2 < ( 1 / Rcipf - 1 / Rcipr ) / ( 1 / Ryipf - 1 / Ryipr ) < 60 \qquad ( 38 - 2 )$$

$$2.5 < ( 1 / Rcipf - 1 / Rcipr ) / ( 1 / Ryipf - 1 / Ryipr ) < 40 \qquad ( 38 - 3 )$$

$$3 < ( 1 / Rcipf - 1 / Rcipr ) / ( 1 / Ryipf - 1 / Ryipr ) < 20 \qquad ( 38 - 4 )$$

In the configuration in which the image side focus group consists of one negative lens, and the negative lens of the image side focus group is the aspherical lens, the variable magnification optical system preferably satisfies Conditional Expression (39) for the aspherical lens. A paraxial curvature radius of a surface of the aspherical lens on the object side is denoted by Rcinf. A paraxial curvature radius of a surface of the aspherical lens on the image side is denoted by Rcinr. A curvature radius of the surface of the aspherical lens on the object side at the position of the maximum effective diameter is denoted by Ryinf. A curvature radius of the surface of the aspherical lens on the image side at the position of the maximum effective diameter is denoted by Ryinr. Ensuring that a corresponding value of Conditional Expression (39) is not less than or equal to its lower limit prevents an excessively strong refractive power on an edge part side of the lens and thus, achieves an advantage in suppressing the distortion. Ensuring that the corresponding value of Conditional Expression (39) is not greater than or equal to its upper limit prevents an excessively weak refractive power on the edge part side of the lens and thus, achieves an advantage in correcting the field curvature and the astigmatism caused by an off-axis ray on the edge part side of the lens. In order to obtain more favorable characteristics, the variable magnification optical system more preferably satisfies Conditional Expression (39-1), further preferably satisfies Conditional Expression (39-2), yet further preferably satisfies Conditional Expression (39-3), and still more preferably satisfies Conditional Expression (39-4).

$$0.1 < ( 1 / Rcinf - 1 / Rcinr ) / ( 1 / Ryinf - 1 / Ryinr ) < 3.5 \qquad ( 39 )$$

$$0.2 < ( 1 / Rcinf - 1 / Rcinr ) / ( 1 / Ryinf - 1 / Ryinr ) < 3 \qquad ( 39 - 1 )$$

$$0.3 < ( 1 / Rcinf - 1 / Rcinr ) / ( 1 / Ryinf - 1 / Ryinr ) < 2.5 \qquad ( 39 - 2 )$$

$$0.4 < ( 1 / Rcinf - 1 / Rcinr ) / ( 1 / Ryinf - 1 / Ryinr ) < 2 \qquad ( 39 - 3 )$$

$$0.5 < ( 1 / Rcinf - 1 / Rcinr ) / ( 1 / Ryinf - 1 / Ryinr ) < 1.5 \qquad ( 39 - 4 )$$

In the configuration in which the final lens group GE consists of one positive lens that is the aspherical lens, the variable magnification optical system preferably satisfies Conditional Expression (40) for the aspherical lens. A paraxial curvature radius of a surface of the aspherical lens on the object side is denoted by RcEpf. A paraxial curvature radius of a surface of the aspherical lens on the image side is denoted by RcEpr. A curvature radius of the surface of the aspherical lens on the object side at the position of the maximum effective diameter is denoted by RyEpf. A curvature radius of the surface of the aspherical lens on the image side at the position of the maximum effective diameter is denoted by RyEpr. Ensuring that a corresponding value of Conditional Expression (40) is not less than or equal to its lower limit prevents an excessively strong refractive power on an edge part side of the lens and thus, achieves an advantage in suppressing the distortion. Ensuring that the corresponding value of Conditional Expression (40) is not greater than or equal to its upper limit prevents an excessively weak refractive power on the edge part side of the lens and thus, achieves an advantage in correcting the field curvature and the astigmatism caused by an off-axis ray on the edge part side of the lens. In order to obtain more favorable characteristics, the variable magnification optical system more preferably satisfies Conditional Expression (40-1), further preferably satisfies Conditional Expression (40-2), yet further preferably satisfies Conditional Expression (40-3), and still more preferably satisfies Conditional Expression (40-4).

$$0.1 < \vert ( 1 / RcEpf - 1 / RcEpr ) / ( 1 / RyEpf - 1 / RyEpr ) \vert < 5 \qquad ( 40 )$$

$$0.2 < \vert ( 1 / RcEpf - 1 / RcEpr ) / ( 1 / RyEpf - 1 / RyEpr ) \vert < 4 \qquad ( 40 - 1 )$$

$$0.3 < \vert ( 1 / RcEpf - 1 / RcEpr ) / ( 1 / RyEpf - 1 / RyEpr ) \vert < 3 \qquad ( 40 - 2 )$$

$$0.4 < \vert ( 1 / RcEpf - 1 / RcEpr ) / ( 1 / RyEpf - 1 / RyEpr ) \vert < 2 \qquad ( 40 - 3 )$$

$$0.5 < \vert ( 1 / RcEpf - 1 / RcEpr ) / ( 1 / RyEpf - 1 / RyEpr ) \vert < 1.5 \qquad ( 40 - 4 )$$

The example illustrated in FIG. 1 is merely an example and can be subjected to various modifications without departing from the gist of the disclosed technology. For example, the number of lens groups included in the intermediate group GM and the number of lenses included in each lens group may be different from the numbers in the example in FIG. 1.

The intermediate group GM of the example in FIG. 1 consists of two lens groups. However, in the disclosed technology, the intermediate group GM may be configured to consist of one lens group, may be configured to consist of three lens groups, may be configured to consist of four lens groups, or may be configured to consist of five lens groups.

The intermediate group GM and the final lens group GE may be configured as described below. The configuration described below achieves an advantage in suppressing fluctuation of the aberrations during changing the magnification. The intermediate group GM may be configured to consist of, in order from the object side to the image side, a lens group having a positive refractive power, a lens group having a positive refractive power, and a lens group having a negative refractive power, and the final lens group GE may be configured to have a positive refractive power. The intermediate group GM may be configured to consist of, in order from the object side to the image side, a lens group having a positive refractive power, a lens group having a positive refractive power, and a lens group having a positive refractive power, and the final lens group GE may be configured to have a negative refractive power. The intermediate group GM may be configured to consist of, in order from the object side to the image side, a lens group having a positive refractive power, a lens group having a negative refractive power, and a lens group having a negative refractive power, and the final lens group GE may be configured to have a positive refractive power. The intermediate group GM may be configured to consist of, in order from the object side to the image side, a lens group having a positive refractive power, a lens group having a positive refractive power, a lens group having a positive refractive power, and a lens group having a positive refractive power, and the final lens group GE may be configured to have a negative refractive power. The intermediate group GM may be configured to consist of, in order from the object side to the image side, a lens group having a positive refractive power, a lens group having a positive refractive power, a lens group having a negative refractive power, and a lens group having a positive refractive power, and the final lens group GE may be configured to have a negative refractive power. The intermediate group GM may be configured to consist of, in order from the object side to the image side, a lens group having a positive refractive power, a lens group having a positive refractive power, a lens group having a negative refractive power, and a lens group having a negative refractive power, and the final lens group GE may be configured to have a positive refractive power. The intermediate group GM may be configured to consist of, in order from the object side to the image side, a lens group having a positive refractive power, a lens group having a positive refractive power, a lens group having a negative refractive power, a lens group having a negative refractive power, and a lens group having a positive refractive power, and the final lens group GE may be configured to have a negative refractive power.

The final lens group GE may be configured to move during changing the magnification. Doing so achieves an advantage in suppressing fluctuation of the aberrations during changing the magnification.

The variable magnification optical system of the present disclosure may be configured to include a plurality of lens groups that move on the same moving path during changing the magnification from the wide angle end to the telephoto end. Doing so enables the lens groups moving on the same moving path to be driven by one cam and thus, can simplify a lens group drive mechanism. The term “same moving path during changing the magnification from the wide angle end to the telephoto end” means the same moving path in the entire magnification range from the wide angle end to the telephoto end.

The variable magnification optical system of the present disclosure may be a zoom lens or a varifocal lens.

The above preferable configurations and available configurations can be combined with each other in any manner and are preferably selectively adopted, as appropriate, in accordance with required specifications. The conditional expressions preferably satisfied by the variable magnification optical system of the present disclosure are not limited to the conditional expressions described in expression forms and include all conditional expressions obtained by combining the lower limits and the upper limits with each other in any manner from the preferable, more preferable, further preferable, yet further preferable, and still more preferable conditional expressions.

For example, according to a preferable first aspect of the present disclosure, the variable magnification optical system consists of, in order from the object side to the image side, the first lens group G1 having a positive refractive power, the second lens group G2 having a negative refractive power, the intermediate group GM, and the final lens group GE having a refractive power, in which the intermediate group GM consists of one or more and five or less lens groups, during changing the magnification, the spacing between the first lens group G1 and the second lens group G2 changes, the spacing between the second lens group G2 and the intermediate group GM changes, and the spacing between the intermediate group GM and the final lens group GE changes, in a case where the intermediate group GM consists of a plurality of lens groups, all spacings between adjacent lens groups in the intermediate group GM change during changing the magnification, the aperture stop St is disposed between the lens surface of the second lens group G2 closest to the image side and the lens surface of the final lens group GE closest to the object side, the first lens group G1 includes, in consecutive order from the object side to the image side, the first lens that is a negative lens, and the second lens that is a positive lens, and Conditional Expressions (1), (2), and (3) are satisfied.

According to a preferable second aspect of the present disclosure, in the variable magnification optical system of the first aspect, Conditional Expressions (4), (5), (6), and (7) are further satisfied.

Next, examples of the variable magnification optical system of the present disclosure will be described with reference to the drawings. Reference numerals provided to the lenses in the cross-sectional view of each example are independently used for each example in order to avoid complication of description and the drawings caused by an increasing number of digits of the reference numerals. Accordingly, a common reference numeral provided in the drawings of different examples does not necessarily indicate a common configuration.

### Example 1

A configuration and a moving path of the variable magnification optical system of Example 1 are illustrated in FIG. 1, and its illustration method and configuration are described above. Thus, duplicate descriptions will be partially omitted. The variable magnification optical system of Example 1 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During changing the magnification from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4. During focusing from the infinite distance object to the nearest object, the focus group moves to the image side.

For the variable magnification optical system of Example 1, Table 1 shows basic lens data, Table 2 shows specifications and a variable surface spacing, and Table 3 shows aspherical coefficients.

The table of the basic lens data is described as follows. A column of Sn shows surface numbers in a case where the number is increased by one at a time toward the image side from a first surface that is a surface closest to the object side. A column of R shows a curvature radius of each surface. A column of D shows a surface spacing on the optical axis between each surface and its adjacent surface on the image side. A column of Nd shows a refractive index with respect to a d line for each constituent. A column of νd shows an Abbe number based on the d line for each constituent. A column of θgF shows a partial dispersion ratio between a g line and an F line for each constituent. A column of ED shows an effective diameter of each surface.

In the table of the basic lens data, a sign of the curvature radius of the surface having a convex shape facing the object side is positive, and a sign of the curvature radius of the surface having a convex shape facing the image side is negative. Table 1 also shows the aperture stop St, and the column of the surface number of the surface corresponding to the aperture stop St shows the surface number and a text (St). A value in the lowermost field of the column of the surface spacing in the table indicates a spacing between a surface closest to the image side in the table and the image plane Sim. A symbol DD[ ] is used for the variable surface spacing. A surface number on the object side of the spacing is shown in [ ] in the column of the surface spacing.

Table 2 shows a zoom ratio Zr, a focal length f, an open F-number FNo., a maximum full angle of view 2ω, and the variable surface spacing based on the d line. In a case where the variable magnification optical system is a zoom lens, the zoom ratio is synonymous with a zoom magnification. In a field of 2ω, [° ] indicates a degree unit. In Table 2, each value in the wide angle end state is shown in a column labeled “Wide”, each value in a middle focal length state is shown in a column labeled “Middle”, and each value in the telephoto end state is shown in a column labeled “Tele”.

In the basic lens data, a surface number of an aspherical surface is marked with *, and a value of a paraxial curvature radius is shown in the field of the curvature radius of the aspherical surface. In Table 3, the column of Sn shows the surface number of the aspherical surface, and columns of KA and Am show numerical values of the aspherical coefficients for each aspherical surface. Here, m of Am is an integer greater than or equal to 3 and varies depending on the surface. For example, m=3, 4, 5, 6, 7, 8, 9, and 10 is established for an eighth surface of Example 1. In the numerical values of the aspherical coefficients in Table 3, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + Σ Am \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients
Σ in the aspheric equation means a sum total related to m.

In the data of each table, a degree unit is used for angles, and a millimeter unit is used for lengths. However, since the optical system can also be proportionally enlarged or proportionally reduced to be used, other appropriate units can also be used. Each table below shows numerical values rounded to predetermined digits.

TABLE 1
Example 1

| Sn | R | D | Nd | νd | θgF | ED |
|---|---|---|---|---|---|---|
| 1 | 166.9813 | 1.5000 | 1.88372 | 20.81 | 0.62796 | 50.60 |
| 2 | 81.7867 | 4.0808 | 1.48749 | 70.44 | 0.53062 | 48.80 |
| 3 | 257.7942 | 0.1500 | | | | 48.02 |
| 4 | 45.0914 | 5.9655 | 1.78457 | 49.54 | 0.54993 | 44.60 |
| 5 | 154.3738 | DD[5] | | | | 43.53 |
| 6 | 47.5370 | 1.0000 | 1.75917 | 52.08 | 0.54632 | 28.07 |
| 7 | 11.7201 | 8.4262 | | | | 20.07 |
| *8 | −21.1101 | 1.6000 | 1.51601 | 52.71 | 0.55457 | 19.24 |
| *9 | 29.5044 | 0.4015 | | | | 17.85 |
| 10 | 35.7739 | 3.8436 | 1.94000 | 30.26 | 0.59757 | 17.80 |
| 11 | −44.2947 | 1.8378 | | | | 18.09 |
| 12 | −18.4297 | 0.8000 | 1.59445 | 61.36 | 0.54201 | 18.07 |
| 13 | −38.7005 | DD[13] | | | | 18.83 |
| 14 (St) | ∞ | 1.1000 | | | | 19.50 |
| *15 | 27.3702 | 4.8112 | 1.68948 | 31.02 | 0.59874 | 21.25 |
| *16 | −95.1444 | 2.4908 | | | | 21.91 |
| 17 | 178.9235 | 0.8002 | 1.74331 | 27.84 | 0.60412 | 21.66 |
| 18 | 16.8228 | 5.4793 | 1.49700 | 81.61 | 0.53887 | 21.29 |
| 19 | 120.4821 | 0.1502 | | | | 21.66 |
| 20 | 33.4205 | 6.0100 | 1.49700 | 81.61 | 0.53887 | 22.22 |
| 21 | −30.1550 | 0.8000 | 1.71991 | 29.01 | 0.60086 | 22.20 |
| 22 | −213.2305 | 0.1501 | | | | 22.45 |
| *23 | 37.9913 | 5.8592 | 1.49700 | 81.61 | 0.53887 | 22.54 |
| *24 | −21.8825 | DD[24] | | | | 22.86 |
| 25 | 153.8337 | 2.1836 | 1.89999 | 20.00 | 0.63131 | 17.51 |
| 26 | −80.4673 | 0.6100 | 1.87504 | 40.50 | 0.56717 | 16.94 |
| 27 | 25.0256 | DD[27] | | | | 16.00 |
| *28 | −96.9598 | 2.8834 | 1.70445 | 56.28 | 0.54269 | 24.72 |
| *29 | −36.5652 | 19.0000 | | | | 25.60 |

TABLE 2
Example 1

| | Wide | Middle | Tele |
|---|---|---|---|
| Zr | 1.0 | 1.8 | 3.2 |
| f | 16.49 | 30.12 | 53.39 |
| FNo. | 2.88 | 2.88 | 2.88 |
| 2ω [°] | 86.2 | 49.0 | 28.6 |
| DD[5] | 0.80 | 13.87 | 25.96 |
| DD[13] | 16.78 | 4.25 | 0.98 |
| DD[24] | 2.42 | 5.42 | 2.40 |
| DD[27] | 5.12 | 9.16 | 29.11 |

TABLE 3
Example 1

| Sn | 8 | 9 | 15 | 16 |
|---|---|---|---|---|
| KA | 1.0000000E+00 | 1.0000000E+00 | 1.0000000E+00 | 1.0000000E+00 |
| A3 | −1.9549851E−19 | 0.0000000E+00 | −5.0194545E−20 | 5.0194545E−20 |
| A4 | 1.7452529E−04 | 1.0216801E−04 | −3.4635590E−05 | −3.2913597E−05 |
| A5 | −2.4469385E−05 | −1.9411839E−05 | 2.8711995E−06 | 3.2681977E−06 |
| A6 | 3.4890476E−07 | −1.3228490E−07 | −3.8022736E−07 | −3.1625258E−07 |
| A7 | 2.1971499E−07 | 2.0605528E−07 | −1.3059424E−08 | −2.1857719E−08 |
| A8 | −1.4606187E−08 | −1.0706850E−08 | 3.4451726E−09 | 3.4005640E−09 |
| A9 | −4.5557919E−10 | −6.4603927E−10 | −1.4468609E−10 | −1.0629089E−10 |
| A10 | 5.0125647E−11 | 5.0442404E−11 | −8.3521220E−12 | −6.6972378E−12 |
| Sn | 23 | 24 | 28 | 29 |
| KA | 1.0000000E+00 | 1.0000000E+00 | 1.0000000E+00 | 1.0000000E+00 |
| A3 | −1.0038909E−19 | 0.0000000E+00 | −5.2879850E−20 | 0.0000000E+00 |
| A4 | −5.3108909E−05 | 1.2271396E−05 | −4.1748417E−05 | −1.3789177E−05 |
| A5 | 3.4055280E−07 | −1.6869878E−06 | 6.9537146E−06 | −1.1104916E−06 |
| A6 | 3.0385219E−07 | 4.6527853E−07 | −3.9603014E−07 | 6.0429904E−07 |
| A7 | −6.5717352E−08 | −6.3409658E−08 | −3.3303261E−08 | −6.4596912E−08 |
| A8 | 1.7280897E−09 | −1.6208345E−10 | 3.9999483E−09 | 2.0640441E−10 |
| A9 | 2.9013903E−10 | 4.3980611E−10 | −4.4466335E−11 | 3.0045096E−10 |
| A10 | −2.0578906E−11 | −2.4001174E−11 | −7.5462945E−12 | −1.4950658E−11 |

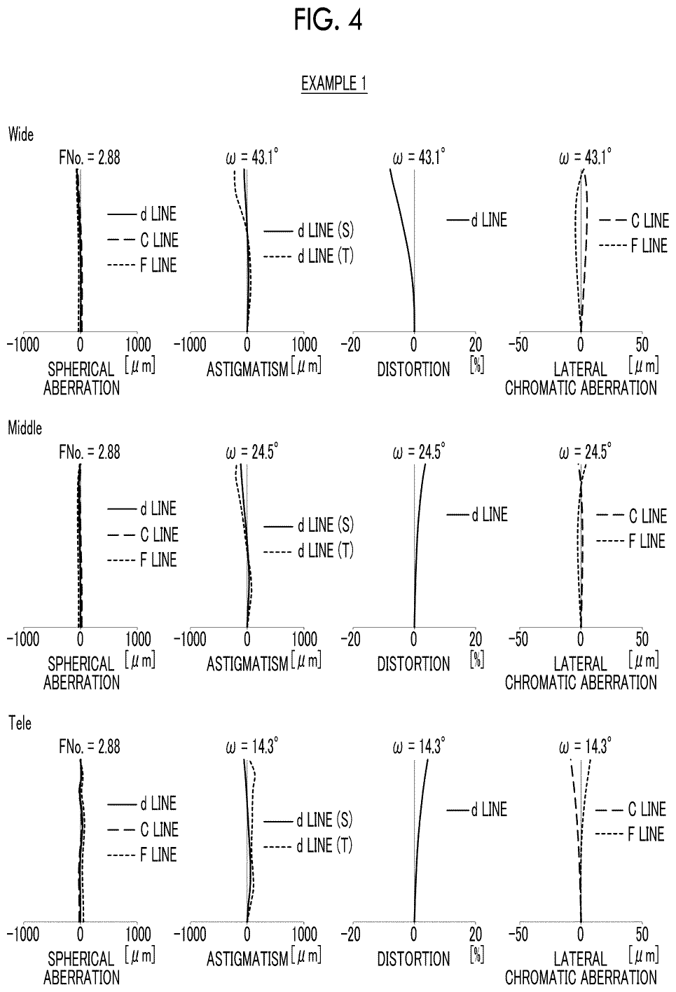

FIG. 4 illustrates each aberration diagram of the variable magnification optical system of Example 1 in the state where the infinite distance object is in focus. In FIG. 4, the spherical aberration, the astigmatism, the distortion, and the lateral chromatic aberration are illustrated in this order from the left. In FIG. 4, the aberrations in the wide angle end state are illustrated in an upper part labeled “Wide”, the aberrations in the middle focal length state are illustrated in a middle part labeled “Middle”, and the aberrations in the telephoto end state are illustrated in a lower part labeled “Tele”. In the spherical aberration diagram, the aberrations on a d line, a C line, and an F line are illustrated by a solid line, a long broken line, and a short broken line, respectively. In the astigmatism diagram, the aberration on the d line in a sagittal direction is illustrated by a solid line, and the aberration on the d line in a tangential direction is illustrated by a short broken line. In the distortion diagram, the aberration on the d line is illustrated by a solid line. In the lateral chromatic aberration diagram, the aberrations on the C line and the F line are illustrated by a long broken line and a short broken line, respectively. In the spherical aberration diagram, a value of the open F-number is shown after “FNo.=”. In other aberration diagrams, a value of the maximum half angle of view is shown after ω=.

Symbols, meanings, description methods, and illustration methods of each data related to Example 1 are basically the same for the following examples unless otherwise specified. Thus, duplicate descriptions will be omitted below.

### Example 2

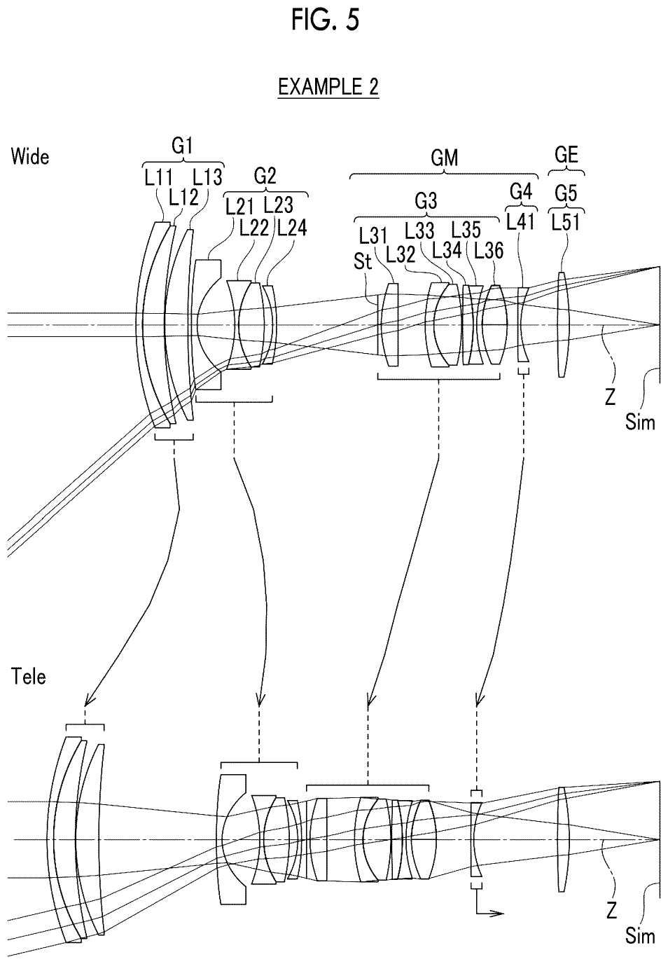

A configuration and a moving path of a variable magnification optical system of Example 2 are illustrated in FIG. 5. The variable magnification optical system of Example 2 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During changing the magnification from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and six lenses including the lenses L31 to L36. The fourth lens group G4 consists of one lens that is the lens L41. The fifth lens group G5 consists of one lens that is the lens L51.

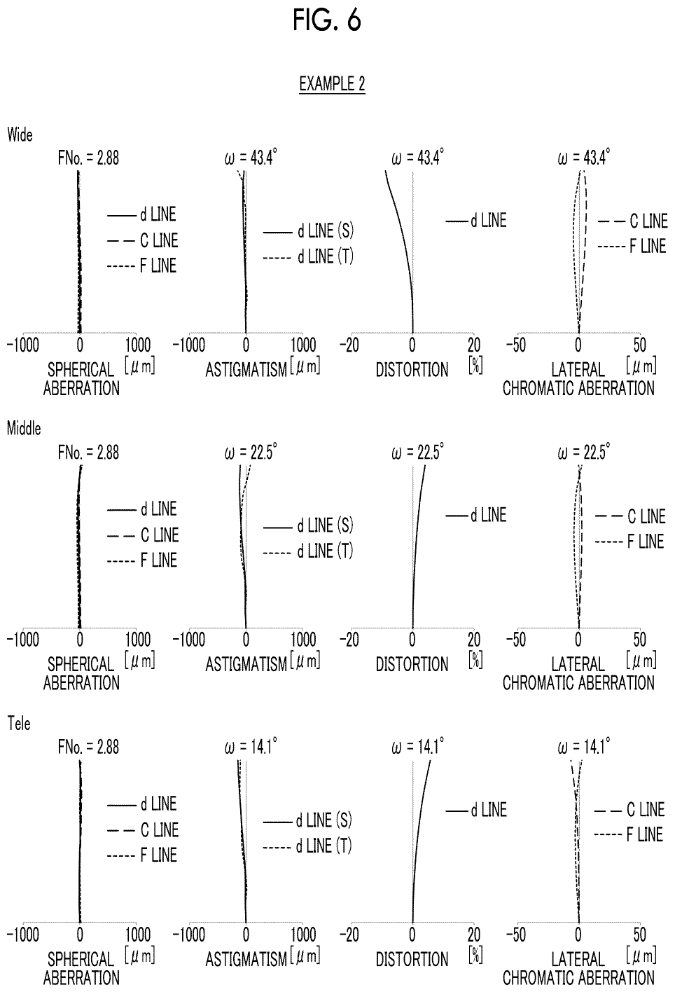

For the variable magnification optical system of Example 2, Table 4 shows basic lens data, Table 5 shows specifications and a variable surface spacing, Table 6 shows aspherical coefficients, and FIG. 6 illustrates each aberration diagram.

TABLE 4
Example 2

| Sn | R | D | Nd | νd | θgF | ED |
|---|---|---|---|---|---|---|
| 1 | 73.8399 | 1.5000 | 1.92286 | 20.88 | 0.63992 | 50.00 |
| 2 | 49.0167 | 4.9618 | 1.59283 | 68.63 | 0.54286 | 48.10 |
| 3 | 109.7447 | 0.1000 | | | | 47.54 |
| 4 | 54.2438 | 5.2575 | 1.80510 | 47.36 | 0.55600 | 46.36 |
| 5 | 213.2070 | DD[5] | | | | 45.52 |
| *6 | 133.2451 | 1.3009 | 1.85135 | 40.10 | 0.56954 | 31.61 |
| *7 | 13.9053 | 8.5917 | | | | 22.90 |
| 8 | −32.1467 | 0.8908 | 1.69322 | 46.63 | 0.56170 | 21.57 |
| 9 | 19.9950 | 5.8165 | 1.92105 | 29.99 | 0.59863 | 20.42 |
| 10 | −47.1897 | 1.9413 | | | | 19.80 |
| 11 | −20.4192 | 0.8892 | 1.56420 | 70.12 | 0.54049 | 19.00 |
| 12 | −45.9983 | DD[12] | | | | 19.05 |
| 13 (St) | ∞ | 0.8009 | | | | 18.75 |
| *14 | 28.9235 | 3.8370 | 1.62138 | 45.13 | 0.56739 | 19.95 |
| *15 | −2191.9602 | 6.1597 | | | | 20.04 |
| 16 | 37.4461 | 1.9461 | 1.75371 | 36.27 | 0.58432 | 20.51 |
| 17 | 15.7596 | 6.3475 | 1.53394 | 76.56 | 0.54005 | 19.69 |
| 18 | −45.5040 | 0.2263 | | | | 19.65 |
| 19 | 353.9353 | 2.4189 | 1.56284 | 72.67 | 0.54205 | 19.27 |
| 20 | −42.6149 | 0.8007 | 1.74198 | 41.72 | 0.57064 | 19.04 |
| 21 | 31.0750 | 1.2482 | | | | 18.64 |
| *22 | 20.3053 | 5.6883 | 1.50487 | 80.44 | 0.53923 | 19.14 |
| *23 | −26.3523 | DD[23] | | | | 18.90 |
| 24 | 414.1850 | 0.7000 | 1.59349 | 67.00 | 0.53667 | 18.00 |
| 25 | 22.6891 | DD[25] | | | | 17.99 |
| *26 | 226.7884 | 2.6886 | 1.59201 | 67.02 | 0.53589 | 25.13 |
| *27 | −67.1003 | 20.6600 | | | | 25.40 |

TABLE 5
Example 2

| | Wide | Middle | Tele |
|---|---|---|---|
| Zr | 1.0 | 2.0 | 3.2 |
| f | 16.49 | 32.99 | 53.43 |
| FNo. | 2.88 | 2.88 | 2.88 |
| 2ω [°] | 86.8 | 45.0 | 28.2 |
| DD[5] | 0.80 | 13.83 | 26.78 |
| DD[12] | 22.92 | 6.14 | 1.08 |
| DD[23] | 2.41 | 7.19 | 7.83 |
| DD[25] | 8.35 | 12.96 | 19.07 |

TABLE 6
Example 2

| Sn | 6 | 7 | 14 | 15 |
|---|---|---|---|---|
| KA | 1.0000000E+00 | −1.5186480E+00 | 1.0000000E+00 | 1.0000000E+00 |
| A3 | 0.0000000E+00 | 0.0000000E+00 | 0.0000000E+00 | 0.0000000E+00 |
| A4 | −1.0596326E−05 | 6.5327028E−05 | −1.1793774E−05 | 3.1245934E−06 |
| A5 | 3.0924761E−06 | 2.0428907E−05 | −2.1426576E−06 | −1.0648004E−05 |
| A6 | −4.4675901E−07 | −6.5312452E−06 | 1.6767813E−06 | 7.3949414E−06 |
| A7 | 2.8398731E−08 | 1.1158373E−06 | −7.0273048E−07 | −2.6058768E−06 |
| A8 | −1.9998006E−10 | −1.1892023E−07 | 1.9162909E−07 | 4.6539139E−07 |
| A9 | 3.7541303E−11 | 1.1492334E−08 | −3.6664707E−08 | −1.9458004E−08 |
| A10 | −1.3949244E−11 | −1.4637867E−09 | 5.3561192E−09 | −8.0990207E−09 |
| A11 | 7.7042427E−13 | 1.0342315E−10 | −6.3502450E−10 | 1.5917514E−09 |
| A12 | 7.6705836E−15 | 8.3875528E−12 | 5.8379204E−11 | −9.8464890E−11 |
| A13 | −3.8440226E−16 | −2.0015818E−12 | −3.5533307E−12 | −3.5658440E−12 |
| A14 | −1.4525898E−16 | 1.2214952E−13 | 1.0495456E−13 | 8.7617404E−13 |
| A15 | 9.0636340E−18 | −2.0373832E−15 | 3.9353803E−16 | −4.8600244E−14 |
| A16 | −1.5826168E−19 | −2.9676553E−17 | −7.2922420E−17 | 9.5349130E−16 |

| Sn | 22 | 23 | 26 | 27 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −3.4201359E−05 | −1.2961283E−05 | −4.1022080E−06 | −6.3820371E−06 |
| A5 | −3.2097127E−07 | 4.0713924E−05 | −3.4287669E−09 | 1.3578080E−05 |
| A6 | 1.7766056E−06 | −3.2635088E−05 | 2.2330462E−08 | −8.3197938E−06 |
| A7 | −1.7459050E−06 | 1.3851387E−05 | −6.2885631E−10 | 2.6720140E−06 |
| A8 | 7.8951577E−07 | −3.4627748E−06 | 3.8435939E−11 | −5.1750967E−07 |
| A9 | −1.9453450E−07 | 5.0945583E−07 | −8.8478289E−12 | 6.1158836E−08 |
| A10 | 2.5079218E−08 | −3.7868351E−08 | −1.0445259E−13 | −3.9014348E−09 |
| A11 | −7.0258956E−10 | 2.2038622E−10 | 1.1953560E−13 | 4.7277785E−11 |
| A12 | −2.8604796E−10 | 1.2159786E−10 | −1.0715499E−14 | 9.4238462E−12 |
| A13 | 4.7633598E−11 | 7.8530640E−12 | 3.0100870E−16 | −2.6732691E−13 |
| A14 | −3.4603043E−12 | −2.3754551E−12 | 1.1894561E−17 | −3.7548548E−14 |
| A15 | 1.2367526E−13 | 1.5614164E−13 | −1.0198838E−18 | 2.7428897E−15 |
| A16 | −1.7128133E−15 | −3.4996819E−15 | 2.0026709E−20 | −5.5315789E−17 |

### Example 3

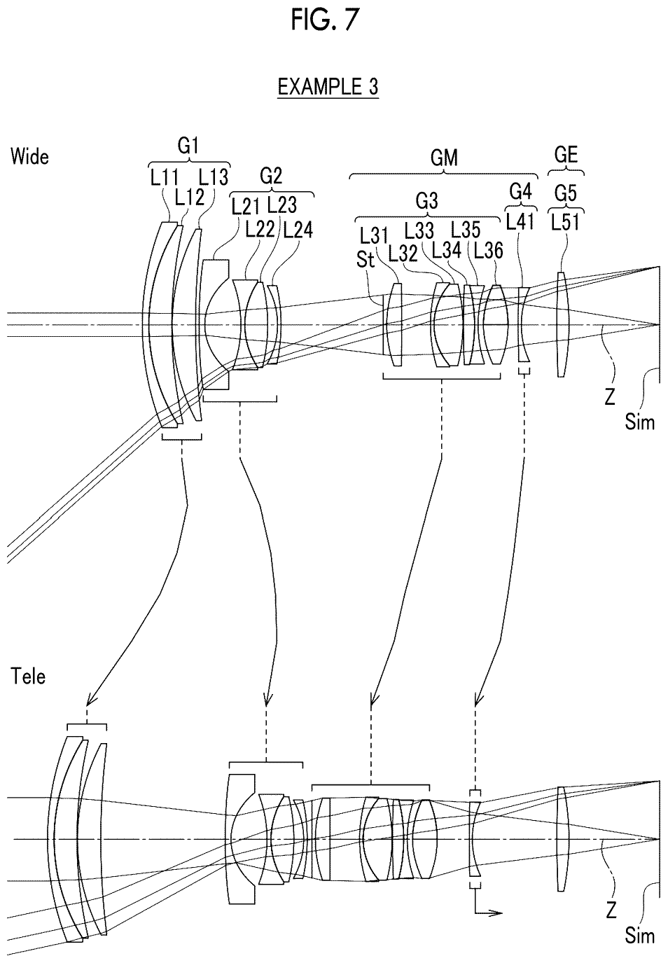

A configuration and a moving path of a variable magnification optical system of Example 3 are illustrated in FIG. 7. The variable magnification optical system of Example 3 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During changing the magnification from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and six lenses including the lenses L31 to L36. The fourth lens group G4 consists of one lens that is the lens L41. The fifth lens group G5 consists of one lens that is the lens L51.

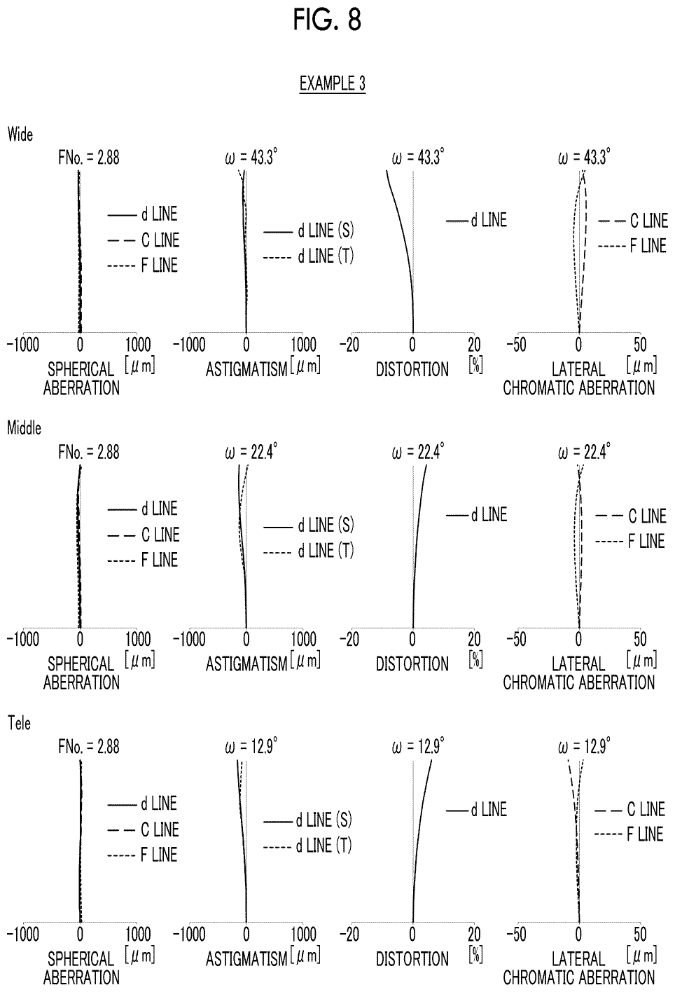

For the variable magnification optical system of Example 3, Table 7 shows basic lens data, Table 8 shows specifications and a variable surface spacing, Table 9 shows aspherical coefficients, and FIG. 8 illustrates each aberration diagram.

TABLE 7
Example 3

| Sn | R | D | Nd | νd | θgF | ED |
|---|---|---|---|---|---|---|
| 1 | 71.6363 | 1.5005 | 1.92286 | 20.88 | 0.63992 | 50.00 |
| 2 | 47.7581 | 5.2149 | 1.59283 | 68.63 | 0.54286 | 48.17 |
| 3 | 112.6790 | 0.1000 | | | | 47.68 |
| 4 | 52.7073 | 5.3223 | 1.80357 | 47.64 | 0.55541 | 46.57 |
| 5 | 197.5620 | DD[5] | | | | 45.79 |
| *6 | 143.9552 | 1.3005 | 1.85135 | 40.10 | 0.56954 | 31.60 |
| *7 | 13.6561 | 8.2305 | | | | 22.75 |
| 8 | −32.2270 | 0.8992 | 1.68511 | 45.42 | 0.56452 | 21.88 |
| 9 | 19.7904 | 5.2153 | 1.92120 | 29.40 | 0.60050 | 20.73 |
| 10 | −45.5336 | 2.2386 | | | | 20.36 |
| 11 | −20.3877 | 0.8004 | 1.59639 | 65.17 | 0.54254 | 19.00 |
| 12 | −46.3394 | DD[12] | | | | 19.06 |
| 13 (St) | ∞ | 0.8006 | | | | 18.76 |
| *14 | 29.1776 | 3.3620 | 1.65041 | 45.75 | 0.56505 | 19.97 |
| *15 | −3388.9635 | 6.5976 | | | | 20.03 |
| 16 | 37.3585 | 0.8000 | 1.74300 | 37.30 | 0.58171 | 20.47 |
| 17 | 15.6275 | 6.5812 | 1.53988 | 75.76 | 0.54046 | 19.86 |
| 18 | −42.8525 | 0.1219 | | | | 19.81 |
| 19 | 239.4891 | 2.5420 | 1.56669 | 72.15 | 0.54232 | 19.35 |
| 20 | −41.2348 | 0.8008 | 1.79280 | 42.22 | 0.56779 | 19.07 |
| 21 | 31.2115 | 1.2156 | | | | 18.63 |
| *22 | 20.1890 | 5.6053 | 1.50462 | 80.48 | 0.53922 | 19.13 |
| *23 | −25.7706 | DD[23] | | | | 18.90 |
| 24 | 344.4230 | 0.7000 | 1.59349 | 67.00 | 0.53667 | 18.00 |
| 25 | 22.1694 | DD[25] | | | | 17.97 |
| *26 | 250.2970 | 2.7494 | 1.59201 | 67.02 | 0.53589 | 25.04 |
| *27 | −68.2775 | 20.6700 | | | | 25.34 |

TABLE 8
Example 3

| | Wide | Middle | Tele |
|---|---|---|---|
| Zr | 1.0 | 2.0 | 3.5 |
| f | 16.49 | 32.99 | 58.38 |
| FNo. | 2.88 | 2.88 | 2.88 |
| 2ω [°] | 86.6 | 44.8 | 25.8 |
| DD[5] | 0.80 | 13.83 | 28.36 |
| DD[12] | 23.16 | 6.61 | 1.04 |
| DD[23] | 2.32 | 7.10 | 7.32 |
| DD[25] | 8.11 | 11.81 | 19.27 |

TABLE 9
Example 3

| Sn | 6 | 7 | 14 | 15 |
|---|---|---|---|---|
| KA | 1.0000000E+00 | −1.4801192E+00 | 1.0000000E+00 | 1.0000000E+00 |
| A3 | 0.0000000E+00 | 0.0000000E+00 | 0.0000000E+00 | 0.0000000E+00 |
| A4 | −1.0645638E−05 | 7.1134208E−05 | −1.1589423E−05 | −2.8982805E−06 |
| A5 | 3.1121787E−06 | 1.4666355E−05 | −3.0603090E−06 | −2.1657647E−07 |
| A6 | −4.4945027E−07 | −1.4236463E−06 | 2.1246336E−06 | −1.2344366E−07 |
| A7 | 2.8060830E−08 | −1.3375557E−06 | −7.3375251E−07 | 2.2793290E−07 |
| A8 | −4.5600536E−11 | 6.0115796E−07 | 1.3588211E−07 | −1.0480647E−07 |
| A9 | 2.3379767E−11 | −1.2315684E−07 | −9.8282038E−09 | 2.5205163E−08 |
| A10 | −1.5422119E−11 | 1.4207633E−08 | −8.5488733E−10 | −3.3430369E−09 |
| A11 | 1.2774775E−12 | −8.5225623E−10 | 2.1468720E−10 | 2.4011410E−10 |
| A12 | −5.2439020E−14 | 2.9503562E−12 | −1.1628147E−11 | −1.6056578E−11 |
| A13 | 3.6599560E−15 | 4.0429806E−12 | −3.9452985E−13 | 2.8220525E−12 |
| A14 | −3.0844851E−16 | −3.6863807E−13 | 5.8963788E−14 | −3.6868441E−13 |
| A15 | 1.2761942E−17 | 1.6309877E−14 | −1.3463133E−15 | 2.2467723E−14 |
| A16 | −1.9463926E−19 | −3.1023348E−16 | −1.4577375E−17 | −5.1762525E−16 |
| Sn | 22 | 23 | 26 | 27 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −4.0119349E−05 | 1.9018353E−06 | −4.6726746E−06 | 2.5426212E−06 |
| A5 | 8.6647618E−06 | 1.5815020E−05 | −8.7146605E−10 | 7.6065488E−07 |
| A6 | −6.0441480E−06 | −1.6482326E−05 | 2.5330418E−08 | −4.0405715E−07 |
| A7 | 2.0440119E−06 | 9.3212099E−06 | −2.8275054E−10 | −2.5201473E−08 |
| A8 | −3.3134941E−07 | −3.3037300E−06 | −1.3161741E−11 | 3.0923208E−08 |
| A9 | 8.4382034E−09 | 7.2912243E−07 | −1.4172765E−11 | −5.2991382E−09 |
| A10 | 5.7521948E−09 | −8.3274359E−08 | 1.7534478E−12 | 3.7982430E−10 |
| A11 | −8.4821909E−10 | −1.6833815E−09 | −8.9900058E−14 | −2.1834980E−11 |
| A12 | 2.2335186E−11 | 2.1844631E−09 | −1.8614595E−15 | 3.8443544E−12 |
| A13 | 4.2042872E−12 | −3.5302038E−10 | 7.0023616E−16 | −5.0597253E−13 |
| A14 | −3.1472440E−13 | 2.9003296E−11 | −5.2429335E−17 | 3.2068993E−14 |
| A15 | −4.7486419E−17 | −1.2617995E−12 | 1.8409507E−18 | −9.4261401E−16 |
| A16 | 3.9678089E−16 | 2.3130469E−14 | −2.6107516E−20 | 9.8786637E−18 |

### Example 4

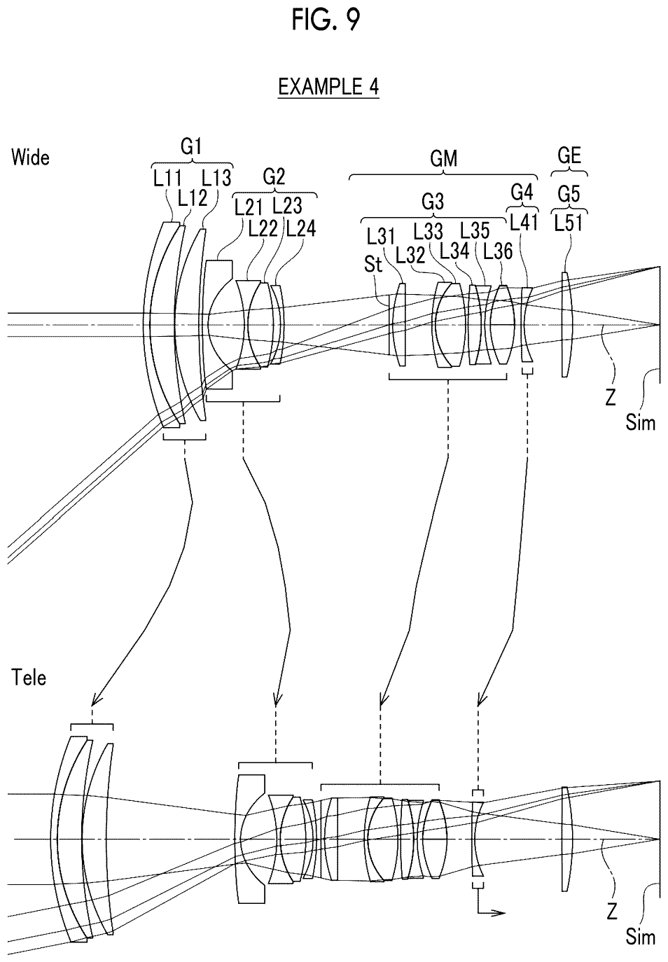

A configuration and a moving path of a variable magnification optical system of Example 4 are illustrated in FIG. 9. The variable magnification optical system of Example 4 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During changing the magnification from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and six lenses including the lenses L31 to L36. The fourth lens group G4 consists of one lens that is the lens L41. The fifth lens group G5 consists of one lens that is the lens L51.

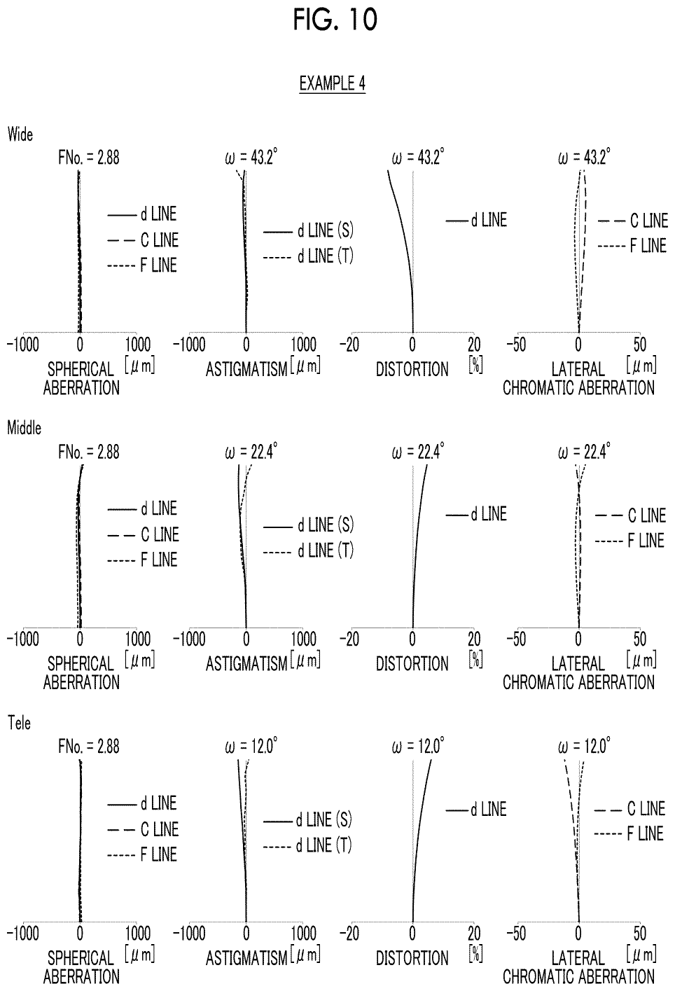

For the variable magnification optical system of Example 4, Table 10 shows basic lens data, Table 11 shows specifications and a variable surface spacing, Table 12 shows aspherical coefficients, and FIG. 10 illustrates each aberration diagram.

TABLE 10
Example 4

| Sn | R | D | Nd | νd | θgF | ED |
|---|---|---|---|---|---|---|
| 1 | 70.0754 | 1.4991 | 1.92286 | 20.88 | 0.63992 | 50.00 |
| 2 | 46.0550 | 5.5631 | 1.59283 | 68.63 | 0.54286 | 48.14 |
| 3 | 115.1986 | 0.1000 | | | | 47.68 |
| 4 | 49.3297 | 5.5057 | 1.81142 | 46.86 | 0.55692 | 46.53 |
| 5 | 168.1898 | DD[5] | | | | 45.73 |
| *6 | 151.4894 | 1.3004 | 1.85135 | 40.10 | 0.56954 | 31.37 |
| *7 | 13.2223 | 8.2475 | | | | 22.40 |
| 8 | −31.5098 | 0.8108 | 1.66878 | 46.13 | 0.56362 | 21.56 |
| 9 | 19.5887 | 5.7943 | 1.92120 | 29.70 | 0.59953 | 20.46 |
| 10 | −40.7007 | 1.6658 | | | | 19.92 |
| 11 | −21.1261 | 0.7999 | 1.70386 | 56.31 | 0.54350 | 19.00 |
| 12 | −48.5401 | DD[12] | | | | 19.09 |
| 13 (St) | ∞ | 0.8002 | | | | 18.82 |
| *14 | 29.8550 | 2.8306 | 1.67502 | 44.41 | 0.56701 | 20.00 |
| *15 | −62709.0793 | 6.0842 | | | | 20.06 |
| 16 | 38.7249 | 0.8002 | 1.70588 | 37.36 | 0.58258 | 20.69 |
| 17 | 15.5639 | 6.8707 | 1.53037 | 77.05 | 0.53980 | 20.14 |
| 18 | −37.7610 | 0.5879 | | | | 20.12 |
| 19 | 119.3245 | 3.0041 | 1.52606 | 77.63 | 0.53950 | 19.37 |
| 20 | −34.4485 | 0.7996 | 1.80376 | 43.22 | 0.56513 | 19.03 |
| 21 | 31.0527 | 1.2593 | | | | 18.56 |
| *22 | 20.0697 | 5.5134 | 1.49700 | 81.61 | 0.53887 | 19.09 |
| *23 | −25.1595 | DD[23] | | | | 18.90 |
| 24 | 187.7760 | 0.7000 | 1.59349 | 67.00 | 0.53667 | 18.00 |
| 25 | 21.3232 | DD[25] | | | | 17.91 |
| *26 | 935.4608 | 2.4228 | 1.59201 | 67.02 | 0.53589 | 24.82 |
| *27 | −64.8687 | 19.9700 | | | | 25.11 |

TABLE 11
Example 4

| | Wide | Middle | Tele |
|---|---|---|---|
| Zr | 1.0 | 2.0 | 3.8 |
| f | 16.49 | 32.98 | 63.32 |
| FNo. | 2.88 | 2.88 | 2.88 |
| 2ω [°] | 86.4 | 44.8 | 24.0 |
| DD[5] | 0.80 | 13.83 | 29.29 |
| DD[12] | 23.82 | 7.04 | 1.02 |
| DD[23] | 1.50 | 6.28 | 5.64 |
| DD[25] | 8.59 | 11.03 | 19.86 |

TABLE 12
Example 4

| Sn | 6 | 7 | 14 | 15 |
|---|---|---|---|---|
| KA | 1.0000000E+00 | −1.4175455E+00 | 1.0000000E+00 | 1.0000000E+00 |
| A3 | 0.0000000E+00 | 0.0000000E+00 | 0.0000000E+00 | 0.0000000E+00 |
| A4 | −1.0668980E−05 | 7.0683142E−05 | −1.2563718E−05 | 6.1227368E−06 |
| A5 | 3.0458819E−06 | 2.6433424E−05 | −1.4413145E−06 | −1.6759766E−05 |
| A6 | −4.0523068E−07 | −1.0031588E−05 | 9.8958262E−07 | 1.2778779E−05 |
| A7 | 1.5394007E−08 | 2.3714514E−06 | −3.2407644E−07 | −5.2967098E−06 |
| A8 | 1.9384389E−09 | −4.2821940E−07 | 6.0220995E−08 | 1.3115579E−06 |
| A9 | −1.5101804E−10 | 6.5564964E−08 | −5.7813851E−09 | −1.9376126E−07 |
| A10 | −7.4934048E−12 | −8.1210418E−09 | 1.6339296E−10 | 1.5341772E−08 |
| A11 | 1.0810721E−12 | 6.4014058E−10 | 2.4967804E−11 | −3.2975740E−10 |
| A12 | −3.0684961E−14 | −1.3819313E−11 | −8.4214650E−12 | −2.9563177E−11 |
| A13 | 6.8039547E−16 | −2.1517764E−12 | 1.8824940E−12 | −7.3604600E−13 |
| A14 | −1.2216424E−16 | 1.7494929E−13 | −2.2503633E−13 | 4.3871547E−13 |
| A15 | 7.2081419E−18 | −3.3608020E−15 | 1.3091638E−14 | −2.9413435E−14 |
| A16 | −1.2916911E−19 | −3.9785724E−17 | −2.9664356E−16 | 6.4294403E−16 |

| Sn | 22 | 23 | 26 | 27 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −4.8339599E−05 | 3.8816563E−06 | −5.0971395E−06 | 1.2904682E−05 |
| A5 | 1.9324797E−05 | 8.8513382E−06 | −1.8330689E−09 | −1.5447215E−05 |
| A6 | −1.4286037E−05 | −6.2027824E−06 | 2.9293880E−08 | 1.1671028E−05 |
| A7 | 5.5117914E−06 | 1.9541573E−06 | −4.1281986E−10 | −4.9871393E−06 |
| A8 | −1.2083545E−06 | −3.6304811E−07 | −2.0713577E−11 | 1.2129551E−06 |
| A9 | 1.4868704E−07 | 6.5269842E−08 | −1.1633847E−11 | −1.6457324E−07 |
| A10 | −9.7978409E−09 | −1.4788877E−08 | 1.0644898E−12 | 9.9071518E−09 |
| A11 | 7.7384232E−10 | 2.3485277E−09 | −2.1189539E−14 | 2.8474288E−10 |
| A12 | −1.8636402E−10 | −1.1868931E−10 | −2.1510478E−15 | −7.8470686E−11 |
| A13 | 2.7867371E−11 | −2.1284457E−11 | 1.7786971E−16 | 3.1051835E−12 |
| A14 | −2.0016344E−12 | 3.9655996E−12 | −4.1873054E−18 | 1.3389698E−13 |
| A15 | 6.3283257E−14 | −2.5675918E−13 | −5.7898352E−20 | −1.3610321E−14 |
| A16 | −5.2871121E−16 | 6.1650910E−15 | 3.0466898E−21 | 2.9879646E−16 |

### Example 5

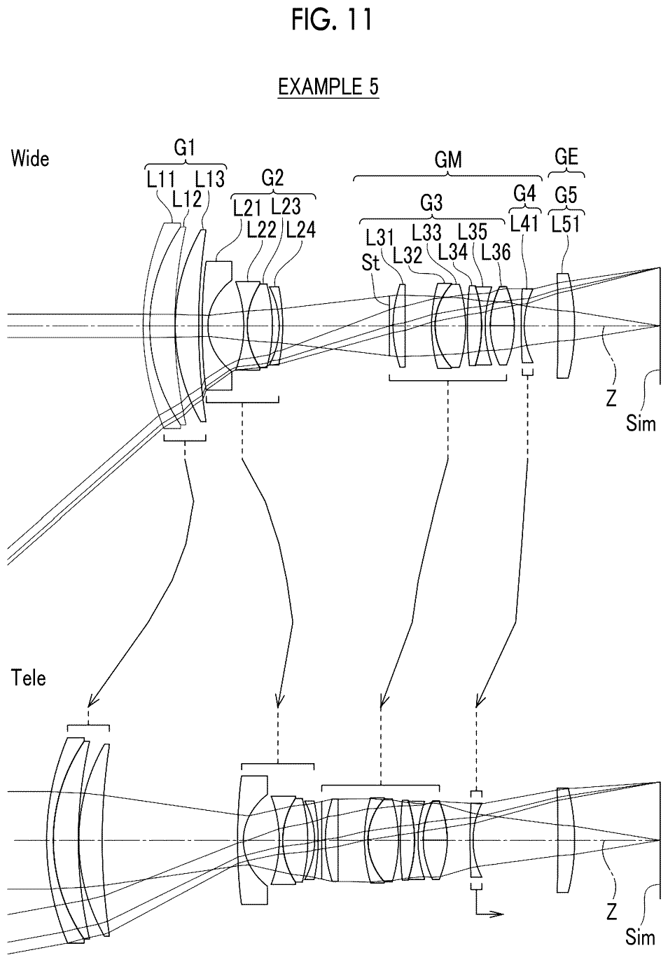

A configuration and a moving path of a variable magnification optical system of Example 5 are illustrated in FIG. 11. The variable magnification optical system of Example 5 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During changing the magnification from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and six lenses including the lenses L31 to L36. The fourth lens group G4 consists of one lens that is the lens L41. The fifth lens group G5 consists of one lens that is the lens L51.

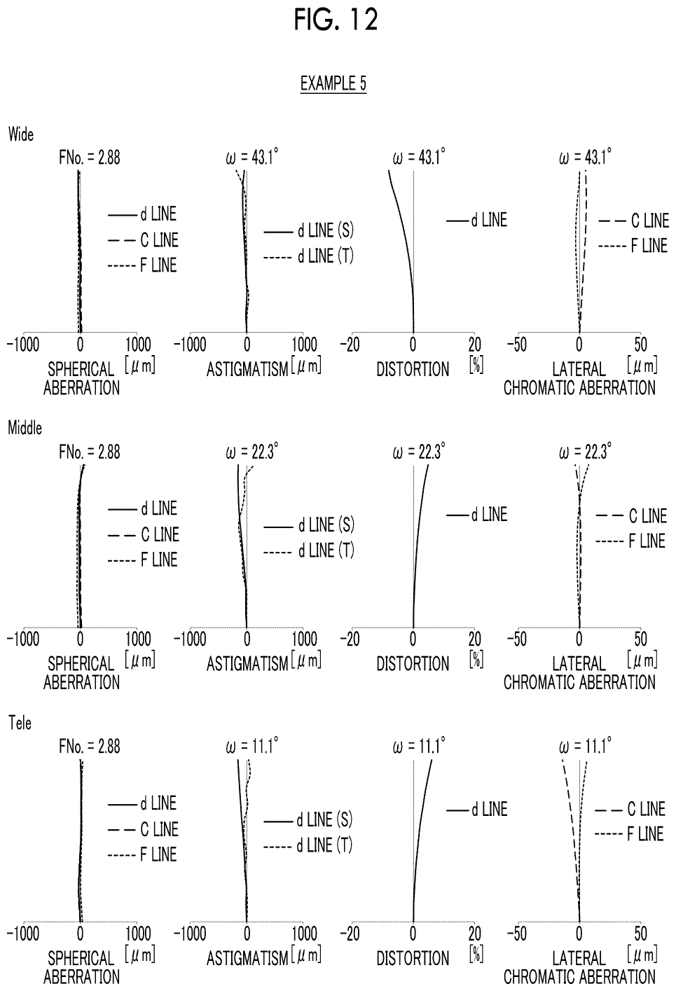

For the variable magnification optical system of Example 5, Table 13 shows basic lens data, Table 14 shows specifications and a variable surface spacing, Table 15 shows aspherical coefficients, and FIG. 12 illustrates each aberration diagram.

TABLE 13
Example 5

| Sn | R | D | Nd | νd | θgF | ED |
|---|---|---|---|---|---|---|
| 1 | 67.9583 | 1.4993 | 1.92286 | 20.88 | 0.63992 | 50.00 |
| 2 | 44.7631 | 5.7115 | 1.59283 | 68.63 | 0.54286 | 48.15 |
| 3 | 114.7013 | 0.1000 | | | | 47.73 |
| 4 | 49.5121 | 5.3348 | 1.82192 | 45.81 | 0.55887 | 46.71 |
| 5 | 164.0298 | DD[5] | | | | 46.01 |
| *6 | 149.9945 | 1.3000 | 1.85135 | 40.10 | 0.56954 | 31.35 |
| *7 | 13.1692 | 8.1784 | | | | 22.34 |
| 8 | −32.2167 | 0.8104 | 1.66035 | 40.80 | 0.57526 | 21.53 |
| 9 | 19.4217 | 5.7060 | 1.92119 | 27.99 | 0.60501 | 20.35 |
| 10 | −40.9542 | 1.5446 | | | | 19.80 |
| 11 | −21.4235 | 0.7993 | 1.72947 | 55.03 | 0.54408 | 19.00 |
| 12 | −50.3215 | DD[12] | | | | 19.08 |
| 13 (St) | ∞ | 0.8008 | | | | 18.85 |
| *14 | 30.3499 | 2.7664 | 1.68690 | 42.79 | 0.57003 | 20.00 |
| *15 | 4715.1210 | 6.0259 | | | | 20.06 |
| 16 | 39.1887 | 0.8003 | 1.68316 | 36.89 | 0.58451 | 20.77 |
| 17 | 15.5885 | 6.9286 | 1.52529 | 77.73 | 0.53945 | 20.25 |
| 18 | −36.9085 | 0.4232 | | | | 20.23 |
| 19 | 100.8918 | 3.2483 | 1.56252 | 72.71 | 0.54203 | 19.47 |
| 20 | −32.5050 | 0.7995 | 1.83037 | 43.23 | 0.56420 | 19.09 |
| 21 | 30.4978 | 1.1615 | | | | 18.56 |
| *22 | 19.9990 | 5.4686 | 1.49700 | 81.61 | 0.53887 | 19.07 |
| *23 | −25.2537 | DD[23] | | | | 18.90 |
| 24 | 173.8168 | 0.7000 | 1.59349 | 67.00 | 0.53667 | 18.00 |
| 25 | 21.1028 | DD[25] | | | | 17.91 |
| *26 | −569.6156 | 3.7823 | 1.59201 | 67.02 | 0.53589 | 24.43 |
| *27 | −56.4019 | 19.5000 | | | | 25.12 |

TABLE 14
Example 5

| | Wide | Middle | Tele |
|---|---|---|---|
| Zr | 1.0 | 2.0 | 4.1 |
| f | 16.49 | 32.98 | 68.27 |
| FNo. | 2.88 | 2.88 | 2.88 |
| 2ω [°] | 86.2 | 44.6 | 22.2 |
| DD[5] | 0.80 | 13.83 | 30.85 |
| DD[12] | 24.19 | 7.32 | 0.82 |
| DD[23] | 1.59 | 6.36 | 5.20 |
| DD[25] | 7.67 | 9.67 | 19.36 |

TABLE 15
Example 5

| Sn | 6 | 7 | 14 | 15 |
|---|---|---|---|---|
| KA | 1.0000000E+00 | −1.4212062E+00 | 1.0000000E+00 | 1.0000000E+00 |
| A3 | 0.0000000E+00 | 0.0000000E+00 | 0.0000000E+00 | 0.0000000E+00 |
| A4 | −1.0705531E−05 | 7.4036378E−05 | −1.6046871E−05 | −2.4785879E−06 |
| A5 | 3.0982093E−06 | 2.3332849E−05 | 4.8576540E−06 | −1.0092066E−06 |
| A6 | −4.3644489E−07 | −7.2125754E−06 | −3.5132131E−06 | 6.0922987E−07 |
| A7 | 2.5831205E−08 | 9.7651971E−07 | 1.3648606E−06 | −1.5358639E−07 |
| A8 | −2.2190856E−10 | −2.9881363E−09 | −2.8230456E−07 | 1.9662769E−08 |
| A9 | 1.3232520E−10 | −1.8307250E−08 | 2.3510095E−08 | −1.7206246E−09 |
| A10 | −2.9742964E−11 | 2.5451424E−09 | 2.0274785E−09 | 6.4889265E−10 |
| A11 | 1.8040936E−12 | −1.6504760E−10 | −5.9483034E−10 | −1.8042214E−10 |
| A12 | 1.0096465E−14 | 8.4092965E−12 | 2.1014923E−11 | 1.7826833E−11 |
| A13 | −5.2638531E−15 | −2.8056278E−13 | 6.6703894E−12 | 4.8881533E−13 |
| A14 | 1.8241756E−16 | −4.6811244E−14 | −9.6291867E−13 | −2.3030730E−13 |
| A15 | −5.4439045E−19 | 6.0759271E−15 | 5.2845919E−14 | 1.6744048E−14 |
| A16 | −4.7680398E−20 | −1.9665684E−16 | −1.0928326E−15 | −4.0707207E−16 |

| Sn | 22 | 23 | 26 | 27 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −4.1235027E−05 | 7.9466450E−06 | −5.3547200E−06 | −1.1522511E−04 |
| A5 | 5.2663416E−06 | −5.9107896E−07 | −5.1162556E−09 | 1.8230526E−04 |
| A6 | −3.3190431E−06 | 2.9996608E−06 | 3.3579961E−08 | −1.1613946E−04 |
| A7 | 9.1004534E−07 | −2.9548620E−06 | −1.1874554E−09 | 4.0590297E−05 |
| A8 | −9.1635288E−08 | 1.2187306E−06 | 1.5444526E−10 | −8.6480508E−06 |
| A9 | −4.1330033E−09 | −2.5001305E−07 | −4.4612236E−11 | 1.1607349E−06 |
| A10 | 2.9717843E−10 | 2.1959615E−08 | 5.8709078E−12 | −9.6498790E−08 |
| A11 | 3.9117488E−10 | 5.9250896E−10 | −6.2196528E−13 | 4.5971257E−09 |
| A12 | −4.9539695E−11 | −2.4231956E−10 | 6.0082154E−14 | −1.1157482E−10 |
| A13 | −4.6326320E−12 | 2.9940028E−12 | −4.6132202E−15 | 3.9399427E−12 |
| A14 | 1.4046148E−12 | 2.4834789E−12 | 2.4189932E−16 | −4.4644105E−13 |
| A15 | −1.0922779E−13 | −2.1984302E−13 | −7.4588022E−18 | 2.3626595E−14 |
| A16 | 2.9623852E−15 | 5.9808769E−15 | 1.0102730E−19 | −4.3029626E−16 |

### Example 6

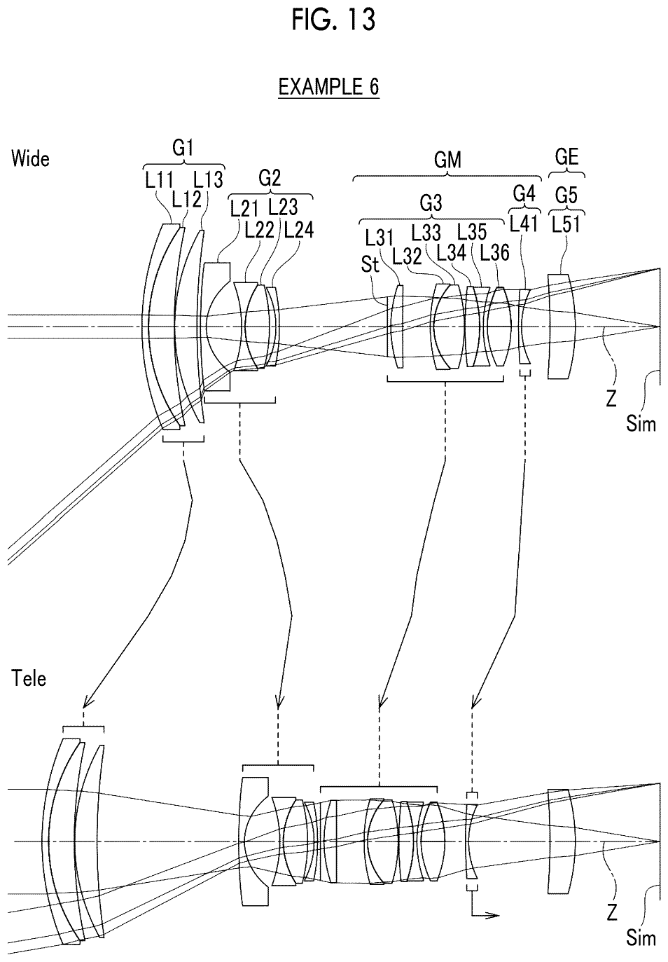

A configuration and a moving path of a variable magnification optical system of Example 6 are illustrated in FIG. 13. The variable magnification optical system of Example 6 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During changing the magnification from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and six lenses including the lenses L31 to L36. The fourth lens group G4 consists of one lens that is the lens L41. The fifth lens group G5 consists of one lens that is the lens L51.

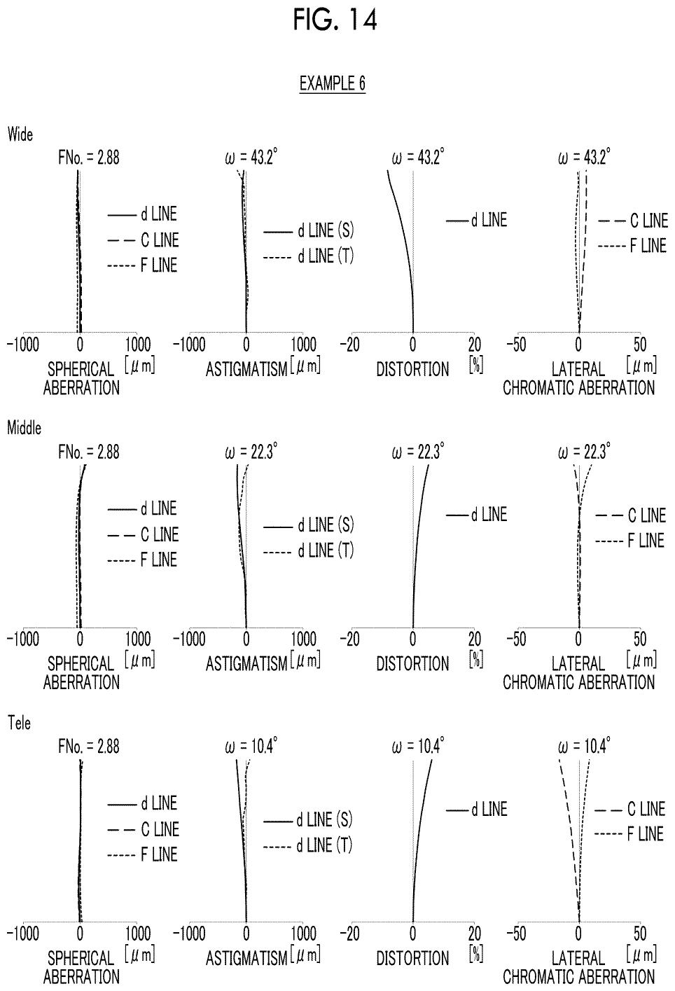

For the variable magnification optical system of Example 6, Table 16 shows basic lens data, Table 17 shows specifications and a variable surface spacing, Table 18 shows aspherical coefficients, and FIG. 14 illustrates each aberration diagram.

TABLE 16
Example 6

| Sn | R | D | Nd | νd | θgF | ED |
|---|---|---|---|---|---|---|
| 1 | 67.5702 | 1.4999 | 1.92286 | 20.88 | 0.63992 | 50.00 |
| 2 | 44.0811 | 5.8577 | 1.59283 | 68.63 | 0.54286 | 48.12 |
| 3 | 119.4873 | 0.1000 | | | | 47.75 |
| 4 | 50.4385 | 5.0988 | 1.83508 | 44.49 | 0.56128 | 46.76 |
| 5 | 168.8211 | DD[5] | | | | 46.18 |
| *6 | 153.2642 | 1.3008 | 1.85135 | 40.10 | 0.56954 | 31.21 |
| *7 | 13.1404 | 8.0528 | | | | 22.22 |
| 8 | −32.6248 | 0.8091 | 1.65063 | 36.63 | 0.58610 | 21.43 |
| 9 | 19.4056 | 5.5324 | 1.92119 | 26.36 | 0.61134 | 20.19 |
| 10 | −42.3436 | 1.4705 | | | | 19.63 |
| 11 | −21.6039 | 0.8000 | 1.74063 | 53.94 | 0.54543 | 19.00 |
| 12 | −50.2245 | DD[12] | | | | 19.08 |
| 13 (St) | ∞ | 0.7992 | | | | 18.88 |
| *14 | 30.5822 | 2.7057 | 1.69471 | 40.30 | 0.57530 | 20.00 |
| *15 | 1357.1009 | 6.2863 | | | | 20.05 |
| 16 | 39.4016 | 0.7997 | 1.68826 | 35.77 | 0.58748 | 20.78 |
| 17 | 15.6188 | 6.9679 | 1.54084 | 75.63 | 0.54053 | 20.26 |
| 18 | −37.5651 | 0.1574 | | | | 20.21 |
| 19 | 91.9991 | 3.3369 | 1.56938 | 71.78 | 0.54251 | 19.49 |
| 20 | −31.5848 | 0.8001 | 1.84242 | 43.39 | 0.56342 | 19.11 |
| 21 | 29.8153 | 0.9374 | | | | 18.58 |
| *22 | 19.9281 | 5.4136 | 1.49700 | 81.61 | 0.53887 | 19.07 |
| *23 | −25.6009 | DD[23] | | | | 18.90 |
| 24 | 136.8929 | 0.7000 | 1.59349 | 67.00 | 0.53667 | 18.00 |
| 25 | 21.0741 | DD[25] | | | | 17.91 |
| *26 | −189.2358 | 5.7849 | 1.59201 | 67.02 | 0.53589 | 23.77 |
| *27 | −49.5684 | 19.3500 | | | | 25.12 |

TABLE 17
Example 6

| | Wide | Middle | Tele |
|---|---|---|---|
| Zr | 1.0 | 2.0 | 4.4 |
| f | 16.49 | 32.99 | 73.22 |
| FNo. | 2.88 | 2.88 | 2.88 |
| 2ω [°] | 86.4 | 44.6 | 20.8 |
| DD[5] | 0.80 | 13.83 | 32.28 |
| DD[12] | 24.45 | 7.64 | 0.64 |
| DD[23] | 1.68 | 6.46 | 4.71 |
| DD[25] | 6.46 | 8.21 | 18.54 |

TABLE 18
Example 6

| Sn | 6 | 7 | 14 | 15 |
|---|---|---|---|---|
| KA | 1.0000000E+00 | −1.4250348E+00 | 1.0000000E+00 | 1.0000000E+00 |
| A3 | 0.0000000E+00 | 0.0000000E+00 | 0.0000000E+00 | 0.0000000E+00 |
| A4 | −1.0614986E−05 | 7.6838448E−05 | −1.4141938E−05 | −5.5457038E−06 |
| A5 | 3.1111689E−06 | 2.0965603E−05 | 2.3591897E−06 | 4.4500271E−06 |
| A6 | −4.5393248E−07 | −5.5917089E−06 | −1.7919851E−06 | −3.4122768E−06 |
| A7 | 2.9488454E−08 | 4.2441114E−07 | 7.6273310E−07 | 1.4156962E−06 |
| A8 | −1.4332411E−10 | 8.8712532E−08 | −1.8037605E−07 | −3.1983131E−07 |
| A9 | −1.1308931E−11 | −2.0878042E−08 | 2.1381625E−08 | 3.3170018E−08 |
| A10 | −5.7572241E−12 | 7.8511664E−10 | −1.5245011E−10 | 1.1340811E−09 |
| A11 | 1.2169273E−13 | 1.5034217E−10 | −2.8283141E−10 | −6.7945729E−10 |
| A12 | 2.4768484E−14 | −1.0919625E−11 | 2.5987914E−11 | 5.1228578E−11 |
| A13 | 8.4551733E−16 | −7.1909342E−13 | 1.1556578E−12 | 3.4439246E−12 |
| A14 | −2.6887933E−16 | 8.1831795E−14 | −3.4321604E−13 | −7.9942032E−13 |
| A15 | 1.3304904E−17 | −7.2281215E−16 | 2.2156759E−14 | 4.9416369E−14 |
| A16 | −2.1275835E−19 | −7.3250770E−17 | −4.9651245E−16 | −1.0860675E−15 |
| Sn | 22 | 23 | 26 | 27 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −3.5623907E−05 | 5.3062059E−06 | −5.9673437E−06 | 9.5349083E−06 |
| A5 | −5.4503336E−06 | 4.4818403E−06 | 1.2858492E−09 | −1.4136716E−05 |
| A6 | 5.6361169E−06 | −1.0682873E−06 | 3.4739614E−08 | 1.3792320E−05 |
| A7 | −3.1943066E−06 | −1.2383490E−06 | 3.0258247E−10 | −7.0374555E−06 |
| A8 | 1.0305851E−06 | 8.2493438E−07 | −2.0551283E−10 | 2.0312029E−06 |
| A9 | −1.8534902E−07 | −2.1098371E−07 | 3.9542375E−12 | −3.5249931E−07 |
| A10 | 1.4441986E−08 | 2.4425113E−08 | 7.6257800E−13 | 3.7245833E−08 |
| A11 | 7.5412253E−10 | −4.6841379E−10 | −1.3358559E−13 | −2.3265599E−09 |
| A12 | −2.4628433E−10 | −1.5830362E−10 | 1.2269169E−14 | 8.7307583E−11 |
| A13 | 1.4469956E−11 | 7.0425327E−12 | −4.8323207E−16 | −3.9764067E−12 |
| A14 | 5.6467551E−13 | 1.3563139E−12 | −4.7468202E−18 | 3.4696508E−13 |
| A15 | −9.5775064E−14 | −1.4662101E−13 | 9.9684257E−19 | −1.8396450E−14 |
| A16 | 3.0239585E−15 | 4.3009140E−15 | −2.3247389E−20 | 3.6341064E−16 |

### Example 7

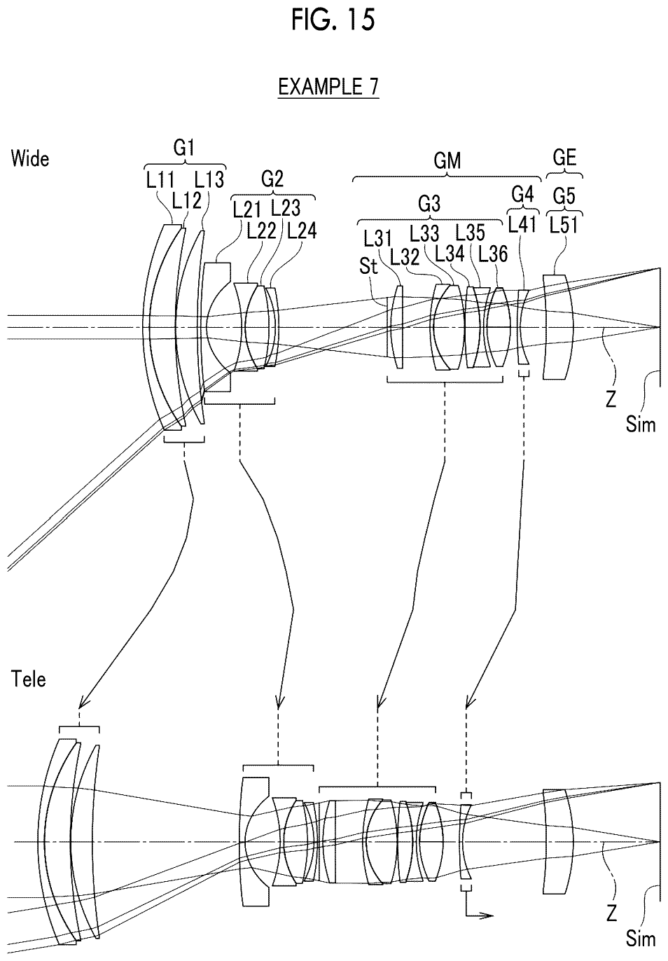

A configuration and a moving path of a variable magnification optical system of Example 7 are illustrated in FIG. 15. The variable magnification optical system of Example 7 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During changing the magnification from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and six lenses including the lenses L31 to L36. The fourth lens group G4 consists of one lens that is the lens L41. The fifth lens group G5 consists of one lens that is the lens L51.

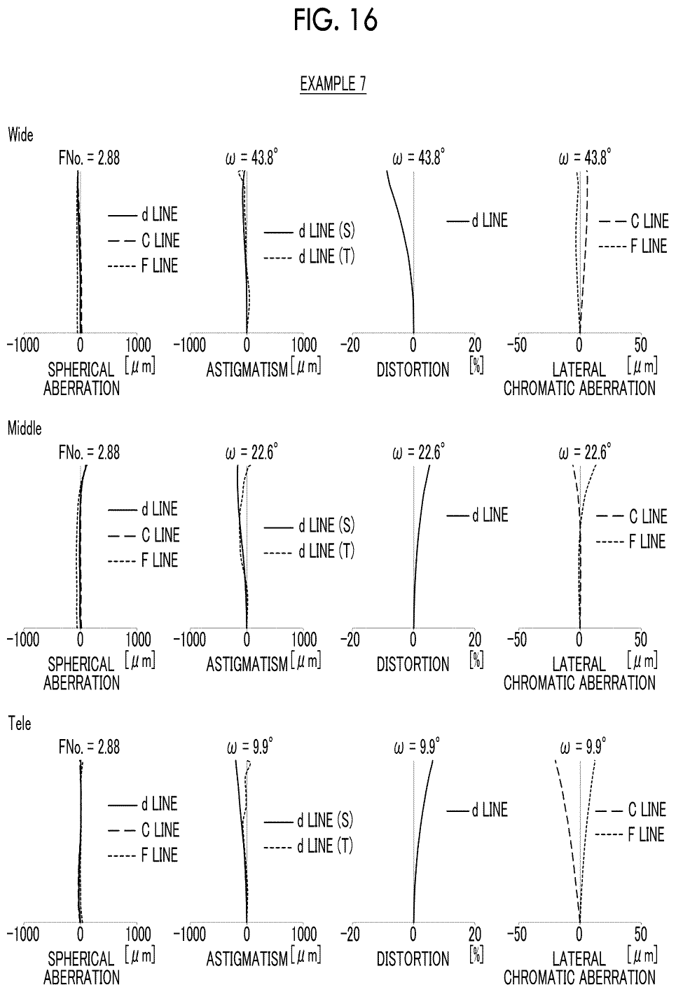

For the variable magnification optical system of Example 7, Table 19 shows basic lens data, Table 20 shows specifications and a variable surface spacing, Table 21 shows aspherical coefficients, and FIG. 16 illustrates each aberration diagram.

TABLE 19
Example 7

| Sn | R | D | Nd | νd | θgF | ED |
|---|---|---|---|---|---|---|
| 1 | 66.4029 | 1.4999 | 1.92286 | 20.88 | 0.63992 | 50.00 |
| 2 | 43.4926 | 5.9054 | 1.59283 | 68.63 | 0.54286 | 48.15 |
| 3 | 120.9729 | 0.1000 | | | | 47.83 |
| 4 | 50.9564 | 4.9130 | 1.84199 | 43.80 | 0.56255 | 46.94 |
| 5 | 169.5880 | DD[5] | | | | 46.46 |
| *6 | 156.5100 | 1.3001 | 1.85135 | 40.10 | 0.56954 | 31.32 |
| *7 | 13.1460 | 8.0109 | | | | 22.20 |
| 8 | −32.9440 | 0.8095 | 1.64267 | 34.09 | 0.59372 | 21.42 |
| 9 | 19.4528 | 5.4081 | 1.92119 | 25.29 | 0.61640 | 20.13 |
| 10 | −43.5381 | 1.4558 | | | | 19.57 |
| 11 | −21.7109 | 0.8002 | 1.75047 | 52.95 | 0.54685 | 19.00 |
| 12 | −49.8579 | DD[12] | | | | 19.08 |
| 13 (St) | ∞ | 0.8001 | | | | 18.91 |
| *14 | 31.0149 | 2.6793 | 1.69223 | 39.61 | 0.57695 | 20.00 |
| *15 | 1880.6629 | 6.2587 | | | | 20.03 |
| 16 | 39.7491 | 0.8055 | 1.67065 | 35.70 | 0.58813 | 20.80 |
| 17 | 15.7227 | 7.0395 | 1.53379 | 76.58 | 0.54004 | 20.34 |
| 18 | −37.5240 | 0.1191 | | | | 20.32 |
| 19 | 87.1020 | 3.4333 | 1.58140 | 70.16 | 0.54334 | 19.64 |
| 20 | −30.8275 | 0.7994 | 1.83963 | 43.30 | 0.56372 | 19.25 |
| 21 | 29.2392 | 0.7600 | | | | 18.67 |
| *22 | 19.9178 | 5.3578 | 1.49700 | 81.61 | 0.53887 | 19.07 |
| *23 | −25.6690 | DD[23] | | | | 18.90 |
| 24 | 121.7636 | 0.7000 | 1.59349 | 67.00 | 0.53667 | 18.00 |
| 25 | 21.1918 | DD[25] | | | | 17.94 |
| *26 | −111.0063 | 6.1492 | 1.59201 | 67.02 | 0.53589 | 23.77 |
| *27 | −43.7233 | 19.8200 | | | | 25.40 |

TABLE 20
Example 7

| | Wide | Middle | Tele |
|---|---|---|---|
| Zr | 1.0 | 2.0 | 4.7 |
| f | 16.49 | 32.99 | 78.18 |
| FNo. | 2.88 | 2.88 | 2.88 |
| 2ω [°] | 87.6 | 45.2 | 19.8 |
| DD[5] | 0.80 | 13.83 | 33.48 |
| DD[12] | 24.54 | 7.72 | 0.42 |
| DD[23] | 1.56 | 6.33 | 3.73 |
| DD[25] | 5.91 | 7.40 | 19.09 |

TABLE 21
Example 7

| Sn | 6 | 7 | 14 | 15 |
|---|---|---|---|---|
| KA | 1.0000000E+00 | −1.4214304E+00 | 1.0000000E+00 | 1.0000000E+00 |
| A3 | 0.0000000E+00 | 0.0000000E+00 | 0.0000000E+00 | 0.0000000E+00 |
| A4 | −1.0430565E−05 | 7.5470344E−05 | −1.2528238E−05 | −2.9293507E−06 |
| A5 | 2.9702524E−06 | 2.3231834E−05 | −5.3762493E−07 | −2.5093842E−07 |
| A6 | −3.9653880E−07 | −7.0300521E−06 | 3.4525671E−07 | −4.7820474E−08 |
| A7 | 1.5664628E−08 | 8.9032223E−07 | −8.2294072E−08 | 1.6622965E−07 |
| A8 | 1.8868976E−09 | 1.4375535E−08 | 9.4518246E−09 | −7.5263602E−08 |
| A9 | −1.8651200E−10 | −1.9132476E−08 | −6.0700824E−10 | 1.5643950E−08 |
| A10 | 1.5246932E−12 | 2.2457261E−09 | 2.2103179E−10 | −1.1141464E−09 |
| A11 | 8.9538913E−14 | −1.0711320E−10 | −5.8126179E−11 | −1.4061538E−10 |
| A12 | 3.1831088E−14 | 5.3207664E−12 | 2.1856697E−12 | 3.0949885E−11 |
| A13 | −1.7472706E−15 | −4.6212077E−13 | 1.1472346E−12 | −1.2263996E−12 |
| A14 | −6.2550825E−17 | −1.6357310E−14 | −1.8841848E−13 | −1.3974346E−13 |
| A15 | 6.2661361E−18 | 4.7172913E−15 | 1.1627303E−14 | 1.4871593E−14 |
| A16 | −1.2072799E−19 | −1.7692172E−16 | −2.6419571E−16 | −4.0599708E−16 |

| Sn | 22 | 23 | 26 | 27 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.7768270E−05 | −1.4821503E−05 | −6.4554647E−06 | −2.0403359E−05 |
| A5 | −1.8522655E−05 | 4.6973110E−05 | 1.3047892E−07 | 2.8678949E−05 |
| A6 | 1.4259154E−05 | −3.9222760E−05 | −4.0231959E−08 | −1.1729709E−05 |
| A7 | −5.8231133E−06 | 1.7931777E−05 | 2.5096041E−08 | 1.3011798E−06 |
| A8 | 1.2483455E−06 | −5.1018225E−06 | −4.3245395E−09 | 3.8510715E−07 |
| A9 | −8.7510287E−08 | 9.3949934E−07 | 2.4359627E−10 | −1.4684561E−07 |
| A10 | −1.9937877E−08 | −1.0687881E−07 | 3.0614150E−11 | 1.9663456E−08 |
| A11 | 5.3022046E−09 | 5.1724679E−09 | −5.9771061E−12 | −9.4990388E−10 |
| A12 | −4.1137894E−10 | 4.9042781E−10 | 1.9998914E−13 | −5.0764230E−11 |
| A13 | −1.3990468E−11 | −1.1620101E−10 | 3.5695653E−14 | 9.0210958E−12 |
| A14 | 4.7064200E−12 | 1.0251383E−11 | −4.3755883E−15 | −4.4897642E−13 |
| A15 | −3.1644972E−13 | −4.6551510E−13 | 1.9660344E−16 | 8.3078054E−15 |
| A16 | 7.4708529E−15 | 8.9647813E−15 | −3.3158481E−18 | −1.1169451E−17 |

### Example 8

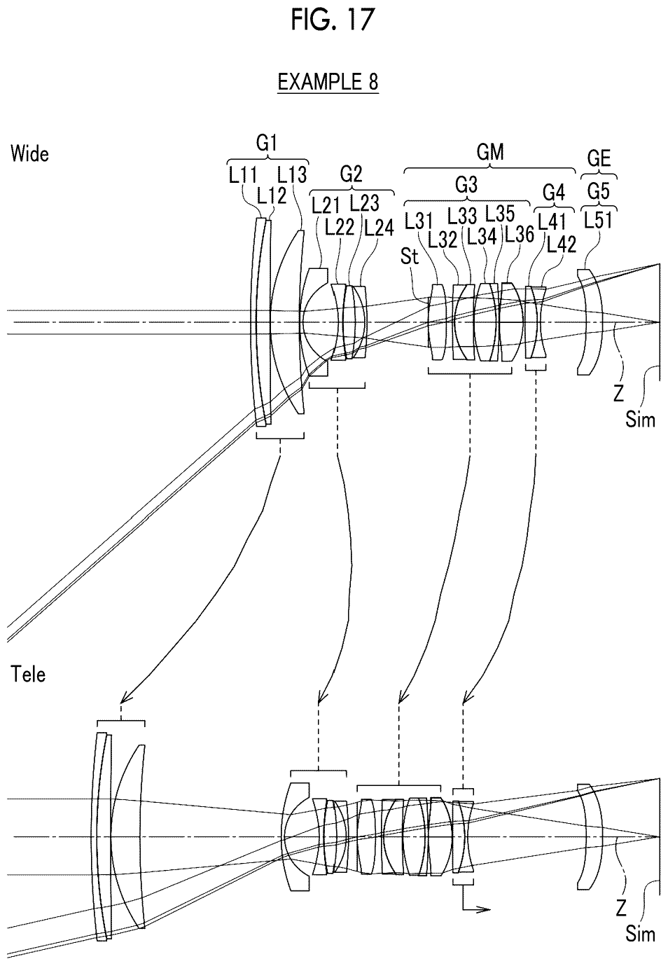

A configuration and a moving path of a variable magnification optical system of Example 8 are illustrated in FIG. 17. The variable magnification optical system of Example 8 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During changing the magnification from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and six lenses including the lenses L31 to L36. The fourth lens group G4 consists of, in order from the object side to the image side, two lenses including the lenses L41 and L42. The fifth lens group G5 consists of one lens that is the lens L51.

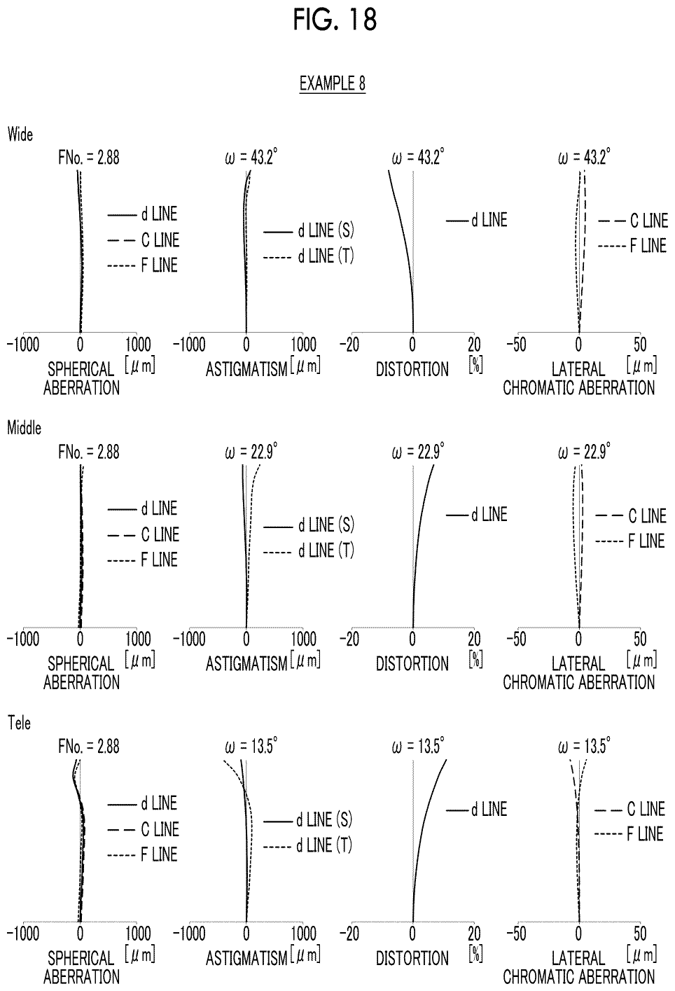

For the variable magnification optical system of Example 8, Table 22 shows basic lens data, Table 23 shows specifications and a variable surface spacing, Table 24 shows aspherical coefficients, and FIG. 18 illustrates each aberration diagram.

TABLE 22
Example 8

| Sn | R | D | Nd | νd | θgF | ED |
|---|---|---|---|---|---|---|
| 1 | 234.5288 | 1.2680 | 1.91711 | 19.14 | 0.64785 | 50.60 |
| 2 | 137.2985 | 0.0200 | | | | 49.60 |
| 3 | 137.2985 | 3.1564 | 1.48749 | 70.44 | 0.53062 | 49.59 |
| 4 | 1612.5329 | 0.0488 | | | | 49.05 |
| 5 | 41.8647 | 6.6116 | 1.50343 | 80.63 | 0.53790 | 44.60 |
| 6 | 220.6656 | DD[6] | | | | 43.81 |
| *7 | 43.0824 | 0.7498 | 1.65839 | 59.76 | 0.54301 | 26.20 |
| *8 | 11.0391 | 7.9350 | | | | 19.13 |
| *9 | −21.6292 | 0.9998 | 1.58543 | 40.05 | 0.57909 | 18.47 |
| *10 | 71.9763 | 0.0483 | | | | 17.85 |
| 11 | 47.0396 | 2.7825 | 2.00001 | 23.37 | 0.62704 | 17.80 |
| 12 | −52.0595 | 2.1664 | | | | 17.55 |
| 13 | −15.5292 | 0.4998 | 1.44404 | 89.67 | 0.53215 | 17.33 |
| 14 | −86.0005 | DD[14] | | | | 17.34 |
| 15 (St) | ∞ | 0.0000 | | | | 16.80 |
| *16 | 27.3070 | 4.1732 | 1.76736 | 35.01 | 0.58757 | 17.48 |
| *17 | −82.2728 | 1.3438 | | | | 18.21 |
| 18 | 175.8865 | 0.5015 | 1.78572 | 26.58 | 0.61294 | 18.14 |
| 19 | 15.8583 | 4.2678 | 1.51286 | 79.19 | 0.53843 | 17.95 |
| 20 | 136.1151 | 0.1546 | | | | 18.28 |
| 21 | 29.8794 | 5.0326 | 1.51286 | 79.19 | 0.53843 | 18.75 |
| 22 | −31.1720 | 0.6998 | 1.71445 | 29.28 | 0.60568 | 18.75 |
| 23 | −119.3914 | 0.0484 | | | | 18.88 |
| *24 | 35.9267 | 5.4177 | 1.51286 | 79.19 | 0.53843 | 18.89 |
| *25 | −19.1045 | DD[25] | | | | 19.00 |
| 26 | 430.9087 | 2.7498 | 1.93641 | 25.98 | 0.61300 | 17.45 |
| 27 | −26.4342 | 0.7098 | 1.86178 | 40.37 | 0.57012 | 17.10 |
| 28 | 25.6887 | DD[28] | | | | 16.00 |
| *29 | −84.8758 | 3.7502 | 1.59023 | 67.37 | 0.54252 | 22.52 |
| *30 | −48.0395 | 13.0100 | | | | 24.39 |

TABLE 23
Example 8

| | Wide | Middle | Tele |
|---|---|---|---|
| Zr | 1.0 | 1.9 | 3.2 |
| f | 16.44 | 31.58 | 53.22 |
| FNo. | 2.88 | 2.88 | 2.88 |
| 2ω [°] | 86.4 | 45.8 | 27.0 |
| DD[6] | 0.10 | 17.45 | 32.19 |
| DD[14] | 13.95 | 4.59 | 2.00 |
| DD[25] | 0.47 | 2.19 | 0.10 |
| DD[28] | 10.43 | 15.35 | 26.98 |

TABLE 24
Example 8

| Sn | 7 | 8 | 9 | 10 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 2.5130920E−05 | 1.5129353E−05 | 2.2545897E−04 | 1.7189547E−04 |
| A5 | −1.6515000E−06 | −5.0312137E−07 | −2.2479312E−05 | −1.7521571E−05 |
| A6 | −5.1931223E−08 | −6.6832273E−08 | −6.2550784E−07 | −1.4261855E−06 |
| A7 | 1.2001839E−09 | −2.0556139E−10 | 2.8770384E−07 | 3.8818755E−07 |
| A8 | 7.2306143E−10 | 1.4054293E−09 | −1.9829868E−08 | −5.4675784E−08 |
| A9 | −5.6895953E−11 | −2.1558650E−10 | 6.3917170E−10 | 6.1807658E−09 |
| A10 | −6.5206739E−15 | 2.0797885E−11 | −1.2450335E−10 | −4.1251588E−10 |
| A11 | 4.9531171E−13 | −8.4128701E−13 | −6.4925397E−12 | 7.4808753E−13 |
| A12 | −5.0518143E−14 | −3.8601269E−14 | 7.1919440E−12 | −1.5566399E−12 |
| A13 | 2.0365439E−15 | 4.8349917E−15 | −1.2106289E−12 | 9.4714420E−13 |
| A14 | −3.6909317E−18 | −7.4384545E−18 | 1.0283986E−13 | −1.2636662E−13 |
| A15 | −2.2638607E−18 | −1.4942823E−17 | −4.5872320E−15 | 7.2851756E−15 |
| A16 | 5.1907463E−20 | 4.9503543E−19 | 8.5616741E−17 | −1.6160649E−16 |

| Sn | 16 | 17 | 24 | 25 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −4.6837030E−05 | −4.0137695E−05 | −7.5915777E−05 | 1.3490311E−05 |
| A5 | 7.2484962E−07 | −2.6818795E−07 | −5.7509658E−07 | −2.1196622E−06 |
| A6 | 3.2535866E−07 | 2.6006884E−08 | 3.8461057E−07 | 4.6567421E−07 |
| A7 | −2.7125304E−07 | −1.3623176E−08 | −6.4284753E−08 | −6.2557907E−08 |
| A8 | 7.1860017E−08 | −8.3224165E−10 | 2.1073297E−09 | −4.0368245E−09 |
| A9 | −1.3600996E−08 | −2.0232119E−10 | −5.8587816E−10 | 1.4949349E−09 |
| A10 | 1.7714499E−09 | 4.2018079E−11 | 1.6859068E−10 | −1.6465860E−10 |
| A11 | −1.6569407E−10 | −9.9218612E−12 | −1.5156850E−11 | 7.5768817E−12 |
| A12 | 1.1941529E−11 | 7.5424713E−13 | −9.4316740E−13 | 7.2236747E−13 |
| A13 | −9.4573713E−13 | 1.7424319E−14 | 3.4617797E−13 | −1.8079079E−13 |
| A14 | 7.7317031E−14 | −7.2597947E−15 | −3.4600406E−14 | 1.5821228E−14 |
| A15 | −4.1197133E−15 | 4.9019336E−16 | 1.6384530E−15 | −6.8621348E−16 |
| A16 | 9.3532901E−17 | −1.1439029E−17 | −3.1271040E−17 | 1.2267012E−17 |

| Sn | 29 | 30 |
|---|---|---|
| KA | 1.0000000E+00 | 1.0000000E+00 |
| A3 | 0.0000000E+00 | 0.0000000E+00 |
| A4 | −8.4936770E−05 | −4.4548224E−05 |
| A5 | 4.6925959E−06 | −2.1319774E−06 |
| A6 | −3.5227834E−07 | 6.8611752E−07 |
| A7 | 7.2106884E−09 | −6.8864664E−08 |
| A8 | −4.7509623E−09 | 4.7369652E−10 |
| A9 | 4.6966787E−10 | 1.6996782E−10 |
| A10 | 5.5045653E−11 | 4.1150769E−12 |
| A11 | −1.2998489E−11 | −1.2247484E−12 |
| A12 | 6.4181805E−13 | 1.0306025E−13 |
| A13 | 5.3417640E−14 | −8.5481589E−15 |
| A14 | −8.4288933E−15 | 5.2376484E−16 |
| A15 | 4.1491434E−16 | −1.8634745E−17 |
| A16 | −7.4723069E−18 | 2.8284963E−19 |

### Example 9

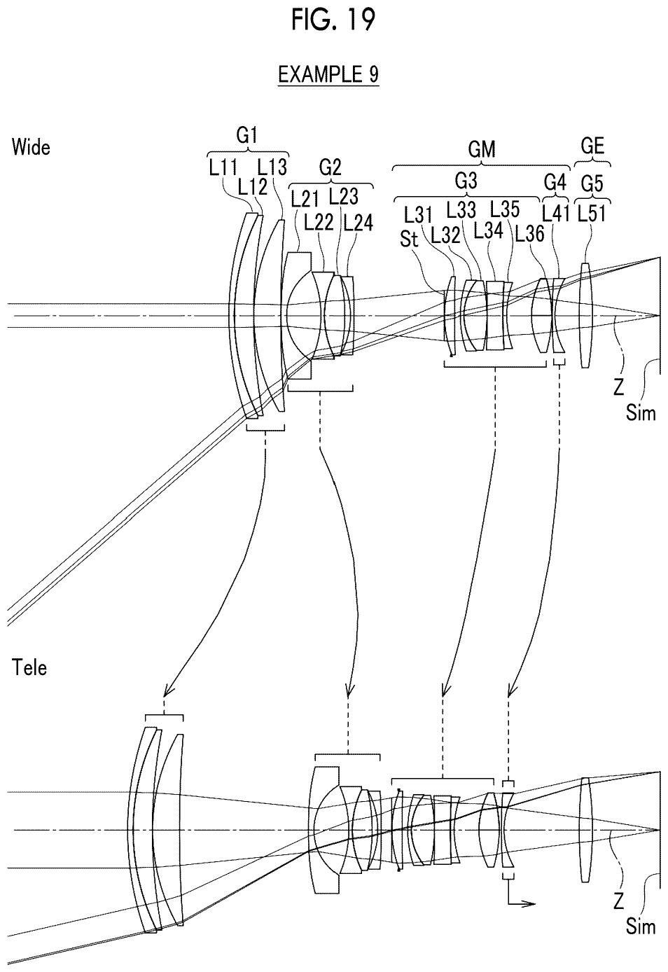

A configuration and a moving path of a variable magnification optical system of Example 9 are illustrated in FIG. 19. The variable magnification optical system of Example 9 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During changing the magnification from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and six lenses including the lenses L31 to L36. The fourth lens group G4 consists of one lens that is the lens L41. The fifth lens group G5 consists of one lens that is the lens L51.

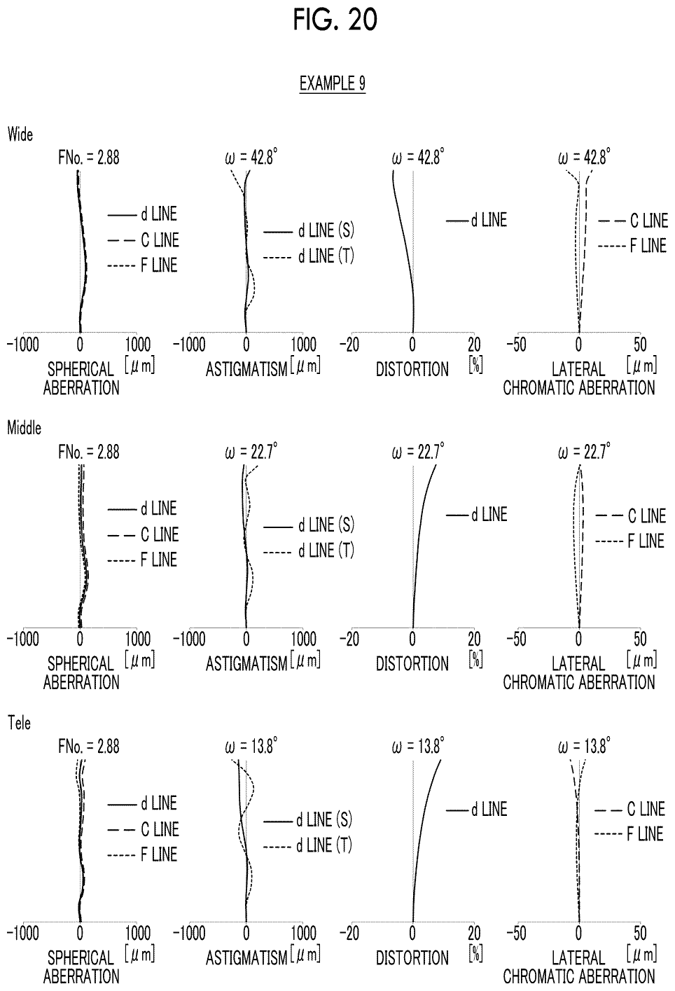

For the variable magnification optical system of Example 9, Table 25 shows basic lens data, Table 26 shows specifications and a variable surface spacing, Table 27 shows aspherical coefficients, and FIG. 20 illustrates each aberration diagram.

TABLE 25
Example 9

| Sn | R | D | Nd | νd | θgF | ED |
|---|---|---|---|---|---|---|
| 1 | 79.5371 | 1.2500 | 1.92286 | 20.88 | 0.63992 | 50.00 |
| 2 | 58.0068 | 4.3887 | 1.59283 | 68.63 | 0.54286 | 48.71 |
| 3 | 137.9001 | 0.0489 | | | | 48.22 |
| 4 | 50.3129 | 6.1194 | 1.59888 | 65.99 | 0.54299 | 46.57 |
| 5 | 317.1182 | DD[5] | | | | 45.74 |
| *6 | 185.1125 | 1.2500 | 1.78860 | 50.20 | 0.55039 | 30.82 |
| *7 | 14.5610 | 7.8093 | | | | 21.72 |
| 8 | −28.5317 | 0.8102 | 1.61201 | 36.80 | 0.58670 | 21.19 |
| 9 | 23.7196 | 4.5111 | 1.99391 | 28.89 | 0.60046 | 19.57 |
| 10 | −44.9709 | 1.2734 | | | | 19.08 |
| *11 | −20.9882 | 0.8000 | 1.50696 | 72.83 | 0.53394 | 19.00 |
| *12 | −170.6727 | DD[12] | | | | 18.60 |
| 13 (St) | ∞ | 0.0300 | | | | 15.67 |
| *14 | 27.3824 | 2.3474 | 1.72729 | 56.33 | 0.54273 | 16.56 |
| *15 | −5171.6327 | 1.2575 | | | | 16.68 |
| 16 | 28.3016 | 0.8250 | 1.77225 | 43.20 | 0.56625 | 17.26 |
| 17 | 14.0442 | 5.2317 | 1.59345 | 66.86 | 0.54270 | 16.91 |
| 18 | −41.0601 | 0.0502 | | | | 16.90 |
| 19 | −243.9579 | 3.5917 | 1.50000 | 55.14 | 0.55220 | 16.69 |
| 20 | 136.2119 | 0.8750 | 1.83010 | 23.94 | 0.61987 | 16.08 |
| 21 | 25.0442 | 5.6379 | | | | 15.80 |
| *22 | 18.8588 | 4.6162 | 1.50000 | 81.15 | 0.53770 | 18.00 |
| *23 | −30.0486 | DD[23] | | | | 18.00 |
| *24 | 121.2733 | 0.6251 | 1.59201 | 67.02 | 0.53589 | 18.00 |
| *25 | 18.8109 | DD[25] | | | | 17.99 |
| 26 | 133.6076 | 3.0000 | 1.59201 | 67.02 | 0.53589 | 25.03 |
| 27 | −90.1338 | 15.4300 | | | | 25.37 |

TABLE 26
Example 9

| | Wide | Middle | Tele |
|---|---|---|---|
| Zr | 1.0 | 1.9 | 3.2 |
| f | 16.42 | 31.54 | 53.16 |
| FNo. | 2.88 | 2.88 | 2.88 |
| 2ω [°] | 85.6 | 45.4 | 27.6 |
| DD[5] | 0.10 | 15.89 | 29.38 |
| DD[12] | 20.59 | 7.06 | 2.40 |
| DD[23] | 0.11 | 2.20 | 0.48 |
| DD[25] | 5.53 | 8.98 | 17.13 |

TABLE 27
Example 9

| Sn | 6 | 7 | 11 | 12 |
|---|---|---|---|---|
| KA | 1.0000000E+00 | −1.4801192E+00 | 1.0000000E+00 | 1.0000000E+00 |
| A3 | 0.0000000E+00 | 0.0000000E+00 | 0.0000000E+00 | 0.0000000E+00 |
| A4 | 3.5370395E−05 | 3.9122455E−05 | 3.5540097E−05 | 1.8959567E−05 |
| A5 | 5.6633348E−06 | 5.5649858E−05 | −7.7846472E−06 | −6.3321294E−07 |
| A6 | −3.9644239E−07 | −1.1225163E−05 | 4.0908943E−06 | −2.9821514E−07 |
| A7 | −2.1917192E−07 | 8.5582837E−07 | −1.9770773E−06 | 3.3819145E−09 |
| A8 | 2.6180161E−08 | 1.0567208E−08 | 5.1010073E−07 | 4.1806134E−10 |
| A9 | 4.4505221E−10 | 7.6311979E−10 | −6.4965442E−08 | 9.9153649E−12 |
| A10 | −2.1530966E−10 | −2.3560977E−09 | 1.8024267E−09 | 2.5971491E−11 |
| A11 | 1.8783735E−11 | 3.2166393E−10 | 4.6984726E−10 | −4.7036469E−12 |
| A12 | −1.8318182E−12 | 5.4885832E−12 | −2.5788277E−11 | 1.3014814E−13 |
| A13 | 1.4380241E−13 | −3.8416465E−12 | −6.8769309E−12 | 5.0026407E−14 |
| A14 | −5.1122959E−15 | 2.1755370E−13 | 1.0878463E−12 | −6.9854365E−15 |
| A15 | 2.2899701E−17 | 2.1923717E−15 | −6.2539109E−14 | 3.8434780E−16 |
| A16 | 1.7065491E−18 | −3.3516949E−16 | 1.3383593E−15 | 8.0799609E−18 |
| Sn | 14 | 15 | 22 | 23 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.4270607E−05 | −4.4883528E−05 | −1.0871183E−04 | 1.8539135E−05 |
| A5 | 7.6403403E−06 | 6.7234011E−05 | −1.0070943E−04 | −1.1137453E−05 |
| A6 | −2.7174810E−06 | −3.3935765E−05 | 1.0935850E−04 | 4.8109862E−06 |
| A7 | 2.2523861E−07 | 7.7329759E−06 | −4.2247494E−05 | −1.8172932E−07 |
| A8 | 7.4287032E−08 | −3.3519900E−07 | 8.2892834E−06 | −1.5725302E−07 |
| A9 | −1.7490325E−08 | −1.8946603E−07 | −8.1730864E−07 | 1.1491241E−08 |
| A10 | 9.5729626E−10 | 2.8229847E−08 | 2.3267916E−08 | 4.3299735E−09 |
| A11 | 2.2554702E−11 | 2.5730076E−09 | 2.3822189E−09 | −6.6565062E−10 |
| A12 | 9.4126694E−12 | −1.0784982E−09 | −2.1479378E−10 | −3.2048831E−11 |
| A13 | −3.0369077E−12 | 1.1781910E−10 | 1.9012007E−11 | 1.7571610E−11 |
| A14 | 3.1594177E−13 | −5.4132917E−12 | −3.1185971E−12 | −2.0634730E−12 |
| A15 | −1.5987537E−14 | 5.1711704E−14 | 2.4245084E−13 | 1.1251793E−13 |
| A16 | 3.3470863E−16 | 2.3805715E−15 | −6.4540766E−15 | −2.4180944E−15 |

| Sn | 24 | 25 |
|---|---|---|
| KA | 1.0000000E+00 | 1.0000000E+00 |
| A3 | 0.0000000E+00 | 0.0000000E+00 |
| A4 | 2.4623049E−05 | −7.8349859E−06 |
| A5 | −9.9342116E−06 | 3.3023100E−08 |
| A6 | 3.0002297E−07 | 2.4091083E−08 |
| A7 | 3.3951399E−07 | 8.7164712E−09 |
| A8 | −7.3059931E−08 | −1.9519769E−09 |
| A9 | 9.2586217E−09 | 1.5854608E−10 |
| A10 | −9.1600559E−10 | 8.8062236E−12 |
| A11 | 2.5412979E−11 | −1.5800650E−12 |
| A12 | 9.8161345E−12 | −4.8810583E−13 |
| A13 | −1.5961339E−12 | 1.4009298E−13 |
| A14 | 1.1344624E−13 | −1.4919369E−14 |
| A15 | −4.1321897E−15 | 7.6441344E−16 |
| A16 | 6.2178671E−17 | −1.5736251E−17 |

### Example 10

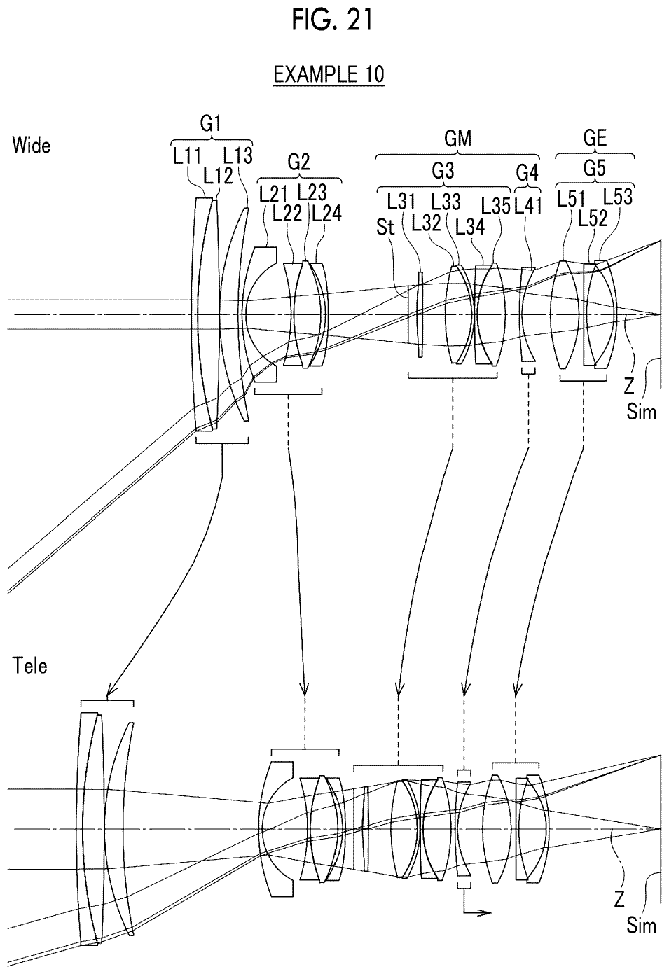

A configuration and a moving path of a variable magnification optical system of Example 10 are illustrated in FIG. 21. The variable magnification optical system of Example 10 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During changing the magnification from the wide angle end to the telephoto end, all lens groups move along the optical axis Z by changing spacings with respect to adjacent lens groups. The focus group consists of the fourth lens group G4. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and five lenses including the lenses L31 to L35. The fourth lens group G4 consists of one lens that is the lens L41. The fifth lens group G5 consists of, in order from the object side to the image side, three lenses including lenses L51 to L53.

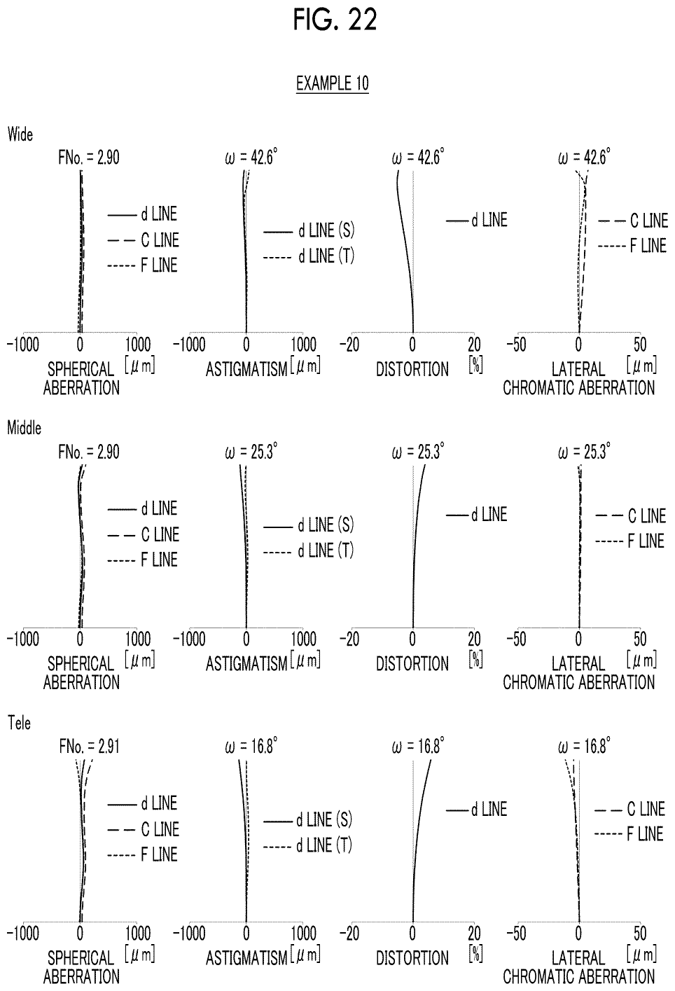

For the variable magnification optical system of Example 10, Table 28 shows basic lens data, Table 29 shows specifications and a variable surface spacing, Table 30 shows aspherical coefficients, and FIG. 22 illustrates each aberration diagram.

TABLE 28
Example 10

| Sn | R | D | Nd | νd | θgF | ED |
|---|---|---|---|---|---|---|
| 1 | 448.8748 | 1.6997 | 1.90001 | 20.00 | 0.64194 | 68.00 |
| 2 | 138.6900 | 5.9441 | 1.73922 | 55.28 | 0.54344 | 66.67 |
| 3 | −775.1112 | 0.0488 | | | | 66.35 |
| 4 | 74.8502 | 5.0563 | 1.81624 | 47.40 | 0.55551 | 62.10 |
| 5 | 166.7438 | DD[5] | | | | 61.27 |
| *6 | 56.5728 | 1.0101 | 1.90001 | 38.83 | 0.57319 | 39.37 |
| *7 | 18.5054 | 12.3426 | | | | 30.00 |
| 8 | −54.2647 | 0.7804 | 1.67291 | 59.05 | 0.54250 | 29.44 |
| 9 | 46.0474 | 7.3514 | 1.73146 | 28.43 | 0.60807 | 29.76 |
| 10 | −35.8563 | 1.3000 | | | | 29.92 |
| *11 | −25.4207 | 0.7728 | 1.43599 | 67.00 | 0.52556 | 29.79 |
| *12 | −84.5329 | DD[12] | | | | 29.92 |
| 13 (St) | ∞ | 2.3495 | | | | 23.56 |
| *14 | 74.0130 | 1.6120 | 1.56608 | 71.09 | 0.54127 | 24.58 |
| *15 | −664.3833 | 6.1388 | | | | 24.78 |
| 16 | 56.5830 | 7.2037 | 1.56289 | 71.57 | 0.54110 | 27.80 |
| 17 | −26.2627 | 0.7383 | 1.73682 | 29.59 | 0.60418 | 28.27 |
| 18 | −30.6483 | 0.0496 | | | | 28.82 |
| *19 | 332.2425 | 0.7384 | 1.72165 | 30.48 | 0.60211 | 28.81 |
| *20 | 29.9384 | 0.0465 | | | | 28.57 |
| 21 | 27.6198 | 7.6181 | 1.57970 | 69.01 | 0.54198 | 28.65 |
| 22 | −47.6310 | DD[22] | | | | 28.78 |
| *23 | 104.7506 | 0.7048 | 1.84448 | 44.51 | 0.56092 | 27.40 |
| *24 | 25.6513 | DD[24] | | | | 26.79 |
| 25 | 47.3683 | 7.7893 | 1.57051 | 41.78 | 0.57605 | 31.37 |
| 26 | −35.4520 | 1.3512 | | | | 31.54 |
| 27 | −2384.9180 | 0.7665 | 1.54643 | 46.29 | 0.56764 | 29.66 |
| 28 | 43.6768 | 7.4675 | | | | 29.00 |
| 29 | −22.6279 | 0.8120 | 1.90001 | 35.85 | 0.58154 | 28.98 |
| 30 | −45.4509 | DD[30] | | | | 31.48 |

TABLE 29
Example 10

| | Wide | Middle | Tele |
|---|---|---|---|
| Zr | 1.0 | 1.8 | 2.7 |
| f | 24.70 | 44.07 | 67.76 |
| FNo. | 2.90 | 2.90 | 2.91 |
| 2ω [°] | 85.2 | 50.6 | 33.6 |
| DD[5] | 1.10 | 16.23 | 37.01 |
| DD[12] | 21.67 | 8.09 | 2.33 |
| DD[22] | 3.84 | 2.05 | 1.10 |
| DD[24 | 7.76 | 7.55 | 6.83 |
| DD[30] | 12.00 | 24.57 | 30.51 |

TABLE 30
Example 10

| Sn | 6 | 7 | 11 | 12 |
|---|---|---|---|---|
| KA | 1.0000000E+00 | 1.0000000E+00 | 1.0000000E+00 | 1.0000000E+00 |
| A4 | 9.5329524E−07 | 4.2021809E−06 | 1.1470242E−05 | −1.0198281E−06 |
| A6 | −1.1482527E−09 | 1.5161688E−08 | −2.1346710E−08 | −3.8317234E−08 |
| A8 | −5.6189490E−12 | 3.4807884E−11 | 1.5747522E−10 | 1.2276239E−10 |
| A10 | 3.2952478E−15 | 1.8177113E−13 | −4.0625642E−13 | −4.4631201E−13 |
| A12 | −8.5668695E−18 | 6.3210805E−16 | −1.7191985E−16 | −9.1507783E−17 |
| A14 | −9.8949705E−22 | −9.6328667E−19 | 9.8952632E−19 | −5.1020970E−19 |
| A16 | −3.6703662E−23 | 8.4547573E−23 | 3.7741080E−21 | 3.9376377E−21 |
| A18 | 8.2717479E−26 | 5.0656405E−23 | −1.3457477E−23 | −2.0759630E−24 |

| Sn | 14 | 15 | 19 | 20 |
|---|---|---|---|---|
| KA | 1.0000000E+00 | 1.0000000E+00 | 1.0000000E+00 | 1.0000000E+00 |
| A4 | −2.1942003E−05 | −5.4549097E−06 | −2.0886866E−06 | 7.9945446E−06 |
| A6 | −4.6828550E−08 | −2.2424353E−08 | 9.9487758E−10 | −1.0431610E−08 |
| A8 | 3.6370108E−11 | 1.9754978E−10 | 9.0498959E−11 | 8.1238676E−11 |
| A10 | 1.1314401E−12 | 5.4762234E−13 | −3.7177643E−14 | 1.5824493E−13 |
| A12 | 3.0980068E−15 | 3.6271952E−15 | −2.6604452E−16 | −9.2330419E−16 |
| A14 | 3.7899600E−18 | 4.7846518E−18 | −2.9532197E−18 | −1.7488864E−18 |
| A16 | −6.0148659E−20 | 1.6398142E−20 | −5.1312975E−21 | −1.2390795E−20 |
| A18 | −1.0901620E−22 | −4.4600909E−22 | 5.0912987E−23 | 7.2094135E−23 |

| Sn | 23 | 24 |
|---|---|---|
| KA | 1.0000000E+00 | 1.0000000E+00 |
| A4 | −3.3849593E−06 | −3.7875413E−06 |
| A6 | −1.3697574E−08 | −2.7491369E−08 |
| A8 | −4.2865798E−11 | 2.1655397E−10 |
| A10 | 6.6610755E−13 | −1.6664410E−12 |
| A12 | −2.1755475E−15 | 5.7632618E−15 |
| A14 | −4.7317741E−18 | 3.2079382E−18 |
| A16 | 3.3631235E−20 | −9.4733592E−20 |
| A18 | −5.2291327E−23 | 1.8997792E−22 |

### Example 11

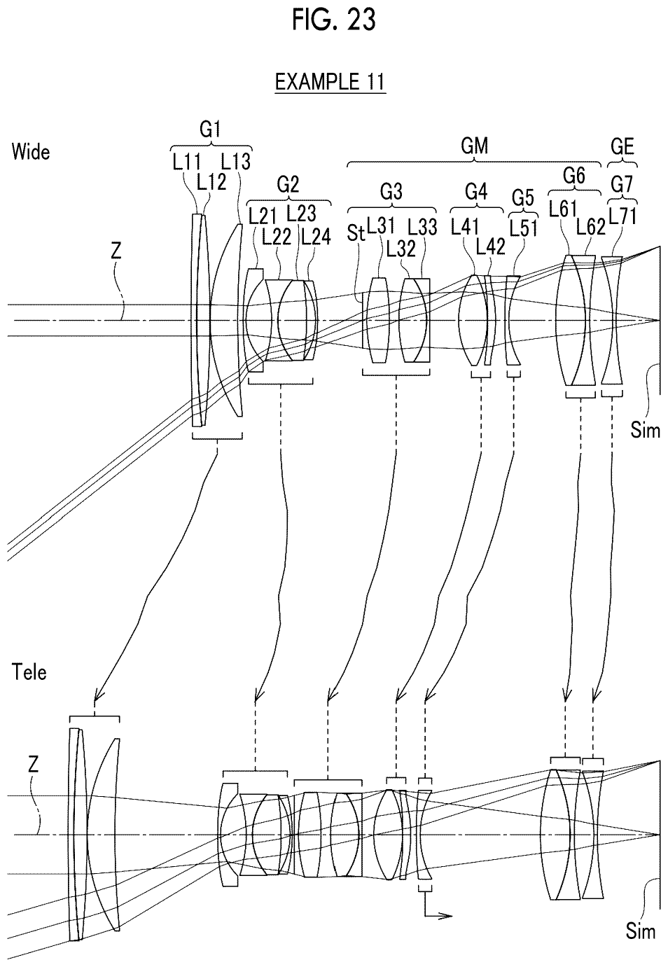

A configuration and a moving path of a variable magnification optical system of Example 11 are illustrated in FIG. 23. The variable magnification optical system of Example 11 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, a sixth lens group G6 having a positive refractive power, and a seventh lens group G7 having a negative refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, all lens groups move along the optical axis Z by changing spacings with respect to adjacent lens groups. The focus group consists of the fifth lens group G5. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and three lenses including the lenses L31 to L33. The fourth lens group G4 consists of, in order from the object side to the image side, two lenses including the lenses L41 and L42. The fifth lens group G5 consists of one lens that is the lens L51. The sixth lens group G6 consists of, in order from the object side to the image side, two lenses including lenses L61 and L62. The seventh lens group G7 consists of one lens that is a lens L71.

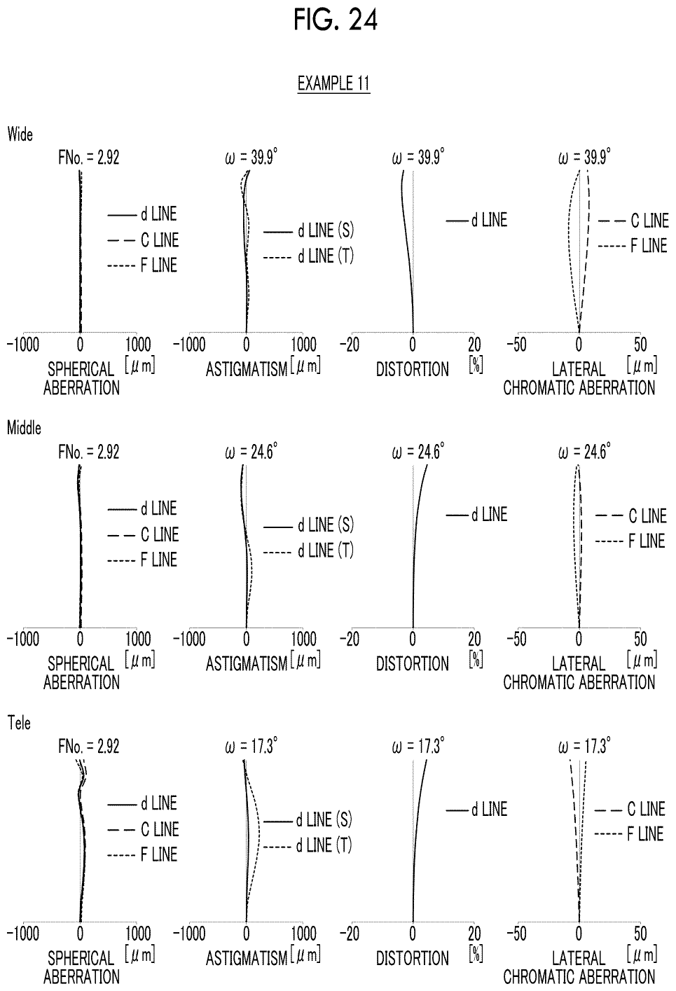

For the variable magnification optical system of Example 11, Table 31 shows basic lens data, Table 32 shows specifications and a variable surface spacing, Table 33 shows aspherical coefficients, and FIG. 24 illustrates each aberration diagram.

TABLE 31
Example 11

| Sn | R | D | Nd | νd | θgF | ED |
|---|---|---|---|---|---|---|
| 1 | 1096.8789 | 1.5616 | 1.93393 | 18.30 | 0.65369 | 62.00 |
| 2 | 344.2924 | 3.6116 | 1.43601 | 90.90 | 0.53134 | 61.29 |
| 3 | −346.0898 | 0.0500 | | | | 61.00 |
| 4 | 55.7302 | 7.5585 | 1.54414 | 57.60 | 0.54643 | 56.11 |
| 5 | 307.3548 | DD[5] | | | | 55.22 |
| *6 | 107.1565 | 0.7772 | 1.76513 | 52.63 | 0.54690 | 30.07 |
| *7 | 17.8608 | 7.0171 | | | | 24.00 |
| 8 | −41.2629 | 1.6945 | 1.53532 | 75.77 | 0.53965 | 23.76 |
| 9 | 19.1679 | 7.8603 | 1.72951 | 31.93 | 0.59776 | 23.32 |
| 10 | −80.9833 | 2.4447 | | | | 22.64 |
| 11 | −22.2956 | 0.5987 | 1.59015 | 67.38 | 0.54252 | 22.52 |
| 12 | −51.1260 | DD[12] | | | | 22.89 |
| 13 (St) | ∞ | 1.1632 | | | | 22.94 |
| *14 | 46.4690 | 6.1794 | 1.66067 | 59.65 | 0.54295 | 24.42 |
| *15 | −73.0107 | 2.5824 | | | | 24.80 |
| 16 | 46.0080 | 7.5880 | 1.44672 | 89.26 | 0.53242 | 24.37 |
| 17 | −22.3901 | 0.8239 | 1.89225 | 32.05 | 0.59280 | 23.81 |
| 18 | −4961.1264 | DD[18] | | | | 24.36 |
| 19 | 25.8059 | 7.8431 | 1.43600 | 90.90 | 0.53134 | 26.00 |
| 20 | −31.3914 | 0.0497 | | | | 26.28 |
| *21 | −349.8784 | 2.2101 | 1.55662 | 72.53 | 0.54077 | 26.01 |
| *22 | −45.2250 | DD[22] | | | | 25.97 |
| *23 | 206.1014 | 1.0606 | 1.72110 | 54.34 | 0.54543 | 25.92 |
| *24 | 28.8879 | DD[24] | | | | 25.50 |
| 25 | 65.6805 | 8.1171 | 1.88464 | 29.20 | 0.60199 | 38.01 |
| 26 | −48.9122 | 1.1773 | 1.59889 | 38.11 | 0.58345 | 37.93 |
| 27 | 109.7356 | DD[27] | | | | 36.55 |
| 28 | −55.4265 | 0.9546 | 1.56193 | 71.72 | 0.54105 | 36.27 |
| 29 | 104.3863 | DD[29] | | | | 37.28 |

TABLE 32
Example 11

| | Wide | Middle | Tele |
|---|---|---|---|
| Zr | 1.0 | 1.7 | 2.5 |
| f | 26.67 | 45.12 | 66.68 |
| FN0. | 2.92 | 2.92 | 2.92 |
| 2ω [°] | 79.8 | 49.2 | 34.6 |
| DD[5] | 1.46 | 19.96 | 28.09 |
| DD[12] | 12.11 | 4.77 | 0.54 |
| DD[18] | 7.92 | 4.30 | 3.24 |
| DD[22] | 2.55 | 1.45 | 1.53 |
| DD[24] | 12.83 | 22.71 | 32.86 |
| DD[27] | 6.29 | 8.74 | 5.31 |
| DD[29] | 11.99 | 12.30 | 17.14 |

TABLE 33
Example 11

| Sn | 6 | 7 | 14 | 15 |
|---|---|---|---|---|
| KA | 1.0000000E+00 | 0.0000000E+00 | 1.0000000E+00 | 1.0000000E+00 |
| A4 | 1.2608056E−05 | 3.2006874E−05 | 4.6903640E−07 | 3.1244088E−07 |
| A6 | −6.0793795E−08 | −1.0695180E−07 | −8.3631678E−09 | −3.3180410E−08 |
| A8 | 2.5110080E−10 | 2.4012525E−09 | −2.3720803E−10 | 4.2114405E−10 |
| A10 | −3.0451581E−13 | −2.7110615E−11 | 4.6264071E−12 | −4.8910524E−12 |
| A12 | −3.2425569E−16 | 1.7645771E−13 | −4.7448368E−14 | 2.8346287E−14 |
| A14 | −2.3103713E−19 | −5.0277617E−16 | 2.3394757E−16 | −7.6690685E−17 |
| A16 | 3.6726006E−21 | 3.8421546E−19 | −4.4186001E−19 | 7.2458853E−20 |

| Sn | 21 | 22 | 23 | 24 |
|---|---|---|---|---|
| KA | 1.0000000E+00 | 1.0000000E+00 | 1.0000000E+00 | 1.0000000E+00 |
| A4 | −4.1687858E−05 | −1.1030808E−05 | 1.6966408E−05 | 1.8024562E−05 |
| A6 | −1.1832487E−07 | −4.8810806E−08 | −1.5575182E−07 | −1.8850339E−07 |
| A8 | 2.7976699E−09 | 2.3783061E−09 | 6.4888415E−10 | 8.3461374E−10 |
| A10 | −7.5268794E−12 | −6.4248502E−12 | −3.3522309E−13 | 1.5199872E−13 |
| A12 | 2.0748660E−15 | 1.0158195E−15 | −2.4682656E−15 | −2.3279255E−15 |
| A14 | −2.1554168E−17 | 2.6814120E−17 | 3.1379245E−18 | −3.3377274E−17 |
| A16 | 4.3872111E−20 | −1.3105744E−19 | 2.2454906E−20 | 1.3865369E−19 |

### Example 12

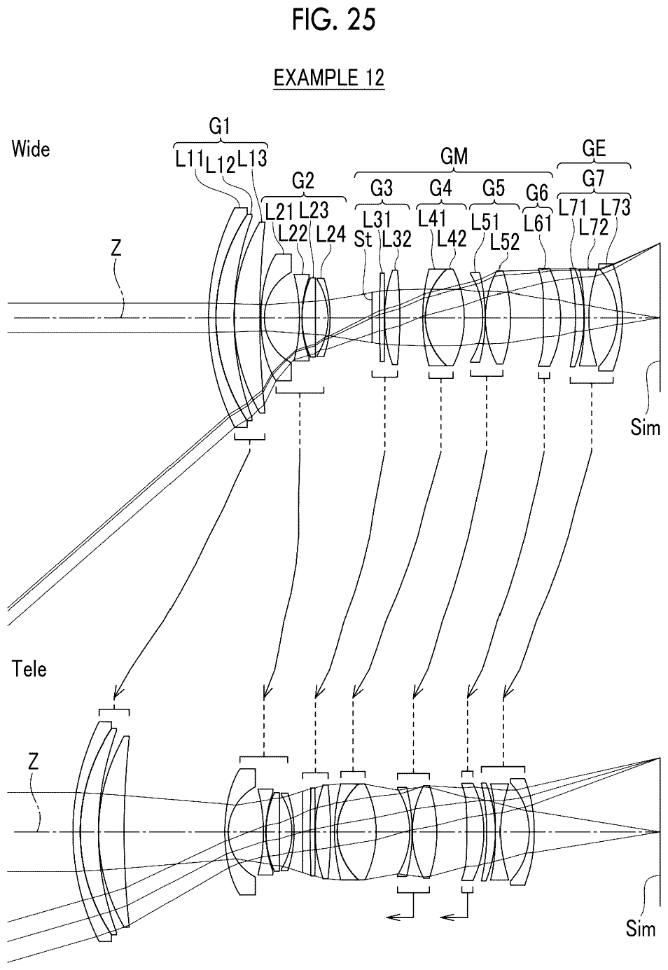

A configuration and a moving path of a variable magnification optical system of Example 12 are illustrated in FIG. 25. The variable magnification optical system of Example 12 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a positive refractive power, and the seventh lens group G7 having a negative refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, all lens groups move along the optical axis Z by changing spacings with respect to adjacent lens groups. During changing the magnification from the wide angle end to the telephoto end, the fourth lens group G4 and the seventh lens group G7 move on the same moving path. During focusing, the fifth lens group G5 and the sixth lens group G6 move by changing a mutual spacing. The object side focus group consists of the fifth lens group G5, and the image side focus group consists of the sixth lens group G6. During focusing from the infinite distance object to the nearest object, the object side focus group and the image side focus group move to the object side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and two lenses including the lenses L31 and L32. The fourth lens group G4 consists of, in order from the object side to the image side, two lenses including the lenses L41 and L42. The fifth lens group G5 consists of, in order from the object side to the image side, two lenses including the lenses L51 and L52. The sixth lens group G6 consists of one lens that is the lens L61. The seventh lens group G7 consists of, in order from the object side to the image side, three lenses including lenses L71 to L73.

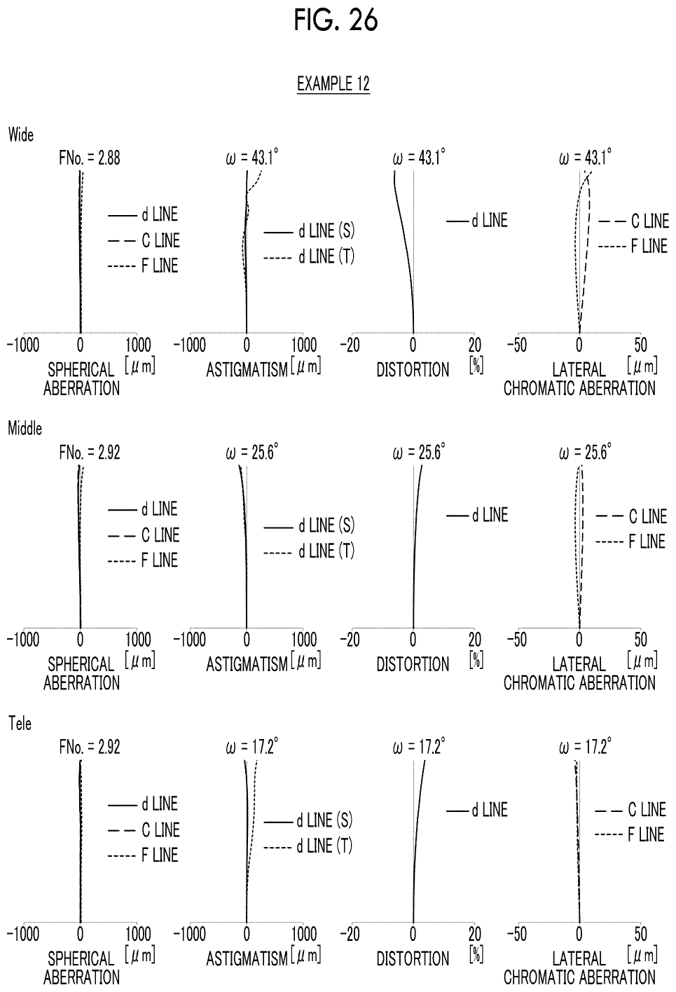

For the variable magnification optical system of Example 12, Table 34 shows basic lens data, Table 35 shows specifications and a variable surface spacing, Table 36 shows aspherical coefficients, and FIG. 26 illustrates each aberration diagram.

TABLE 34
Example 12

| Sn | R | D | Nd | νd | θgF | ED |
|---|---|---|---|---|---|---|
| 1 | 75.2092 | 1.9998 | 1.91753 | 19.12 | 0.64799 | 64.00 |
| 2 | 56.9916 | 4.9581 | 1.77746 | 51.36 | 0.54871 | 60.05 |
| 3 | 89.4763 | 0.0500 | | | | 58.61 |
| 4 | 58.7061 | 6.9894 | 1.48749 | 70.32 | 0.52917 | 55.60 |
| 5 | 270.1760 | DD[5] | | | | 54.56 |
| *6 | 49.7684 | 0.9462 | 1.62597 | 61.78 | 0.54356 | 36.80 |
| *7 | 15.4526 | 9.6246 | | | | 26.32 |
| 8 | −52.5425 | 0.6500 | 1.70706 | 52.40 | 0.54948 | 25.15 |
| 9 | 35.1263 | 0.0500 | | | | 23.05 |
| 10 | 29.6028 | 3.6509 | 1.84713 | 22.64 | 0.62854 | 22.89 |
| 11 | 32456.2274 | 3.4372 | | | | 22.10 |
| 12 | −21.7802 | 0.5910 | 1.72984 | 54.29 | 0.54519 | 21.96 |
| 13 | −38.1719 | DD[13] | | | | 22.71 |
| 14 (St) | ∞ | 1.9513 | | | | 23.79 |
| *15 | 171.3135 | 1.3762 | 1.80610 | 40.73 | 0.56940 | 25.30 |
| *16 | 538.9825 | 0.0500 | | | | 25.69 |
| 17 | 44.1206 | 4.1852 | 1.47099 | 85.57 | 0.53488 | 27.14 |
| 18 | −137.2287 | DD[18] | | | | 27.42 |
| 19 | 57.8906 | 0.7358 | 1.58122 | 39.88 | 0.57956 | 28.14 |
| 20 | 19.7722 | 10.6496 | 1.48849 | 82.90 | 0.53665 | 27.87 |
| 21 | −33.6095 | DD[21] | | | | 27.99 |
| 22 | −25.4202 | 0.6528 | 1.96068 | 32.48 | 0.58948 | 25.17 |
| 23 | −55.9445 | 0.0500 | | | | 26.00 |
| 24 | 31.0471 | 6.7074 | 1.49710 | 81.59 | 0.53752 | 27.00 |
| 25 | −45.2227 | DD[25] | | | | 27.00 |
| *26 | −7848.5070 | 4.6742 | 1.68885 | 58.27 | 0.54210 | 27.45 |
| *27 | −38.3404 | DD[27] | | | | 28.35 |
| 28 | −69.7820 | 2.3282 | 2.00069 | 25.43 | 0.61417 | 28.32 |
| 29 | −41.4180 | 0.0500 | | | | 28.57 |
| *30 | −101.7653 | 1.2500 | 1.67311 | 59.04 | 0.54249 | 28.15 |
| *31 | 39.5433 | 7.8369 | | | | 28.02 |
| *32 | −23.6676 | 1.3752 | 1.67798 | 54.89 | 0.54485 | 28.20 |
| *33 | −52.9681 | DD[33] | | | | 31.05 |

TABLE 35
Example 12

| | Wide | Middle | Tele |
|---|---|---|---|
| Zr | 1.0 | 1.8 | 2.7 |
| f | 24.62 | 43.93 | 67.54 |
| FNo. | 2.88 | 2.92 | 2.92 |
| 2ω [°] | 86.2 | 51.2 | 34.4 |
| DD[5] | 0.30 | 16.93 | 27.40 |
| DD[13] | 11.52 | 5.63 | 2.41 |
| DD[18] | 6.25 | 2.74 | 1.10 |
| DD[21] | 5.06 | 7.50 | 9.20 |
| DD[25] | 9.03 | 8.50 | 8.18 |
| DD[27] | 4.09 | 2.19 | 0.80 |
| DD[33] | 10.30 | 22.09 | 34.42 |

TABLE 36
Example 12

| Sn | 6 | 7 | 15 | 16 |
|---|---|---|---|---|
| KA | 1.0000000E+00 | 1.0000000E+00 | 1.0000000E+00 | 1.0000000E+00 |
| A4 | −4.7146542E−06 | −9.5511548E−06 | −5.9374073E−06 | −2.4961823E−06 |
| A6 | 6.6134325E−08 | 4.0791837E−08 | −9.5081074E−08 | −8.5955264E−08 |
| A8 | −2.6847148E−10 | −1.4251102E−10 | 6.4281775E−10 | 6.2788479E−10 |
| A10 | 6.9894388E−13 | 1.8893249E−12 | −1.7954931E−12 | −2.8264566E−12 |
| A12 | −2.1702552E−16 | −1.3021399E−14 | 1.0077100E−15 | 1.4063447E−14 |
| A14 | −2.8705601E−18 | 5.5014659E−17 | 2.5671932E−17 | −4.1671613E−17 |
| A16 | 4.6435605E−21 | 5.0306453E−20 | −4.9557330E−20 | 7.4473072E−20 |
| Sn | 26 | 27 | 30 | 31 |
| KA | 1.0000000E+00 | 1.0000000E+00 | 1.0000000E+00 | 1.0000000E+00 |
| A4 | −3.3140414E−05 | −6.9968305E−06 | −1.0191130E−05 | −7.5251104E−06 |
| A6 | −5.0481111E−08 | −4.9375802E−08 | −7.1432130E−09 | 1.3971322E−08 |
| A8 | −3.4864316E−11 | 2.0807142E−10 | 1.9791761E−10 | −1.0108234E−10 |
| A10 | 8.9129031E−13 | 2.1314041E−13 | −7.0945893E−13 | 3.4743464E−13 |
| A12 | 4.6260847E−15 | 1.4739941E−15 | −4.7486449E−15 | −7.2865509E−15 |
| A14 | −3.8886834E−17 | −1.9933983E−17 | 3.0213378E−17 | 2.6052757E−17 |
| A16 | 9.8972591E−20 | 7.1683506E−20 | −2.4786823E−20 | −1.8319937E−20 |

| Sn | 32 | 33 |
|---|---|---|
| KA | 1.0000000E+00 | 1.0000000E+00 |
| A4 | −8.0498328E−07 | −3.9542152E−06 |
| A6 | −2.4383473E−08 | −1.6227052E−08 |
| A8 | −5.0149451E−11 | −8.1406322E−11 |
| A10 | −1.4469725E−12 | 2.1560513E−13 |
| A12 | 8.5652343E−15 | 3.4664877E−16 |
| A14 | −1.0058819E−17 | 1.0759267E−17 |
| A16 | 2.0287149E−20 | −2.3588749E−20 |

### Example 13

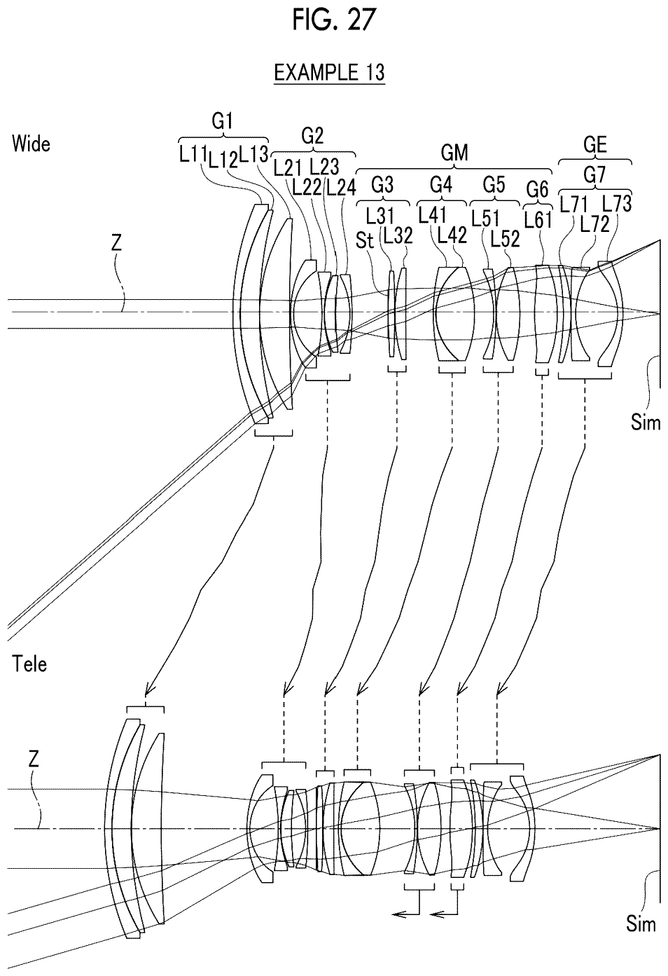

A configuration and a moving path of a variable magnification optical system of Example 13 are illustrated in FIG. 27. The variable magnification optical system of Example 13 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a positive refractive power, and the seventh lens group G7 having a negative refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, all lens groups move along the optical axis Z by changing spacings with respect to adjacent lens groups. During focusing, the fifth lens group G5 and the sixth lens group G6 move by changing a mutual spacing. The object side focus group consists of the fifth lens group G5, and the image side focus group consists of the sixth lens group G6. During focusing from the infinite distance object to the nearest object, the object side focus group and the image side focus group move to the object side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and two lenses including the lenses L31 and L32. The fourth lens group G4 consists of, in order from the object side to the image side, two lenses including the lenses L41 and L42. The fifth lens group G5 consists of, in order from the object side to the image side, two lenses including the lenses L51 and L52. The sixth lens group G6 consists of one lens that is the lens L61. The seventh lens group G7 consists of, in order from the object side to the image side, three lenses including the lenses L71 to L73.

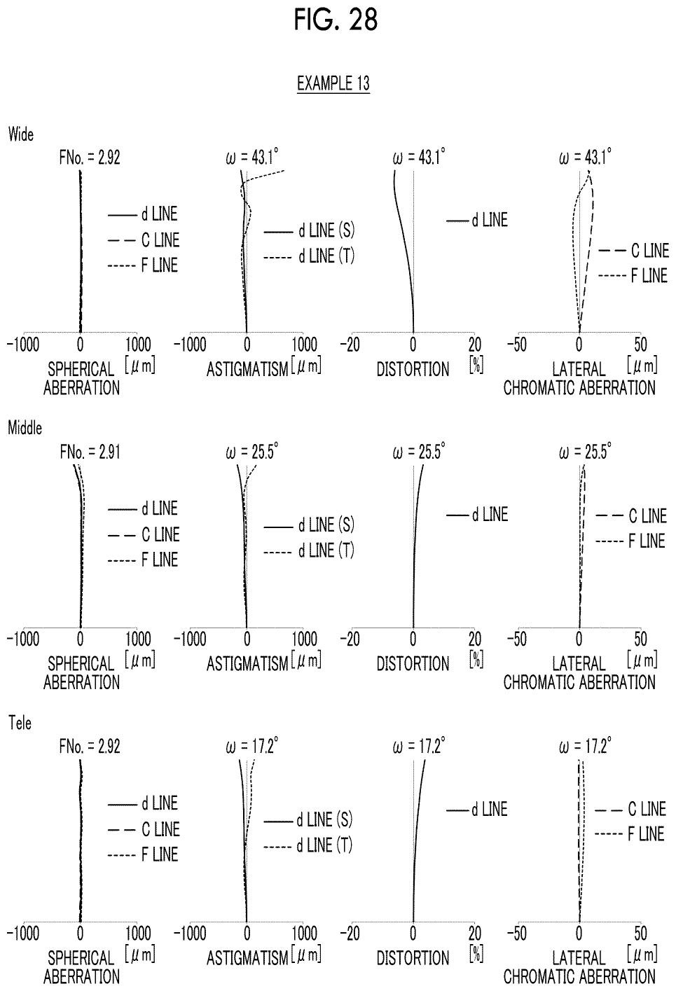

For the variable magnification optical system of Example 13, Table 37 shows basic lens data, Table 38 shows specifications and a variable surface spacing, Table 39 shows aspherical coefficients, and FIG. 28 illustrates each aberration diagram.

TABLE 37
Example 13

| Sn | R | D | Nd | νd | θgF | ED |
|---|---|---|---|---|---|---|
| 1 | 87.5546 | 1.9998 | 1.82155 | 23.92 | 0.61972 | 64.00 |
| 2 | 63.8178 | 5.2698 | 1.48749 | 70.32 | 0.52917 | 60.67 |
| 3 | 123.0825 | 0.0482 | | | | 59.62 |
| 4 | 54.7271 | 8.1691 | 1.48749 | 70.32 | 0.52917 | 55.60 |
| 5 | 473.5191 | DD[5] | | | | 54.54 |
| *6 | 35.5731 | 0.8128 | 1.88563 | 40.30 | 0.56957 | 31.53 |
| *7 | 16.4878 | 7.7519 | | | | 25.12 |
| 8 | −68.7503 | 0.6359 | 1.57060 | 57.71 | 0.54556 | 24.50 |
| 9 | 34.6778 | 0.0474 | | | | 22.18 |
| 10 | 28.3471 | 2.9234 | 1.93777 | 18.11 | 0.65503 | 22.39 |
| 11 | 95.3360 | 3.8698 | | | | 22.12 |
| 12 | −24.4374 | 0.5948 | 1.78720 | 50.37 | 0.55014 | 22.00 |
| 13 | −112.5108 | DD[13] | | | | 22.87 |
| 14 (St) | ∞ | 0.0000 | | | | 24.11 |
| *15 | 108.0960 | 1.8060 | 1.80610 | 40.73 | 0.56940 | 24.54 |
| *16 | −548.1834 | 0.0495 | | | | 24.94 |
| 17 | 48.0267 | 2.9678 | 1.73192 | 46.52 | 0.56055 | 26.51 |
| 18 | 2317.3005 | DD[18] | | | | 26.65 |
| 19 | 60.8067 | 0.7041 | 1.63460 | 34.67 | 0.59220 | 27.25 |
| 20 | 17.8974 | 10.5880 | 1.54387 | 74.47 | 0.54011 | 27.03 |
| 21 | −37.8119 | DD[21] | | | | 27.21 |
| 22 | −29.0747 | 0.6549 | 1.99564 | 25.57 | 0.61462 | 25.05 |
| 23 | −84.5848 | 0.0495 | | | | 25.76 |
| 24 | 29.6882 | 6.4555 | 1.49961 | 81.21 | 0.53768 | 27.00 |
| 25 | −51.2844 | DD[25] | | | | 27.00 |
| *26 | 53.6001 | 6.1640 | 1.72316 | 42.52 | 0.56940 | 27.91 |
| *27 | −49.1560 | DD[27] | | | | 28.48 |
| 28 | −75.9453 | 2.0729 | 2.00069 | 25.43 | 0.61417 | 28.13 |
| 29 | −44.5487 | 0.0492 | | | | 28.29 |
| *30 | 373.2497 | 1.2498 | 1.78209 | 50.89 | 0.54939 | 27.23 |
| *31 | 23.6440 | 11.4866 | | | | 25.49 |
| *32 | −18.9244 | 1.4360 | 1.58913 | 61.15 | 0.53824 | 27.83 |
| *33 | −37.3079 | DD[33] | | | | 30.64 |

TABLE 38
Example 13

| | Wide | Middle | Tele |
|---|---|---|---|
| Zr | 1.0 | 1.8 | 2.7 |
| f | 24.63 | 43.94 | 67.56 |
| FNo. | 2.92 | 2.91 | 2.92 |
| 2ω [°] | 86.2 | 51.0 | 34.4 |
| DD[5] | 0.30 | 16.13 | 23.41 |
| DD[13] | 9.86 | 5.29 | 2.30 |
| DD[18] | 7.51 | 4.01 | 1.10 |
| DD[21] | 5.22 | 7.32 | 9.59 |
| DD[25] | 4.02 | 2.96 | 2.39 |
| DD[27] | 1.69 | 0.80 | 0.80 |
| DD[33] | 10.20 | 22.16 | 34.26 |

TABLE 39
Example 13

| Sn | 6 | 7 | 15 | 16 |
|---|---|---|---|---|
| KA | 1.0000000E+00 | 1.0000000E+00 | 1.0000000E+00 | 1.0000000E+00 |
| A4 | −2.9392618E−07 | −1.4442742E−06 | −1.5352604E−05 | −9.3234909E−06 |
| A6 | 3.1577789E−08 | 7.3114714E−08 | 1.0719593E−07 | 4.9777011E−08 |
| A8 | −6.4178148E−11 | −1.0356355E−09 | −3.2124019E−09 | −1.6140513E−09 |
| A10 | −4.6695420E−14 | 1.8143934E−11 | 4.0484897E−11 | 1.6107474E−11 |
| A12 | 2.8807576E−15 | −1.3905039E−13 | −2.6504752E−13 | −6.9144171E−14 |
| A14 | −7.9286288E−18 | 5.2352688E−16 | 9.8353457E−16 | 1.5329821E−16 |
| A16 | 4.0094786E−21 | −1.6460582E−19 | −1.4498829E−18 | −6.1093799E−21 |

| Sn | 26 | 27 | 30 | 31 |
|---|---|---|---|---|
| KA | 1.0000000E+00 | 1.0000000E+00 | 1.0000000E+00 | 1.0000000E+00 |
| A4 | −3.0725495E−05 | −3.0156513E−06 | −1.1102964E−05 | −1.2939260E−05 |
| A6 | −6.4454551E−08 | −7.6034820E−08 | 2.5281002E−08 | 4.7363409E−08 |
| A8 | −1.2524200E−10 | 1.9476575E−10 | 3.9404305E−10 | −2.1129437E−10 |
| A10 | 3.5286348E−14 | −7.4299641E−14 | −2.1830415E−12 | 2.1455404E−12 |
| A12 | 6.7637644E−15 | 2.6343627E−15 | 3.5016164E−15 | −2.7340447E−16 |
| A14 | −1.3120622E−17 | −1.4125361E−17 | 3.2668517E−17 | −3.5016143E−17 |
| A16 | 3.1494715E−20 | 6.8040439E−20 | −8.3089400E−20 | 4.6153089E−19 |

| Sn | 32 | 33 |
|---|---|---|
| KA | 1.0000000E+00 | 1.0000000E+00 |
| A4 | −1.5053362E−05 | −1.5952854E−05 |
| A6 | −4.0909876E−09 | 1.0631828E−08 |
| A8 | 3.6045461E−10 | 2.5327615E−10 |
| A10 | −2.8022382E−12 | −8.0549478E−13 |
| A12 | 3.3075902E−14 | 7.6673088E−15 |
| A14 | 1.0050611E−16 | 9.7747279E−18 |
| A16 | −5.5886075E−19 | −1.0701049E−19 |

### Example 14

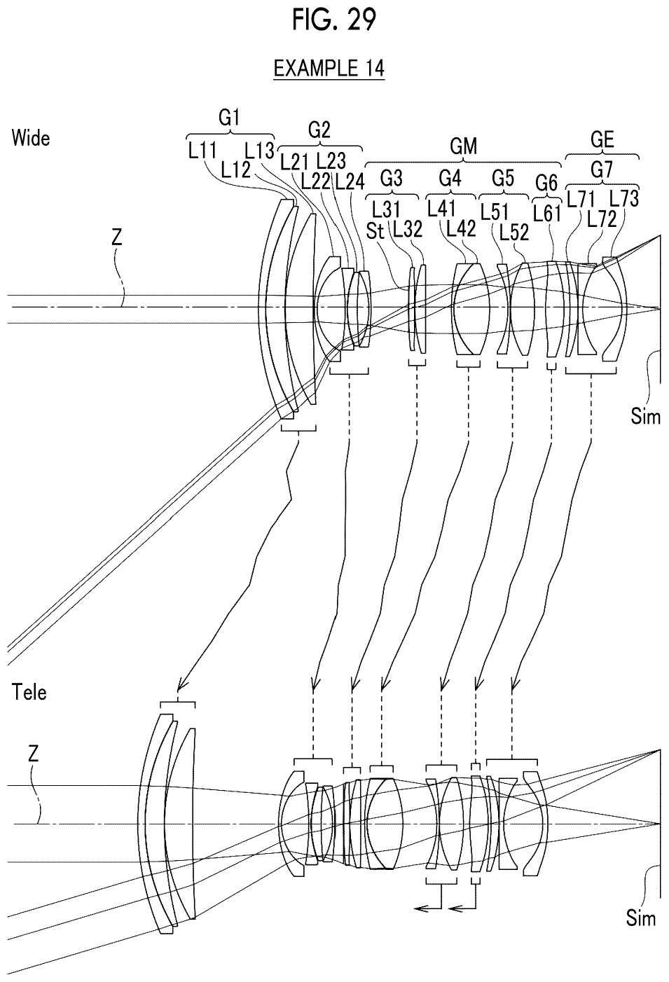

A configuration and a moving path of a variable magnification optical system of Example 14 are illustrated in FIG. 29. The variable magnification optical system of Example 14 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a positive refractive power, and the seventh lens group G7 having a negative refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, all lens groups move along the optical axis Z by changing spacings with respect to adjacent lens groups. During focusing, the fifth lens group G5 and the sixth lens group G6 move by changing a mutual spacing. The object side focus group consists of the fifth lens group G5, and the image side focus group consists of the sixth lens group G6. During focusing from the infinite distance object to the nearest object, the object side focus group and the image side focus group move to the object side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and two lenses including the lenses L31 and L32. The fourth lens group G4 consists of, in order from the object side to the image side, two lenses including the lenses L41 and L42. The fifth lens group G5 consists of, in order from the object side to the image side, two lenses including the lenses L51 and L52. The sixth lens group G6 consists of one lens that is the lens L61. The seventh lens group G7 consists of, in order from the object side to the image side, three lenses including the lenses L71 to L73.

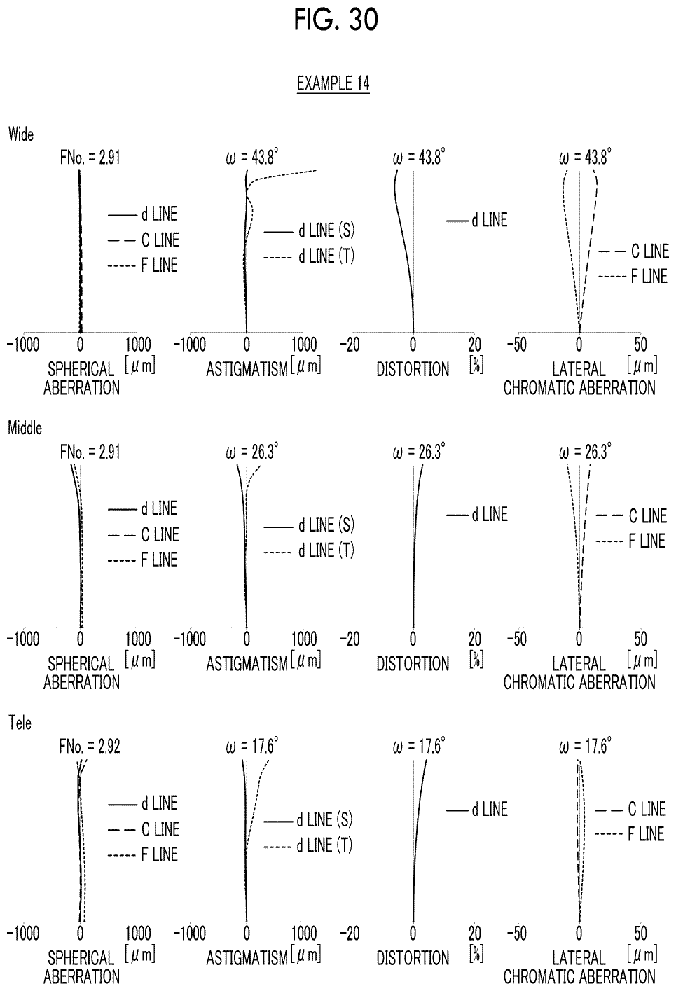

For the variable magnification optical system of Example 14, Table 40 shows basic lens data, Table 41 shows specifications and a variable surface spacing, Table 42 shows aspherical coefficients, and FIG. 30 illustrates each aberration diagram.

TABLE 40
Example 14

| Sn | R | D | Nd | νd | θgF | ED |
|---|---|---|---|---|---|---|
| 1 | 85.4035 | 1.9998 | 1.84615 | 22.69 | 0.62832 | 64.00 |
| 2 | 62.9483 | 5.2702 | 1.48749 | 70.32 | 0.52917 | 59.87 |
| 3 | 123.4398 | 0.0248 | | | | 58.87 |
| 4 | 58.2891 | 7.6776 | 1.48749 | 70.32 | 0.52917 | 55.60 |
| 5 | 524.7122 | DD[5] | | | | 54.58 |
| *6 | 34.5620 | 0.7908 | 1.89821 | 39.01 | 0.57273 | 30.69 |
| *7 | 16.4764 | 7.4776 | | | | 24.42 |
| 8 | −78.5835 | 0.6164 | 1.52347 | 77.58 | 0.53901 | 23.77 |
| 9 | 33.0723 | 0.0362 | | | | 21.44 |
| 10 | 30.6628 | 2.6945 | 1.92623 | 19.06 | 0.64878 | 21.51 |
| 11 | 114.3505 | 3.1413 | | | | 21.30 |
| *12 | −24.4275 | 0.5759 | 1.77150 | 51.97 | 0.54783 | 21.28 |
| *13 | −113.2017 | DD[13] | | | | 22.17 |
| 14 (St) | ∞ | 0.0000 | | | | 23.26 |
| *15 | 110.9526 | 1.6761 | 1.80610 | 40.73 | 0.56940 | 23.82 |
| *16 | −508.0808 | 0.0351 | | | | 24.09 |
| 17 | 47.1874 | 2.9278 | 1.71841 | 56.80 | 0.54255 | 25.52 |
| 18 | −2250.0033 | DD[18] | | | | 25.70 |
| 19 | 57.4011 | 0.6842 | 1.64106 | 34.98 | 0.59111 | 26.43 |
| 20 | 19.0219 | 9.7773 | 1.53945 | 75.14 | 0.53987 | 26.35 |
| 21 | −34.5952 | DD[21] | | | | 26.60 |
| 22 | −28.0146 | 0.6543 | 2.00000 | 26.87 | 0.60688 | 24.82 |
| 23 | −83.9027 | 0.0411 | | | | 25.61 |
| 24 | 29.2078 | 6.5859 | 1.49229 | 82.32 | 0.53704 | 27.00 |
| 25 | −49.4474 | DD[25] | | | | 27.00 |
| *26 | 52.6945 | 5.0308 | 1.75166 | 47.59 | 0.55745 | 27.76 |
| *27 | −47.9160 | DD[27] | | | | 27.98 |
| 28 | −80.6573 | 2.1705 | 2.00069 | 25.43 | 0.61417 | 27.58 |
| 29 | −43.1507 | 0.0325 | | | | 27.70 |
| *30 | 717.1820 | 1.2499 | 1.79919 | 49.14 | 0.55213 | 26.60 |
| *31 | 22.7717 | 10.6934 | | | | 25.00 |
| *32 | −18.6246 | 1.3748 | 1.58913 | 61.15 | 0.53824 | 26.99 |
| *33 | −44.6204 | DD[33] | | | | 30.40 |

TABLE 41
Example 14

| | Wide | Middle | Tele |
|---|---|---|---|
| Zr | 1.0 | 1.8 | 2.7 |
| f | 23.80 | 42.46 | 65.28 |
| FNo. | 2.91 | 2.91 | 2.92 |
| 2ω [°] | 87.6 | 52.6 | 35.2 |
| DD[5] | 0.28 | 10.66 | 23.48 |
| DD[13] | 10.28 | 4.36 | 2.28 |
| DD[18] | 7.05 | 3.17 | 1.09 |
| DD[21] | 4.98 | 6.92 | 9.30 |
| DD[25] | 3.02 | 2.63 | 1.70 |
| DD[27] | 1.65 | 1.36 | 0.77 |
| DD[33] | 9.18 | 20.72 | 30.77 |

TABLE 42
Example 14

| Sn | 6 | 7 | 12 | 13 |
|---|---|---|---|---|
| KA | 1.0000000E+00 | 1.0000000E+00 | 1.0000000E+00 | 1.0000000E+00 |
| A4 | 9.6517032E−07 | 2.1971801E−06 | 6.2334226E−06 | 2.2895531E−06 |
| A6 | 4.2582137E−08 | 8.4648988E−08 | −3.8335009E−07 | −4.0880590E−07 |
| A8 | −3.0156831E−11 | −6.1447676E−10 | 5.1575730E−09 | 6.7926866E−09 |
| A10 | −5.8755308E−14 | 1.6757112E−11 | −7.8513476E−12 | −5.9054169E−11 |
| A12 | 2.6855278E−15 | −1.2676081E−13 | −5.2420178E−13 | 2.6286582E−13 |
| A14 | −7.1924907E−18 | 4.7076597E−16 | 5.0733069E−15 | −6.1664229E−16 |
| A16 | 1.2433400E−21 | 4.7765098E−19 | −1.5416358E−17 | 4.1130290E−19 |

| Sn | 15 | 16 | 26 | 27 |
|---|---|---|---|---|
| KA | 1.0000000E+00 | 1.0000000E+00 | 1.0000000E+00 | 1.0000000E+00 |
| A4 | −1.6647970E−05 | −9.9876828E−06 | −3.1276954E−05 | −1.9827555E−06 |
| A6 | 5.9418111E−08 | 3.1108673E−08 | −6.6143623E−08 | −7.7208827E−08 |
| A8 | −2.3440632E−09 | −1.1898758E−09 | −1.2757217E−10 | 2.1382934E−10 |
| A10 | 4.5172763E−11 | 2.2522672E−11 | 8.4236667E−14 | −1.8124646E−13 |
| A12 | −3.0659204E−13 | −1.0934229E−13 | 7.3735802E−15 | 2.9018663E−15 |
| A14 | 1.0023180E−15 | 1.7895856E−16 | −9.3213318E−18 | −1.2021732E−17 |
| A16 | −1.1490443E−18 | 2.6293223E−19 | 4.0322450E−20 | 9.9134615E−20 |

| Sn | 30 | 31 | 32 | 33 |
|---|---|---|---|---|
| KA | 1.0000000E+00 | 1.0000000E+00 | 1.0000000E+00 | 1.0000000E+00 |
| A4 | −1.3935433E−05 | −1.3122722E−05 | −1.6735132E−05 | −1.9522331E−05 |
| A6 | 1.1578083E−08 | 2.8003197E−08 | −1.2930296E−08 | 1.3426163E−08 |
| A8 | 4.2393057E−10 | −2.5948391E−10 | 2.3148322E−10 | 1.5708659E−10 |
| A10 | −2.1487448E−12 | 2.3530290E−12 | −2.6128486E−12 | −5.8801418E−13 |
| A12 | 4.5720911E−15 | 1.0011901E−15 | 3.3019349E−14 | 8.4116713E−15 |
| A14 | 3.7645438E−17 | −1.1079106E−17 | 1.2021819E−16 | 8.2729441E−18 |
| A16 | −1.3677179E−19 | 4.3824880E−19 | −4.7017366E−19 | −1.1999315E−19 |

### Example 15

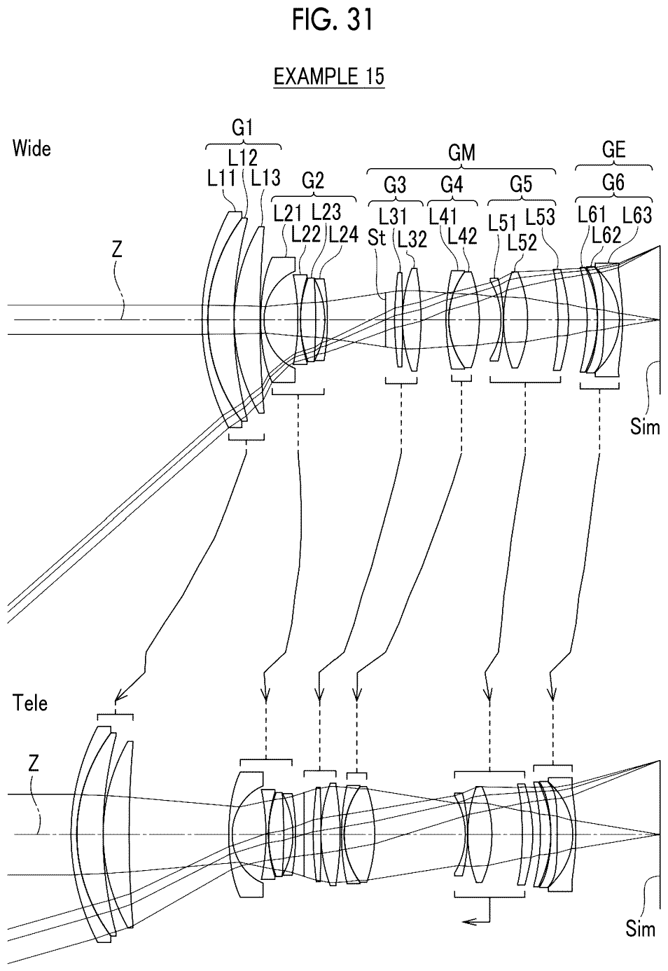

A configuration and a moving path of a variable magnification optical system of Example 15 are illustrated in FIG. 31. The variable magnification optical system of Example 15 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, and the sixth lens group G6 having a negative refractive power. The intermediate group GM consists of the third lens group G3, the fourth lens group G4, and the fifth lens group G5. The final lens group GE consists of the sixth lens group G6. During changing the magnification from the wide angle end to the telephoto end, all lens groups move along the optical axis Z by changing spacings with respect to adjacent lens groups. The focus group consists of the fifth lens group G5. During focusing from the infinite distance object to the nearest object, the focus group moves to the object side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and two lenses including the lenses L31 and L32. The fourth lens group G4 consists of, in order from the object side to the image side, two lenses including the lenses L41 and L42. The fifth lens group G5 consists of, in order from the object side to the image side, three lenses including the lenses L51 to L53. The sixth lens group G6 consists of, in order from the object side to the image side, three lenses including lenses L61 to L63.

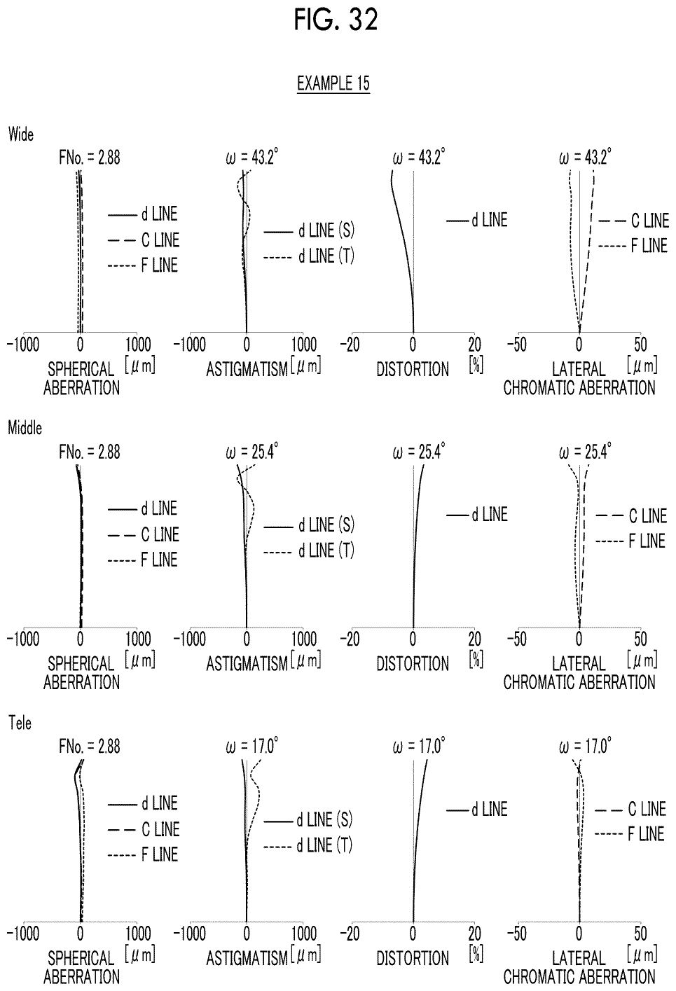

For the variable magnification optical system of Example 15, Table 43 shows basic lens data, Table 44 shows specifications and a variable surface spacing, Table 45 shows aspherical coefficients, and FIG. 32 illustrates each aberration diagram.

TABLE 43
Example 15

| Sn | R | D | Nd | νd | θgF | ED |
|---|---|---|---|---|---|---|
| 1 | 71.7165 | 1.5744 | 1.80610 | 33.34 | 0.59048 | 63.00 |
| 2 | 51.7543 | 7.1666 | 1.48749 | 70.32 | 0.52917 | 59.27 |
| 3 | 118.3569 | 0.0425 | | | | 57.94 |
| 4 | 58.1591 | 7.0752 | 1.48749 | 70.32 | 0.52917 | 54.40 |
| 5 | 326.7696 | DD[5] | | | | 53.36 |
| *6 | 67.0295 | 0.9124 | 1.75480 | 46.34 | 0.56010 | 36.50 |
| *7 | 16.9661 | 9.2604 | | | | 27.11 |
| 8 | −68.9715 | 0.6794 | 1.60686 | 64.77 | 0.54344 | 26.20 |
| 9 | 43.5666 | 0.0375 | | | | 24.50 |
| 10 | 37.5254 | 4.1274 | 1.82212 | 23.89 | 0.61978 | 24.38 |
| 11 | −181.9522 | 2.5020 | | | | 23.49 |
| 12 | −26.5160 | 0.7383 | 1.62123 | 48.89 | 0.55956 | 23.28 |
| 13 | −75.9754 | DD[13] | | | | 23.83 |
| 14 (St) | ∞ | 2.5004 | | | | 24.41 |
| *15 | 80.7969 | 2.1077 | 1.80610 | 40.73 | 0.56940 | 27.19 |
| *16 | 1933.9999 | 0.0467 | | | | 27.47 |
| 17 | 45.1890 | 5.0530 | 1.56574 | 71.14 | 0.54125 | 28.83 |
| 18 | −92.0999 | DD[18] | | | | 28.93 |
| 19 | 69.5984 | 0.7412 | 1.82484 | 28.31 | 0.60626 | 28.69 |
| 20 | 24.7147 | 8.3427 | 1.47027 | 85.68 | 0.53481 | 27.88 |
| 21 | −45.5955 | DD[21] | | | | 27.95 |
| 22 | −23.0319 | 0.6263 | 1.84234 | 36.55 | 0.58110 | 22.60 |
| 23 | −51.6476 | 0.0422 | | | | 24.12 |
| 24 | 42.5318 | 6.6150 | 1.55224 | 73.19 | 0.54054 | 27.58 |
| 25 | −37.1890 | 8.2722 | | | | 28.00 |
| *26 | −125.9263 | 2.8750 | 1.80610 | 40.73 | 0.56940 | 28.88 |
| *27 | −44.9594 | DD[27] | | | | 29.45 |
| 28 | −62.6025 | 2.8168 | 2.00069 | 25.46 | 0.61402 | 30.18 |
| 29 | −36.5748 | 0.0416 | | | | 30.56 |
| *30 | −47.4647 | 1.7500 | 1.80610 | 40.73 | 0.56940 | 30.43 |
| *31 | −157.7842 | 4.2271 | | | | 31.00 |
| *32 | −21.2612 | 0.8538 | 1.72207 | 56.62 | 0.54261 | 30.70 |
| *33 | −83.5279 | DD[33] | | | | 33.15 |

TABLE 44
Example 15

| | Wide | Middle | Tele |
|---|---|---|---|
| Zr | 1.0 | 1.8 | 2.7 |
| f | 24.70 | 44.07 | 67.77 |
| FNo. | 2.88 | 2.88 | 2.88 |
| 2ω [°] | 86.4 | 50.8 | 34.0 |
| DD[5] | 0.19 | 16.74 | 27.26 |
| DD[13] | 15.69 | 5.81 | 2.30 |
| DD[18] | 6.86 | 3.39 | 0.39 |
| DD[21] | 5.95 | 14.28 | 24.77 |
| DD[27] | 5.08 | 5.31 | 2.10 |
| DD[33] | 10.29 | 15.93 | 23.05 |

TABLE 45
Example 15

| Sn | 6 | 7 | 15 | 16 |
|---|---|---|---|---|
| KA | 1.0000000E+00 | 1.0000000E+00 | 1.0000000E+00 | 1.0000000E+00 |
| A4 | 1.1036932E−06 | −2.2423124E−06 | −1.0257433E−05 | −7.6000424E−06 |
| A6 | 2.9043890E−08 | 5.7723241E−08 | 3.5349587E−08 | 1.6865410E−08 |
| A8 | −8.9530650E−11 | −3.9012234E−10 | −1.3264724E−09 | −8.6274860E−10 |
| A10 | 9.7078630E−14 | 3.3090536E−12 | 1.4470778E−11 | 8.1105564E−12 |
| A12 | 2.2573298E−16 | 1.3414955E−14 | −6.4379652E−14 | −2.0664755E−14 |
| A14 | −4.8410666E−19 | −2.4276706E−16 | 1.2003307E−16 | −3.2852965E−17 |
| A16 | 8.7362899E−23 | 8.6463191E−19 | −1.8727857E−20 | 1.9898671E−19 |

| Sn | 26 | 27 | 30 | 31 |
|---|---|---|---|---|
| KA | 1.0000000E+00 | 1.0000000E+00 | 1.0000000E+00 | 1.0000000E+00 |
| A4 | −1.2703043E−05 | 2.6915314E−06 | 5.6437214E−06 | −1.7218479E−06 |
| A6 | −6.8121481E−09 | −2.2771890E−08 | −5.4747355E−08 | −4.7032348E−08 |
| A8 | 1.6318339E−10 | 3.9441425E−10 | 6.6670167E−11 | −2.1570624E−10 |
| A10 | 5.5216617E−13 | −2.9743911E−13 | −5.1088299E−13 | −8.3446845E−13 |
| A12 | −2.4908390E−15 | −3.1978141E−15 | −5.6821050E−15 | −3.5749129E−15 |
| A14 | −1.3358759E−17 | 2.1580037E−19 | 2.3678965E−17 | 9.7811096E−18 |
| A16 | 2.3995456E−20 | 5.1096728E−21 | 5.7056044E−21 | 4.3690085E−20 |

| Sn | 32 | 33 |
|---|---|---|
| KA | 1.0000000E+00 | 1.0000000E+00 |
| A4 | −4.5061472E−06 | −5.4743998E−06 |
| A6 | 2.1922897E−08 | 2.3766330E−08 |
| A8 | −1.3292646E−10 | 2.5355044E−11 |
| A10 | 2.8295936E−13 | 6.0447032E−13 |
| A12 | 1.6531518E−15 | −3.4051150E−16 |
| A14 | −1.1131348E−17 | −3.2322146E−18 |
| A16 | 2.7661392E−20 | 1.2192440E−21 |

### Example 16

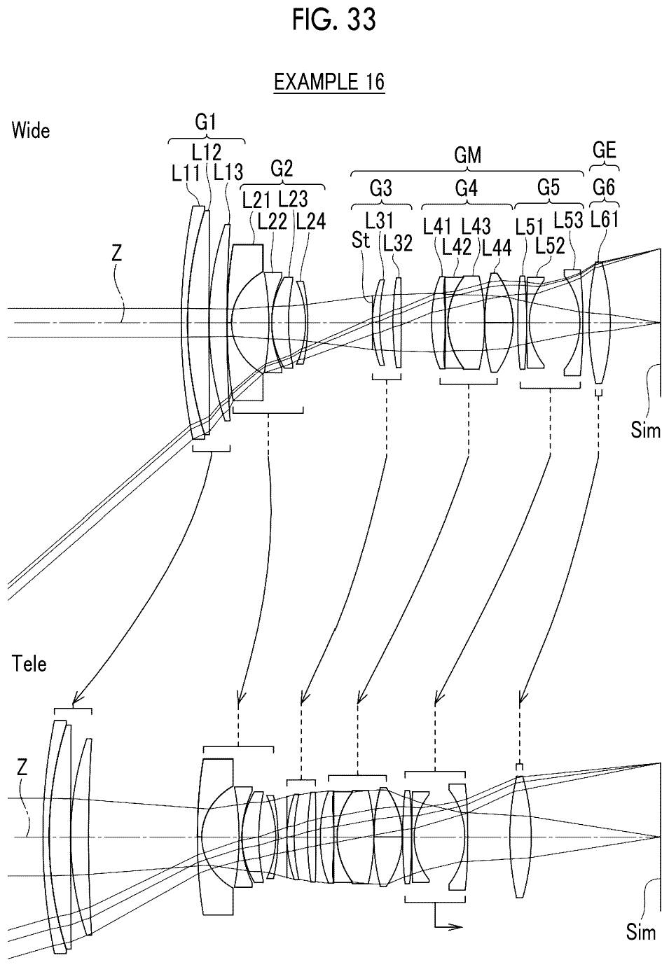

A configuration and a moving path of a variable magnification optical system of Example 16 are illustrated in FIG. 33. The variable magnification optical system of Example 16 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a positive refractive power. The intermediate group GM consists of the third lens group G3, the fourth lens group G4, and the fifth lens group G5. The final lens group GE consists of the sixth lens group G6. During changing the magnification from the wide angle end to the telephoto end, all lens groups move along the optical axis Z by changing spacings with respect to adjacent lens groups. The focus group consists of the fifth lens group G5. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and two lenses including the lenses L31 and L32. The fourth lens group G4 consists of, in order from the object side to the image side, four lenses including lenses L41 to L44. The fifth lens group G5 consists of, in order from the object side to the image side, three lenses including the lenses L51 to L53. The sixth lens group G6 consists of one lens that is the lens L61.

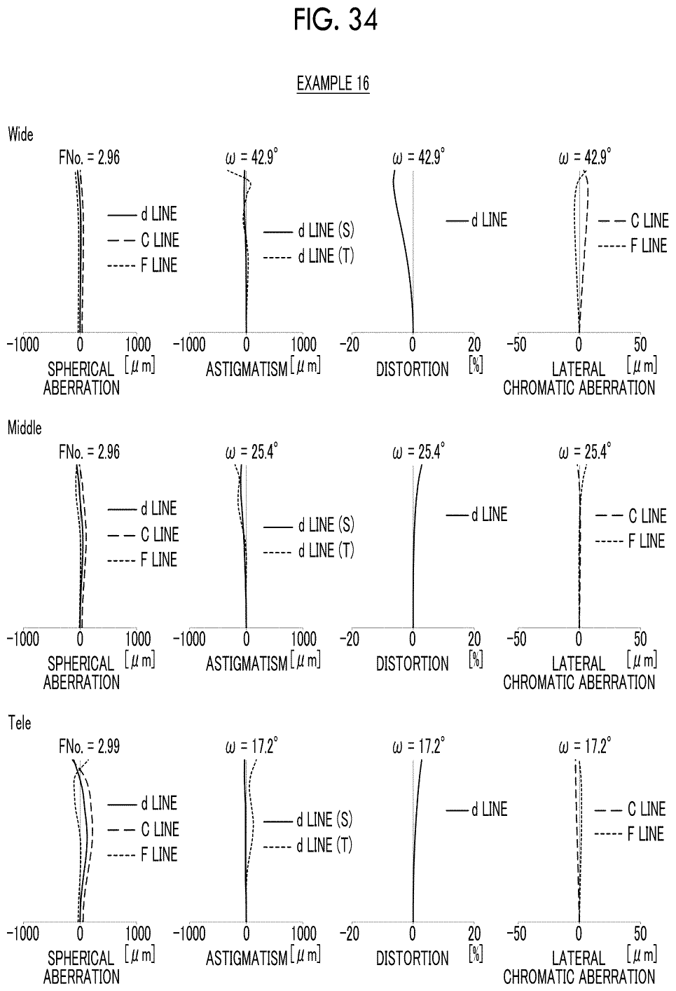

For the variable magnification optical system of Example 16, Table 46 shows basic lens data, Table 47 shows specifications and a variable surface spacing, Table 48 shows aspherical coefficients, and FIG. 34 illustrates each aberration diagram.

TABLE 46
Example 16

| Sn | R | D | Nd | νd | θgF | ED |
|---|---|---|---|---|---|---|
| 1 | 185.4356 | 1.6998 | 2.00069 | 25.46 | 0.61402 | 68.00 |
| 2 | 117.0846 | 5.8609 | 1.77406 | 51.71 | 0.54821 | 65.47 |
| 3 | 3139.3192 | 0.0487 | | | | 64.41 |
| 4 | 96.4814 | 4.8581 | 1.48749 | 70.32 | 0.52917 | 57.40 |
| 5 | 478.2547 | DD[5] | | | | 56.51 |
| *6 | 199.6561 | 1.1669 | 1.46766 | 86.08 | 0.53454 | 45.59 |
| *7 | 16.9403 | 10.2003 | | | | 29.80 |
| 8 | −86.0681 | 0.7582 | 1.51856 | 78.32 | 0.53874 | 29.34 |
| 9 | 33.3739 | 0.0427 | | | | 26.77 |
| 10 | 27.3870 | 4.5743 | 1.79904 | 25.55 | 0.61601 | 26.58 |
| 11 | 67.6044 | 4.6388 | | | | 25.11 |
| 12 | −31.1136 | 0.6295 | 1.65135 | 33.47 | 0.59535 | 24.25 |
| 13 | −58.9444 | DD[13] | | | | 24.06 |
| 14 (St) | ∞ | 0.0251 | | | | 23.86 |
| *15 | 36.2874 | 1.9618 | 1.86274 | 42.64 | 0.56440 | 24.98 |
| *16 | 56.9214 | 3.6533 | | | | 24.90 |
| 17 | 92.7198 | 2.2538 | 1.43751 | 90.67 | 0.53149 | 26.01 |
| 18 | −1400.8606 | DD[18] | | | | 26.19 |
| *19 | 48.7951 | 3.7069 | 1.72404 | 56.52 | 0.54265 | 26.93 |
| *20 | −76.1333 | 0.0478 | | | | 26.62 |
| 21 | −935.4759 | 0.6893 | 1.78084 | 32.11 | 0.59579 | 26.61 |
| 22 | 22.7013 | 10.0138 | 1.47622 | 84.77 | 0.53541 | 26.26 |
| 23 | −62.0200 | 0.0490 | | | | 27.20 |
| *24 | 63.7975 | 7.7424 | 1.49146 | 82.45 | 0.53695 | 28.40 |
| *25 | −24.5473 | DD[25] | | | | 28.86 |
| 26 | 141.9261 | 2.4270 | 2.00069 | 25.46 | 0.61402 | 27.16 |
| 27 | −185.1221 | 0.0440 | | | | 26.89 |
| 28 | 414.1101 | 0.6857 | 1.71857 | 55.70 | 0.54369 | 26.46 |
| 29 | 20.9709 | 13.8466 | | | | 24.84 |
| *30 | −25.7406 | 0.8009 | 1.64929 | 58.37 | 0.54288 | 27.38 |
| *31 | −256.4710 | DD[31] | | | | 31.02 |
| 32 | 85.5278 | 5.8393 | 1.63645 | 51.62 | 0.55359 | 34.60 |
| 33 | −68.7096 | DD[33] | | | | 35.48 |

TABLE 47
Example 16

| | Wide | Middle | Tele |
|---|---|---|---|
| Zr | 1.0 | 1.8 | 2.7 |
| f | 24.80 | 44.26 | 68.04 |
| FNo. | 2.96 | 2.96 | 2.99 |
| 2ω [°] | 85.8 | 50.8 | 34.4 |
| DD[5] | 0.10 | 15.62 | 29.77 |
| DD[13] | 17.48 | 8.04 | 2.41 |
| DD[18] | 8.31 | 3.27 | 1.24 |
| DD[25] | 1.25 | 0.42 | 0.10 |
| DD[31] | 1.67 | 7.90 | 11.50 |
| DD[33] | 13.75 | 24.12 | 35.36 |

TABLE 48
Example 16

| Sn | 6 | 7 | 15 | 16 |
|---|---|---|---|---|
| KA | 1.0000000E+00 | 1.0000000E+00 | 1.0000000E+00 | 1.0000000E+00 |
| A4 | 2.5469102E−06 | −5.2717243E−07 | −9.0722428E−06 | −4.9248318E−06 |
| A6 | −7.2024967E−09 | −1.8199500E−08 | −8.8502931E−09 | −5.6202599E−09 |
| A8 | 1.4631279E−11 | −4.2103669E−11 | 1.2064809E−10 | 1.8864902E−10 |
| A10 | −8.3648553E−15 | 2.2738805E−12 | 2.0158699E−13 | −2.1214489E−12 |
| A12 | −1.2833786E−17 | −2.9710199E−14 | −9.6141761E−15 | 1.9012844E−14 |
| A14 | 8.4633837E−21 | 1.4795629E−16 | 6.9622346E−17 | −8.6339017E−17 |
| A16 | 7.9641911E−24 | −2.6889984E−19 | −4.8239777E−20 | 2.9680328E−19 |

| Sn | 19 | 20 | 24 | 25 |
|---|---|---|---|---|
| KA | 1.0000000E+00 | 1.0000000E+00 | 1.0000000E+00 | 1.0000000E+00 |
| A4 | 2.2374124E−06 | 2.5543559E−05 | 4.1888744E−06 | 8.9013675E−06 |
| A6 | 5.7951812E−08 | 4.8887875E−08 | −2.4007256E−09 | −1.1585378E−08 |
| A8 | 3.6575373E−11 | 3.9726823E−11 | −1.0048425E−10 | −1.5935084E−11 |
| A10 | −3.3696567E−13 | 1.1108140E−13 | 3.3110235E−13 | 2.2851729E−13 |
| A12 | 2.3359809E−15 | 3.0651424E−15 | 8.1165548E−16 | −1.2871618E−15 |
| A14 | 5.7524765E−18 | −1.3003962E−17 | −2.6551801E−18 | 8.6685664E−18 |
| A16 | −9.6498121E−20 | −6.7289060E−20 | −4.9161400E−21 | −2.1837520E−20 |

| Sn | 30 | 31 |
|---|---|---|
| KA | 1.0000000E+00 | 1.0000000E+00 |
| A4 | −1.1372577E−05 | −1.1039946E−05 |
| A6 | −3.5269759E−08 | 3.1214051E−08 |
| A8 | 9.7011152E−10 | 1.3859406E−10 |
| A10 | −7.0839104E−12 | −9.8498859E−13 |
| A12 | 7.7531710E−15 | −1.8048246E−15 |
| A14 | 1.2060816E−16 | 2.9173253E−17 |
| A16 | −3.9031436E−19 | −6.3776388E−20 |

### Example 17

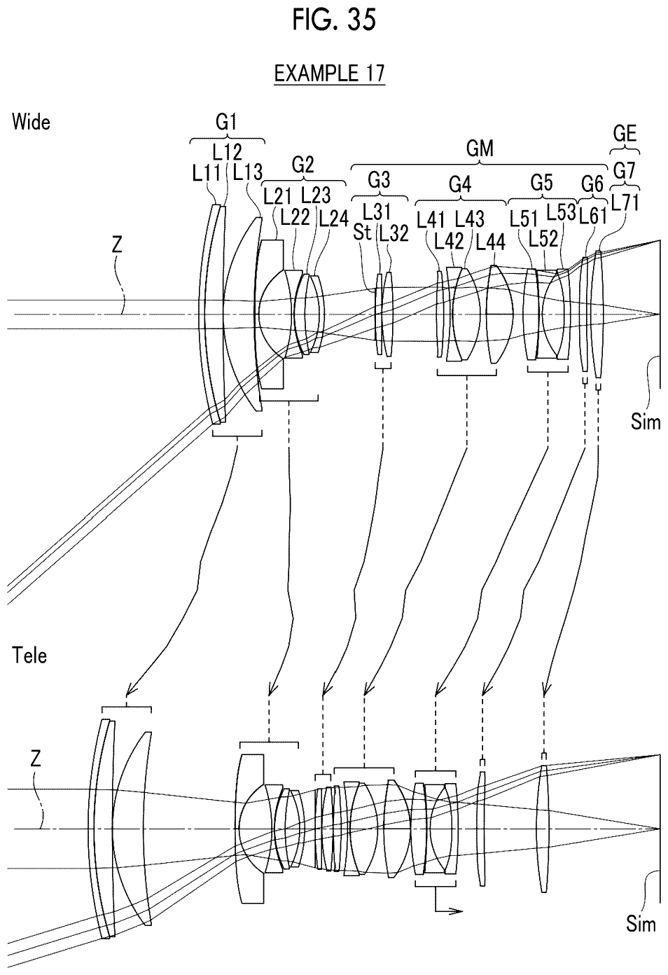

A configuration and a moving path of a variable magnification optical system of Example 17 are illustrated in FIG. 35. The variable magnification optical system of Example 17 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, the sixth lens group G6 having a negative refractive power, and the seventh lens group G7 having a positive refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, all lens groups move along the optical axis Z by changing spacings with respect to adjacent lens groups. During changing the magnification from the wide angle end to the telephoto end, the fourth lens group G4 and the sixth lens group G6 move on the same moving path. The focus group consists of the fifth lens group G5. During focusing from the infinite distance object to the nearest object, the focus group moves to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and two lenses including the lenses L31 and L32. The fourth lens group G4 consists of, in order from the object side to the image side, four lenses including the lenses L41 to L44. The fifth lens group G5 consists of, in order from the object side to the image side, three lenses including the lenses L51 to L53. The sixth lens group G6 consists of one lens that is the lens L61. The seventh lens group G7 consists of one lens that is the lens L71.

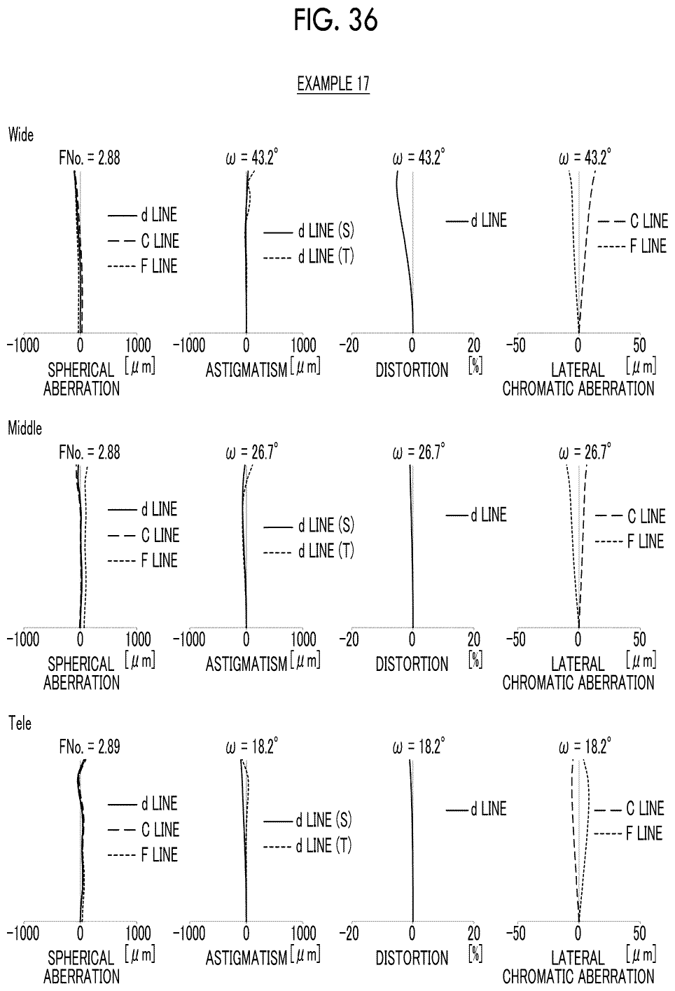

For the variable magnification optical system of Example 17, Table 49 shows basic lens data, Table 50 shows specifications and a variable surface spacing, Table 51 shows aspherical coefficients, and FIG. 36 illustrates each aberration diagram.

TABLE 49
Example 17

| Sn | R | D | Nd | νd | θgF | ED |
|---|---|---|---|---|---|---|
| 1 | 136.9731 | 1.6053 | 1.80610 | 33.34 | 0.59048 | 64.00 |
| 2 | 117.6942 | 5.0055 | 1.48749 | 70.32 | 0.52917 | 62.95 |
| 3 | 675.3812 | 0.0498 | | | | 62.26 |
| 4 | 48.8423 | 8.4506 | 1.48749 | 70.32 | 0.52917 | 56.48 |
| 5 | 178.2122 | DD[5] | | | | 55.02 |
| *6 | 239.9152 | 1.0850 | 1.57768 | 69.32 | 0.54187 | 38.41 |
| *7 | 15.7158 | 8.9666 | | | | 26.00 |
| 8 | −44.9482 | 0.6647 | 1.43822 | 77.24 | 0.52569 | 25.63 |
| 9 | 31.6570 | 0.1000 | | | | 23.54 |
| 10 | 27.7816 | 2.8847 | 1.99455 | 23.34 | 0.62718 | 23.42 |
| 11 | 56.1654 | 3.9590 | | | | 22.57 |
| 12 | −26.1327 | 1.3604 | 1.72401 | 28.80 | 0.60702 | 22.32 |
| 13 | −37.5757 | DD[13] | | | | 22.34 |
| 14 (St) | ∞ | 0.0000 | | | | 22.70 |
| *15 | 83.2529 | 1.7981 | 1.61881 | 63.85 | 0.54182 | 23.23 |
| *16 | −1601.3278 | 0.0498 | | | | 23.49 |
| 17 | 54.3714 | 3.0457 | 1.45935 | 87.34 | 0.53370 | 24.28 |
| 18 | −133.5754 | DD[18] | | | | 24.51 |
| *19 | 139.1196 | 1.9939 | 1.88882 | 39.97 | 0.57034 | 24.72 |
| *20 | −86.4991 | 1.7416 | | | | 25.02 |
| 21 | −91.9752 | 0.6852 | 1.83980 | 32.70 | 0.59230 | 25.18 |
| 22 | 35.5534 | 7.5648 | 1.43789 | 90.61 | 0.53153 | 25.91 |
| 23 | −26.1917 | 1.6363 | | | | 26.63 |
| *24 | 68.8964 | 7.3236 | 1.50344 | 80.63 | 0.53790 | 28.00 |
| *25 | −23.5601 | DD[25] | | | | 28.47 |
| 26 | 72.0742 | 4.2934 | 2.00069 | 25.46 | 0.61402 | 26.60 |
| 27 | −94.0152 | 0.0496 | | | | 26.04 |
| 28 | −148.7356 | 0.9012 | 1.90700 | 33.67 | 0.58759 | 25.68 |
| 29 | 20.2136 | 5.9839 | | | | 23.83 |
| *30 | −60.0086 | 1.6719 | 1.85222 | 43.72 | 0.56238 | 24.01 |
| *31 | −226.2105 | DD[31] | | | | 26.32 |
| *32 | 2247.7361 | 1.9441 | 1.51633 | 64.06 | 0.53345 | 32.41 |
| *33 | 221.0369 | DD[33] | | | | 33.31 |
| 34 | 115.7596 | 3.4325 | 2.00069 | 25.46 | 0.61402 | 36.87 |
| 35 | −237.2568 | DD[35] | | | | 37.00 |

TABLE 50
Example 17

| | Wide | Middle | Tele |
|---|---|---|---|
| Zr | 1.0 | 1.8 | 2.7 |
| f | 24.30 | 43.36 | 66.66 |
| FNo. | 2.88 | 2.88 | 2.89 |
| 2ω [°] | 86.4 | 53.4 | 36.4 |
| DD[5] | 0.20 | 10.86 | 25.06 |
| DD[13] | 13.71 | 6.08 | 2.84 |
| DD[18] | 11.86 | 3.03 | 0.10 |
| DD[25] | 2.75 | 1.44 | 0.10 |
| DD[31] | 2.49 | 3.80 | 5.14 |
| DD[33] | 1.15 | 11.15 | 14.32 |
| DD[35] | 15.57 | 22.28 | 30.41 |

TABLE 51
Example 17

| Sn | 6 | 7 | 15 | 16 |
|---|---|---|---|---|
| KA | 1.0000000E+00 | 1.0000000E+00 | 1.0000000E+00 | 1.0000000E+00 |
| A4 | 1.8967485E−06 | −4.4291037E−06 | −8.9473921E−06 | −2.6776803E−06 |
| A6 | 1.3071412E−08 | −3.0892906E−08 | 3.3081433E−08 | −6.1548517E−08 |
| A8 | −3.9138465E−11 | 8.6212858E−10 | −2.3258440E−09 | 5.2897706E−10 |
| A10 | 6.1596397E−14 | −1.5293364E−11 | 5.2339350E−11 | 4.1697655E−12 |
| A12 | −7.1606027E−17 | 1.4696088E−13 | −5.3602181E−13 | −8.3938970E−14 |
| A14 | 1.5379082E−19 | −7.1042848E−16 | 2.7714180E−15 | 5.2452990E−16 |
| A16 | −1.6555453E−22 | 1.3712234E−18 | −5.2267044E−18 | −6.1397967E−19 |

| Sn | 19 | 20 | 24 | 25 |
|---|---|---|---|---|
| KA | 1.0000000E+00 | 1.0000000E+00 | 1.0000000E+00 | 1.0000000E+00 |
| A4 | −1.3038963E−06 | 1.6821050E−05 | −5.2303033E−06 | 7.8077433E−06 |
| A6 | 2.7644447E−08 | 5.1851520E−08 | 1.3026200E−08 | −1.4844575E−08 |
| A8 | 2.8554222E−11 | −4.2841234E−11 | −5.3826090E−11 | 1.8466236E−11 |
| A10 | −1.9664454E−12 | −2.4879539E−12 | 9.6396584E−14 | 1.8536672E−13 |
| A12 | −1.6605886E−14 | −5.4703866E−16 | −2.5909061E−16 | −1.5549400E−15 |
| A14 | 4.5547146E−18 | −1.2711904E−16 | 1.3602634E−18 | 6.0573817E−18 |
| A16 | 1.3265042E−20 | 4.3670338E−19 | −2.1813592E−21 | −8.7467654E−21 |

| Sn | 30 | 31 | 32 | 33 |
|---|---|---|---|---|
| KA | 1.0000000E+00 | 1.0000000E+00 | 1.0000000E+00 | 1.0000000E+00 |
| A4 | −3.1806044E−05 | −1.5865322E−05 | 1.7434673E−05 | −3.2311781E−06 |
| A6 | −3.2588608E−08 | 1.1977742E−08 | −1.5946560E−08 | −1.1915129E−08 |
| A8 | 2.8866723E−10 | 1.3307521E−10 | −5.0866783E−11 | 3.6375797E−11 |
| A10 | −1.1902039E−12 | 7.9755986E−13 | 3.8908653E−13 | −7.3304571E−14 |
| A12 | 7.2570790E−15 | −1.8700259E−16 | 5.3572229E−16 | 2.4504329E−16 |
| A14 | −1.5488588E−17 | −1.8131290E−17 | −5.9042897E−18 | 2.5717501E−18 |
| A16 | 6.8324230E−20 | 5.5961098E−20 | 2.5968589E−21 | −1.3092513E−20 |

### Example 18

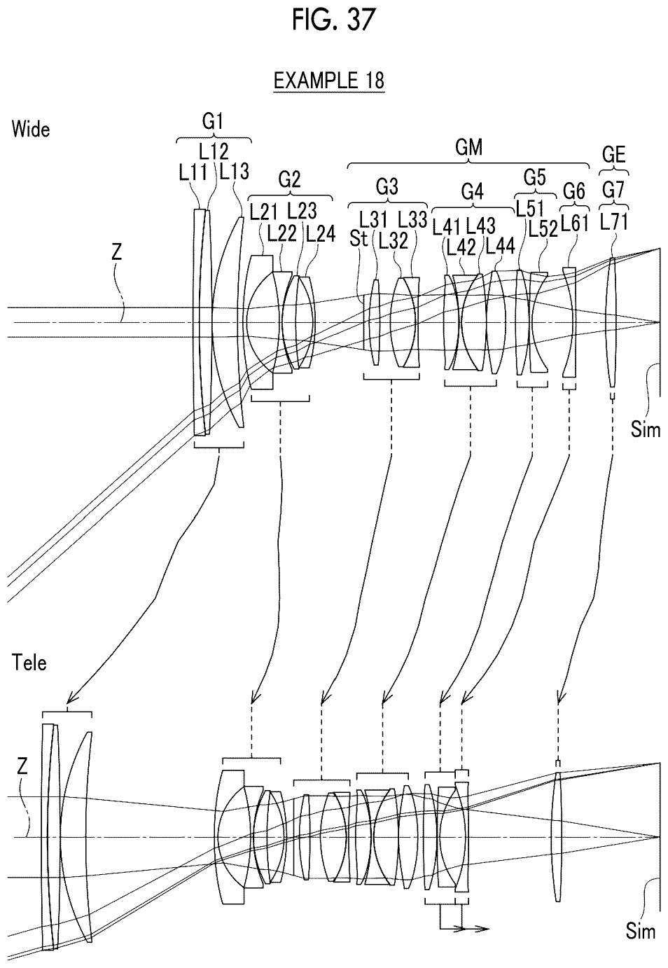

A configuration and a moving path of a variable magnification optical system of Example 18 are illustrated in FIG. 37. The variable magnification optical system of Example 18 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, the sixth lens group G6 having a negative refractive power, and the seventh lens group G7 having a positive refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, all lens groups move along the optical axis Z by changing spacings with respect to adjacent lens groups. During focusing, the fifth lens group G5 and the sixth lens group G6 move by changing a mutual spacing. The object side focus group consists of the fifth lens group G5, and the image side focus group consists of the sixth lens group G6. During focusing from the infinite distance object to the nearest object, the object side focus group and the image side focus group move to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and three lenses including the lenses L31 to L33. The fourth lens group G4 consists of, in order from the object side to the image side, four lenses including the lenses L41 to L44. The fifth lens group G5 consists of, in order from the object side to the image side, two lenses including the lenses L51 and L52. The sixth lens group G6 consists of one lens that is the lens L61. The seventh lens group G7 consists of one lens that is the lens L71.

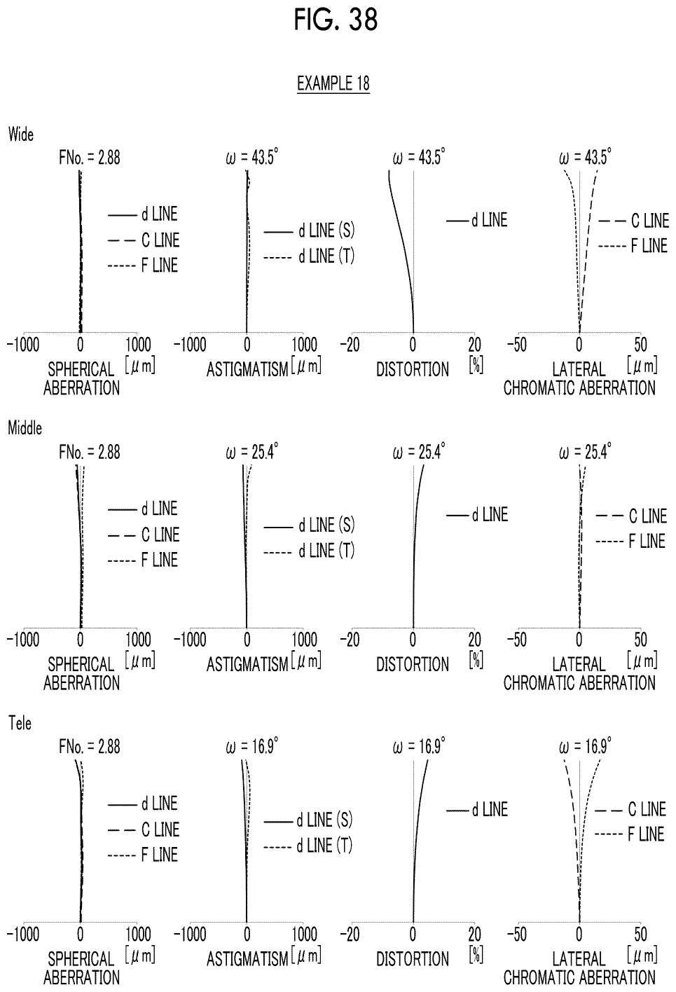

For the variable magnification optical system of Example 18, Table 52 shows basic lens data, Table 53 shows specifications and a variable surface spacing, Table 54 shows aspherical coefficients, and FIG. 38 illustrates each aberration diagram.

TABLE 52
Example 18

| Sn | R | D | Nd | νd | θgF | ED |
|---|---|---|---|---|---|---|
| 1 | 1547.4089 | 1.6633 | 1.89947 | 20.03 | 0.64175 | 66.00 |
| 2 | 312.4311 | 3.4919 | 1.54964 | 73.59 | 0.54040 | 65.25 |
| 3 | −763.7402 | 0.0462 | | | | 64.97 |
| 4 | 67.3550 | 6.9318 | 1.73505 | 55.70 | 0.54312 | 61.37 |
| 5 | 272.3923 | DD[5] | | | | 60.56 |
| *6 | 95.7170 | 1.0011 | 1.79999 | 49.06 | 0.55229 | 38.97 |
| *7 | 18.8909 | 8.9298 | | | | 29.55 |
| 8 | −60.2098 | 0.7664 | 1.49861 | 81.36 | 0.53762 | 29.63 |
| 9 | 36.1654 | 0.0382 | | | | 27.33 |
| 10 | 29.8797 | 3.6778 | 1.87327 | 24.90 | 0.61792 | 27.17 |
| 11 | 102.6257 | 4.6582 | | | | 26.42 |
| 12 | −24.8651 | 0.6863 | 1.50964 | 79.68 | 0.53825 | 26.41 |
| 13 | −53.8647 | DD[13] | | | | 26.25 |
| 14 (St) | ∞ | 1.5001 | | | | 22.36 |
| 15 | 56.4923 | 2.8950 | 1.94036 | 20.99 | 0.63874 | 24.65 |
| 16 | −192.6816 | 2.8817 | | | | 24.82 |
| 17 | 37.9050 | 6.8846 | 1.46118 | 87.06 | 0.53389 | 25.76 |
| 18 | −26.8241 | 0.6710 | 1.83567 | 28.00 | 0.60700 | 25.61 |
| 19 | 234.8691 | DD[19] | | | | 26.17 |
| *20 | 85.8723 | 4.2047 | 1.81534 | 47.49 | 0.55533 | 27.17 |
| *21 | −40.5913 | 0.0460 | | | | 27.53 |
| 22 | −55.3176 | 0.6993 | 1.81400 | 24.30 | 0.61898 | 27.16 |
| 23 | 23.8053 | 6.7430 | 1.45767 | 87.60 | 0.53353 | 27.51 |
| 24 | −90.1705 | 0.0411 | | | | 28.09 |
| *25 | 57.4395 | 5.2802 | 1.82051 | 46.95 | 0.55637 | 29.50 |
| *26 | −49.2731 | DD[26] | | | | 30.02 |
| 27 | 257.6459 | 3.7084 | 1.94172 | 20.30 | 0.64210 | 30.66 |
| 28 | −56.6320 | 0.0463 | | | | 30.65 |
| 29 | 256.1702 | 0.7447 | 1.72095 | 52.83 | 0.54817 | 29.12 |
| 30 | 24.1217 | DD[30] | | | | 27.34 |
| *31 | −44.0389 | 0.8336 | 1.78792 | 40.02 | 0.57317 | 30.40 |
| *32 | −570.1594 | DD[32] | | | | 32.02 |
| 33 | 131.2105 | 2.8761 | 1.84218 | 22.89 | 0.62689 | 37.43 |
| 34 | −387.5090 | DD[34] | | | | 37.60 |

TABLE 53
Example 18

| | Wide | Middle | Tele |
|---|---|---|---|
| Zr | 1.0 | 1.8 | 2.7 |
| f | 24.74 | 44.15 | 67.88 |
| FNo. | 2.88 | 2.88 | 2.88 |
| 2ω [°] | 87.0 | 50.8 | 33.8 |
| DD[5] | 1.50 | 18.70 | 35.15 |
| DD[13] | 13.09 | 4.77 | 1.99 |
| DD[19] | 6.99 | 3.19 | 1.90 |
| DD[26] | 2.68 | 2.60 | 1.49 |
| DD[30] | 11.17 | 10.71 | 7.01 |
| DD[32] | 8.13 | 15.81 | 22.62 |
| DD[34] | 11.99 | 17.18 | 26.87 |

TABLE 54
Example 18

| Sn | 6 | 7 | 20 | 21 |
|---|---|---|---|---|
| KA | 1.0000000E+00 | 1.0000000E+00 | 1.0000000E+00 | 1.0000000E+00 |
| A4 | 1.6748778E−06 | −2.1901392E−07 | −1.4235701E−05 | −1.3404796E−06 |
| A6 | 9.3567145E−10 | 3.2358328E−09 | 7.9010412E−09 | −1.7132843E−08 |
| A8 | −2.5675374E−13 | −2.7597416E−11 | −3.8316762E−10 | −2.1293958E−10 |
| A10 | −2.4066671E−16 | 3.2956806E−13 | 4.3270074E−13 | −1.6903496E−13 |
| A12 | −1.4630071E−18 | −1.8812519E−15 | 4.7049041E−15 | 6.9590220E−15 |
| A14 | 2.3832628E−20 | 4.9434154E−18 | −2.3269002E−17 | −2.5807587E−17 |

| Sn | 25 | 26 | 31 | 32 |
|---|---|---|---|---|
| KA | 1.0000000E+00 | 1.0000000E+00 | 1.0000000E+00 | 1.0000000E+00 |
| A4 | −2.6815580E−06 | 3.0654617E−06 | −6.9920446E−06 | −4.0168853E−06 |
| A6 | −2.2873420E−08 | −2.7256492E−08 | 1.6551333E−08 | 3.0119064E−08 |
| A8 | −2.8047284E−11 | −7.8961653E−12 | 4.0696402E−11 | 1.1726498E−11 |
| A10 | 9.6187136E−14 | −1.4578976E−13 | −1.7431325E−13 | −3.4001002E−13 |
| A12 | −3.3854794E−16 | 5.2286841E−17 | 2.7964840E−16 | 1.4736371E−15 |
| A14 | 1.3721626E−18 | 5.5570182E−19 | 1.5543444E−18 | −1.8127478E−18 |

### Example 19

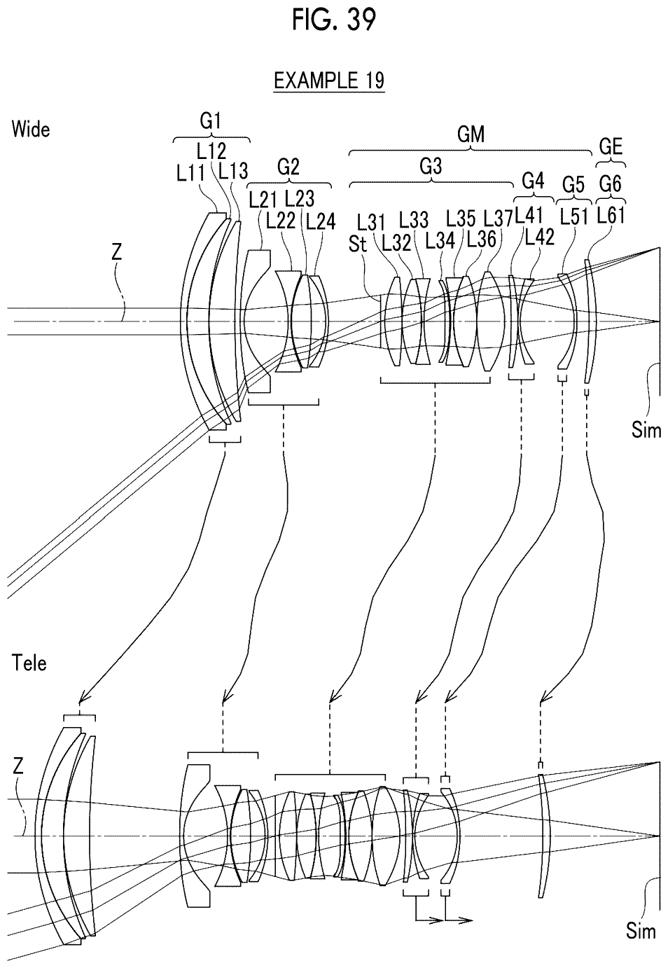

A configuration and a moving path of a variable magnification optical system of Example 19 are illustrated in FIG. 39. The variable magnification optical system of Example 19 consists of, in order from the object side to the image side, the first lens group G1 having a positive refractive power, the second lens group G2 having a negative refractive power, the third lens group G3 having a positive refractive power, the fourth lens group G4 having a negative refractive power, the fifth lens group G5 having a negative refractive power, and the sixth lens group G6 having a positive refractive power. The intermediate group GM consists of the third lens group G3, the fourth lens group G4, and the fifth lens group G5. The final lens group GE consists of the sixth lens group G6. During changing the magnification from the wide angle end to the telephoto end, all lens groups move along the optical axis Z by changing spacings with respect to adjacent lens groups. During focusing, the fourth lens group G4 and the fifth lens group G5 move by changing a mutual spacing. The object side focus group consists of the fourth lens group G4, and the image side focus group consists of the fifth lens group G5. During focusing from the infinite distance object to the nearest object, the object side focus group and the image side focus group move to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and seven lenses including lenses L31 to L37. The fourth lens group G4 consists of, in order from the object side to the image side, two lenses including the lenses L41 and L42. The fifth lens group G5 consists of one lens that is the lens L51. The sixth lens group G6 consists of one lens that is the lens L61.

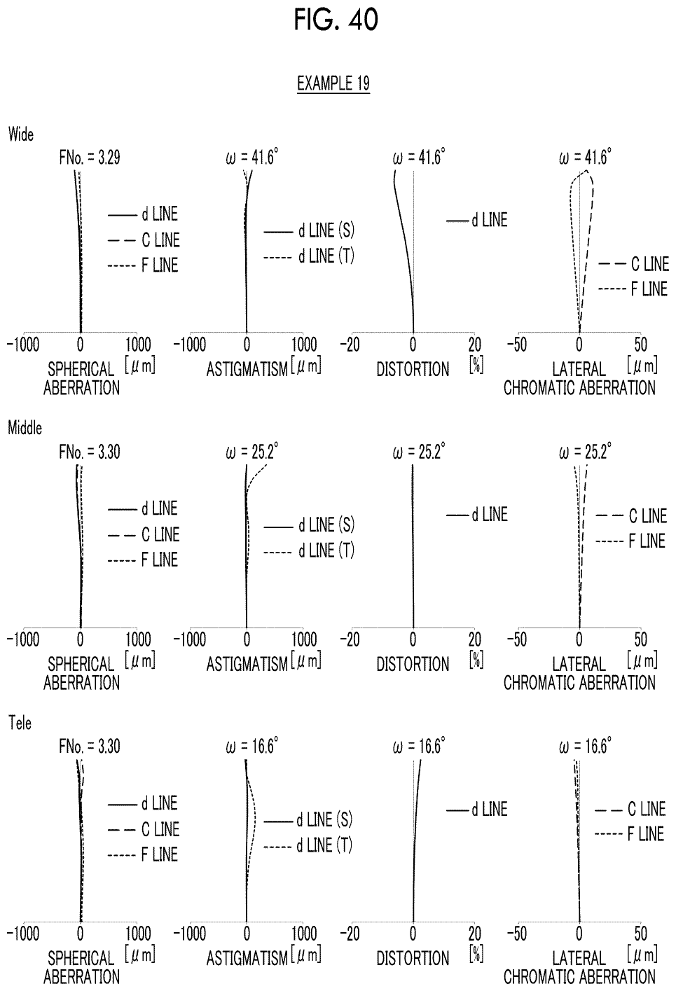

For the variable magnification optical system of Example 19, Table 55 shows basic lens data, Table 56 shows specifications and a variable surface spacing, Table 57 shows aspherical coefficients, and FIG. 40 illustrates each aberration diagram.

TABLE 55
Example 19

| Sn | R | D | Nd | νd | θgF | ED |
|---|---|---|---|---|---|---|
| 1 | 67.6162 | 1.7823 | 1.89128 | 20.44 | 0.63907 | 63.40 |
| 2 | 47.0267 | 6.0055 | 1.69935 | 42.76 | 0.56967 | 59.91 |
| 3 | 75.8674 | 0.0500 | | | | 59.11 |
| 4 | 61.0691 | 7.0896 | 1.75166 | 54.00 | 0.54490 | 58.32 |
| 5 | 267.5022 | DD[5] | | | | 57.39 |
| *6 | 116.8122 | 1.0787 | 1.87819 | 41.06 | 0.56791 | 41.57 |
| *7 | 19.4226 | 12.0273 | | | | 32.22 |
| 8 | −32.5913 | 0.7636 | 1.58724 | 66.18 | 0.54185 | 29.41 |
| 9 | 34.1721 | 0.1357 | | | | 27.01 |
| 10 | 31.3114 | 5.4204 | 1.89064 | 21.10 | 0.63635 | 27.06 |
| 11 | −88.6457 | 3.9587 | | | | 26.55 |
| 12 | −21.2305 | 0.7279 | 1.89706 | 30.69 | 0.59701 | 25.91 |
| 13 | −34.5978 | DD[13] | | | | 26.64 |
| 14 (St) | ∞ | 1.1881 | | | | 23.58 |
| 15 | 31.9151 | 4.6635 | 1.80928 | 48.11 | 0.55413 | 25.83 |
| 16 | −126.2166 | 0.0500 | | | | 25.69 |
| 17 | 32.0782 | 5.3145 | 1.43602 | 90.89 | 0.53134 | 24.52 |
| 18 | −47.5645 | 0.6914 | 1.98063 | 28.34 | 0.60247 | 23.83 |
| 19 | 46.8120 | 5.7632 | | | | 23.08 |
| *20 | −494.5413 | 1.2890 | 1.89995 | 34.33 | 0.58588 | 23.32 |
| *21 | −59.5168 | 0.2122 | | | | 23.90 |
| 22 | −59.8722 | 0.8118 | 1.73632 | 36.82 | 0.58324 | 24.14 |
| 23 | 32.8531 | 6.3343 | 1.46930 | 85.83 | 0.53471 | 25.55 |
| 24 | −38.9610 | 0.0502 | | | | 26.35 |
| *25 | 56.5580 | 7.5792 | 1.61876 | 62.91 | 0.54387 | 28.50 |
| *26 | −26.6409 | DD[26] | | | | 28.87 |
| 27 | −138.3063 | 1.8127 | 1.89322 | 20.34 | 0.63959 | 26.87 |
| 28 | −64.5186 | 0.0500 | | | | 26.76 |
| 29 | 40.4844 | 0.6263 | 1.73786 | 55.42 | 0.54334 | 24.80 |
| 30 | 21.0277 | DD[30] | | | | 23.84 |
| *31 | −22.0098 | 0.7500 | 1.89262 | 39.58 | 0.57131 | 25.80 |
| *32 | −40.5848 | DD[32] | | | | 27.72 |
| 33 | −139.6982 | 2.0185 | 1.89987 | 32.89 | 0.59005 | 35.60 |
| 34 | −78.1045 | DD[34] | | | | 36.00 |

TABLE 56
Example 19

| | Wide | Middle | Tele |
|---|---|---|---|
| Zr | 1.0 | 1.8 | 2.7 |
| f | 25.89 | 46.21 | 71.04 |
| FNo. | 3.29 | 3.30 | 3.30 |
| 2ω [°] | 83.2 | 50.4 | 33.2 |
| DD[5] | 1.45 | 8.57 | 24.63 |
| DD[13] | 14.08 | 4.70 | 2.00 |
| DD[26] | 1.79 | 2.85 | 1.62 |
| DD[30] | 14.75 | 13.12 | 11.57 |
| DD[32] | 3.27 | 23.47 | 22.65 |
| DD[34] | 17.39 | 14.76 | 29.99 |

TABLE 57
Example 19

| Sn | 6 | 7 | 20 | 21 |
|---|---|---|---|---|
| KA | 1.0000000E+00 | 1.0000000E+00 | 1.0000000E+00 | 1.0000000E+00 |
| A4 | 4.0401732E−06 | −2.3500895E−06 | −4.9584291E−05 | −6.7490827E−06 |
| A6 | −1.3280248E−08 | −2.6584415E−08 | −1.8283050E−07 | −1.8135541E−07 |
| A8 | 3.8720961E−11 | 2.7079495E−11 | −9.7302478E−10 | −9.4793942E−10 |
| A10 | −4.3561529E−14 | −5.7407810E−13 | −4.4290756E−12 | −1.9897443E−12 |
| A12 | −2.3575289E−17 | −3.5856090E−16 | 7.1773774E−14 | 5.0374745E−14 |
| A14 | 5.1883149E−20 | 1.4775205E−17 | −1.0339759E−16 | −9.1670347E−18 |
| A16 | 9.4485970E−24 | −6.3234363E−20 | −1.7797546E−20 | −3.2119780E−19 |

| Sn | 25 | 26 | 31 | 32 |
|---|---|---|---|---|
| KA | 1.0000000E+00 | 1.0000000E+00 | 1.0000000E+00 | 1.00000006+00 |
| A4 | 1.3227825E−05 | 3.3381503E−06 | −1.0880840E−05 | −1.4297941E−05 |
| A6 | −2.5595982E−08 | 1.1006569E−08 | −7.2756389E−09 | 1.8259643E−08 |
| A8 | −2.8268908E−11 | 1.0110493E−11 | 2.7531649E−10 | −1.5107906E−11 |
| A10 | 1.2350869E−13 | 9.3518991E−14 | −2.2049339E−12 | −1.0830622E−13 |
| A12 | −1.2573862E−15 | −9.1719199E−16 | 1.5751150E−15 | −1.3587055E−15 |
| A14 | 3.7196947E−18 | −2.2614855E−18 | 5.6477916E−18 | 1.1538995E−17 |
| A16 | 3.3189021E−21 | 1.6994116E−20 | 1.7909007E−19 | 1.9978787E−20 |

### Example 20

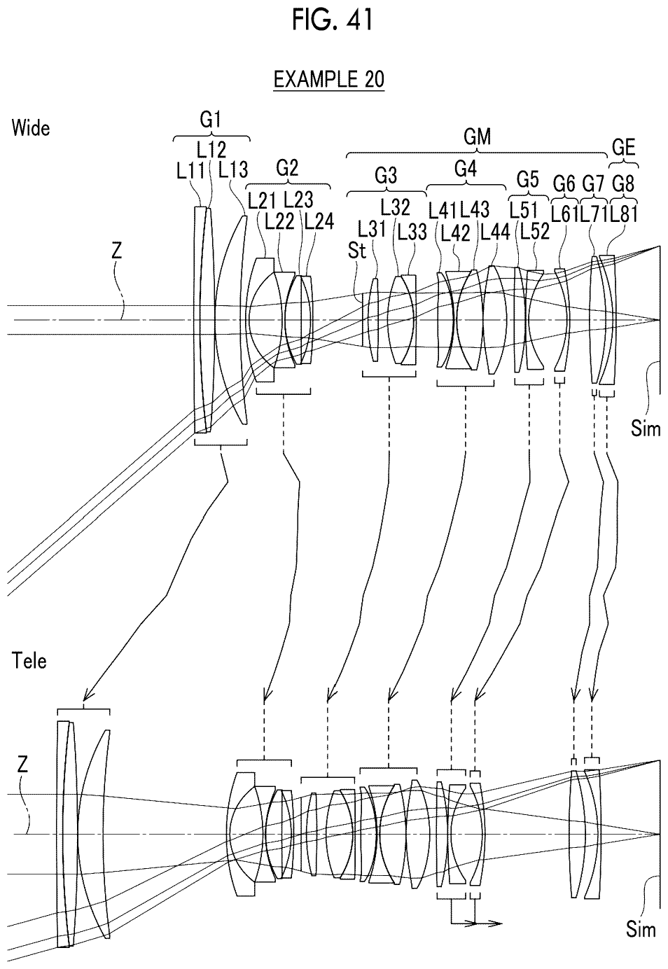

A configuration and a moving path of a variable magnification optical system of Example 20 are illustrated in FIG. 41. The variable magnification optical system of Example 20 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, the sixth lens group G6 having a negative refractive power, the seventh lens group G7 having a positive refractive power, and an eighth lens group G8 having a negative refractive power. The intermediate group GM consists of the third lens group G3, the fourth lens group G4, the fifth lens group G5, the sixth lens group G6, and the seventh lens group G7. The final lens group GE consists of the eighth lens group G8. During changing the magnification from the wide angle end to the telephoto end, all lens groups move along the optical axis Z by changing spacings with respect to adjacent lens groups. During focusing, the fifth lens group G5 and the sixth lens group G6 move by changing a mutual spacing. The object side focus group consists of the fifth lens group G5, and the image side focus group consists of the sixth lens group G6. During focusing from the infinite distance object to the nearest object, the object side focus group and the image side focus group move to the image side.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and three lenses including the lenses L31 to L33. The fourth lens group G4 consists of, in order from the object side to the image side, four lenses including the lenses L41 to L44. The fifth lens group G5 consists of, in order from the object side to the image side, two lenses including the lenses L51 and L52. The sixth lens group G6 consists of one lens that is the lens L61. The seventh lens group G7 consists of one lens that is the lens L71. The eighth lens group G8 consists of one lens that is a lens L81.

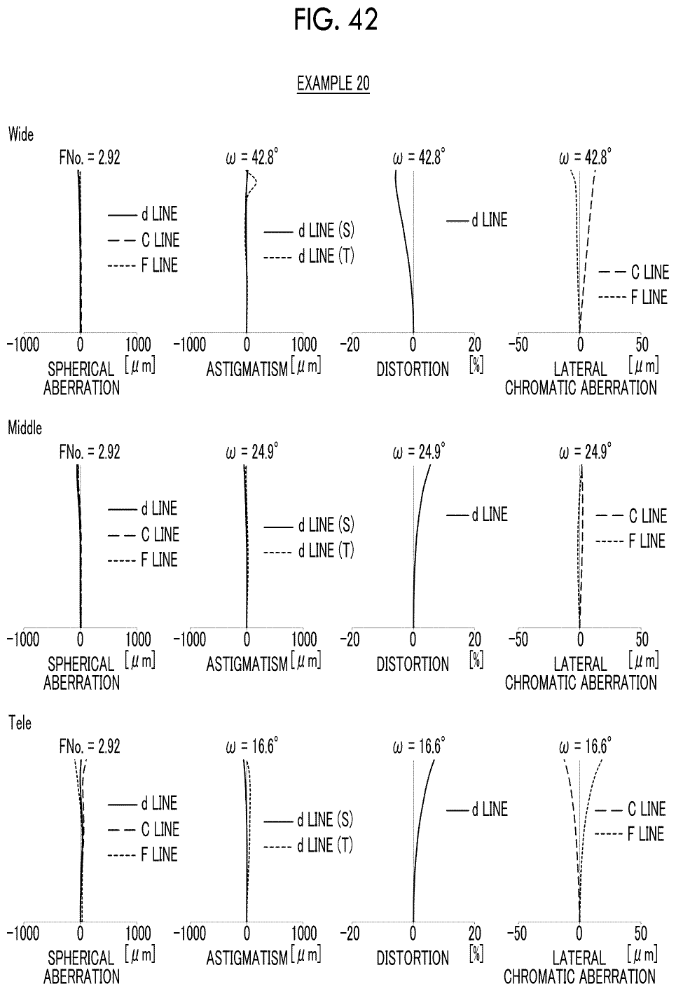

For the variable magnification optical system of Example 20, Table 58 shows basic lens data, Table 59 shows specifications and a variable surface spacing, Table 60 shows aspherical coefficients, and FIG. 42 illustrates each aberration diagram.

TABLE 58
Example 20

| Sn | R | D | Nd | νd | θgF | ED |
|---|---|---|---|---|---|---|
| 1 | 1971.0963 | 1.6629 | 1.88978 | 20.51 | 0.63871 | 66.00 |
| 2 | 297.1158 | 4.0610 | 1.55809 | 72.30 | 0.54084 | 65.23 |
| 3 | −457.6411 | 0.0467 | | | | 64.96 |
| 4 | 64.8671 | 6.9138 | 1.70695 | 57.37 | 0.54236 | 60.81 |
| 5 | 240.4147 | DD[5] | | | | 59.94 |
| *6 | 61.0711 | 0.9292 | 1.83982 | 44.84 | 0.56035 | 36.12 |
| *7 | 17.8076 | 9.0430 | | | | 27.97 |
| 8 | −45.0516 | 0.7244 | 1.50952 | 78.77 | 0.53760 | 27.97 |
| 9 | 32.4162 | 0.0382 | | | | 25.95 |
| 10 | 27.9324 | 4.4308 | 1.82762 | 23.62 | 0.62122 | 25.95 |
| 11 | 1619.9945 | 2.5743 | | | | 25.36 |
| 12 | −31.2793 | 0.6621 | 1.67278 | 59.05 | 0.54250 | 25.53 |
| 13 | −125.0725 | DD[13] | | | | 25.32 |
| 14 (St) | ∞ | 1.4998 | | | | 21.50 |
| 15 | 50.6722 | 2.8040 | 1.86498 | 21.75 | 0.63273 | 23.87 |
| 16 | −321.2992 | 2.5435 | | | | 24.07 |
| 17 | 37.6128 | 7.1399 | 1.44696 | 89.23 | 0.53245 | 25.38 |
| 18 | −25.2925 | 0.6760 | 1.83902 | 28.44 | 0.60550 | 25.31 |
| 19 | −621.6057 | DD[19] | | | | 26.12 |
| *20 | 104.5084 | 4.2547 | 1.76857 | 52.27 | 0.54740 | 27.05 |
| *21 | −36.4890 | 0.2122 | | | | 27.57 |
| 22 | −43.5811 | 0.7327 | 1.82611 | 23.79 | 0.62002 | 27.25 |
| 23 | 27.2672 | 7.1597 | 1.49299 | 82.22 | 0.53711 | 28.38 |
| 24 | −63.0102 | 0.0669 | | | | 29.15 |
| *25 | 59.3955 | 6.4362 | 1.84843 | 40.72 | 0.56967 | 31.00 |
| *26 | −39.6117 | DD[26] | | | | 31.58 |
| 27 | 646.7025 | 3.0745 | 1.94850 | 18.01 | 0.65617 | 30.60 |
| 28 | −67.7458 | 0.0514 | | | | 30.50 |
| 29 | 201.1122 | 0.8469 | 1.76606 | 52.53 | 0.54703 | 28.93 |
| 30 | 24.5615 | DD[30] | | | | 27.01 |
| *31 | −32.5697 | 0.7696 | 1.95146 | 29.66 | 0.59896 | 28.28 |
| *32 | −75.2598 | DD[32] | | | | 29.80 |
| 33 | 241.0478 | 4.4500 | 1.84035 | 25.25 | 0.61673 | 36.77 |
| 34 | −68.2576 | DD[34] | | | | 36.99 |
| 35 | −47.9361 | 0.8752 | 1.63808 | 59.60 | 0.54301 | 36.71 |
| 36 | −346.7592 | DD[36] | | | | 37.70 |

TABLE 59
Example 20

| | Wide | Middle | Tele |
|---|---|---|---|
| Zr | 1.0 | 1.8 | 2.7 |
| f | 24.81 | 44.26 | 68.05 |
| FNo. | 2.92 | 2.92 | 2.92 |
| 2ω [°] | 85.6 | 49.8 | 33.2 |
| DD[5] | 1.49 | 18.39 | 33.72 |
| DD[13] | 13.39 | 4.30 | 2.00 |
| DD[19] | 5.87 | 2.59 | 1.50 |
| DD[26] | 2.05 | 2.97 | 1.83 |
| DD[30] | 10.44 | 10.98 | 8.57 |
| DD[32] | 5.43 | 13.06 | 22.97 |
| DD[34] | 1.92 | 2.28 | 3.43 |
| DD[36] | 12.00 | 12.91 | 16.09 |

TABLE 60
Example 20

| Sn | 6 | 7 | 20 | 21 |
|---|---|---|---|---|
| KA | 1.0000000E+00 | 1.0000000E+00 | 1.0000000E+00 | 1.0000000E+00 |
| A4 | 3.2703591E−06 | 1.8191814E−06 | −1.9565043E−05 | −3.4799368E−06 |
| A6 | −1.7626948E−08 | −2.4494142E−08 | −9.3911741E−09 | −8.1289344E−09 |
| A8 | 1.4496902E−10 | 2.6862343E−10 | −3.7161477E−10 | −5.0253194E−10 |
| A10 | −6.4625710E−13 | −2.3075798E−12 | 3.7589803E−13 | 2.7764950E−12 |
| A12 | 1.2555538E−15 | 2.5282175E−14 | 1.5787924E−14 | −2.9533122E−15 |
| A14 | −6.4106783E−19 | −1.6861789E−16 | −1.5455105E−16 | −6.4994732E−17 |
| A16 | −3.2239883E−22 | 3.9141919E−19 | 3.6457745E−19 | 1.9274572E−19 |
| Sn | 25 | 26 | 31 | 32 |
| KA | 1.0000000E+00 | 1.0000000E+00 | 1.0000000E+00 | 1.0000000E+00 |
| A4 | −3.7755619E−06 | 3.5592025E−06 | −5.5743606E−06 | −2.8947597E−06 |
| A6 | −1.2493772E−08 | −2.3642173E−08 | 1.3140757E−08 | 2.3781365E−08 |
| A8 | −2.4784235E−11 | 1.7617245E−11 | −1.0702543E−11 | 2.1944226E−11 |
| A10 | 1.2773949E−13 | −5.0728626E−14 | −9.4287595E−14 | −2.7385400E−13 |
| A12 | −5.1531669E−16 | −6.4178654E−16 | 1.0004768E−15 | −4.3518164E−18 |
| A14 | 3.5577844E−19 | 2.6228610E−18 | −2.1083659E−18 | 9.0200307E−18 |
| A16 | 6.1077547E−22 | −4.5075558E−21 | 9.6591286E−21 | −2.4414888E−20 |

Tables 61 to 65 show the corresponding values of Conditional Expressions (1) to (40) of the variable magnification optical systems of Examples 1 to 20. A field without a corresponding lens shows “-”. Preferable ranges of the conditional expressions may be set using the corresponding values of the examples shown in Tables 61 to 65 as the upper limits and the lower limits of the conditional expressions.

TABLE 61

| Expression Number | | Example 1 | Example 2 | Example 3 | Example 4 |
|---|---|---|---|---|---|
| (1) | DDL1STw/TLw | 0.441 | 0.461 | 0.465 | 0.475 |
| (2) | Fnot/(ft/fw) | 0.890 | 0.889 | 0.814 | 0.750 |
| (3) | Bfw/(ft × tan ωt) | 1.395 | 1.540 | 1.546 | 1.483 |
| (4) | fw/(ft × tan ωt) | 1.212 | 1.229 | 1.234 | 1.225 |
| (5) | f1/fL1STw | −4.035 | −3.882 | −3.748 | −3.525 |
| (6) | f1/fL1 | 0.492 | −0.534 | −0.522 | −0.529 |
| (7) | fw/fL1STw | −0.739 | −0.736 | −0.740 | −0.732 |
| (8) | TLw/(ft × tan ωt) | 7.865 | 8.886 | 8.810 | 8.742 |
| (9) | β2t/β2w | 1.619 | 1.714 | 1.874 | 2.072 |
| (10) | \|DDG12w − DDG12t\|/TLt | 0.179 | 0.186 | 0.198 | 0.205 |
| (11) | DDL1STw/f1 | 0.524 | 0.632 | 0.656 | 0.704 |
| (12) | DDL1STw/{(fw × tan ωw) × log (ft/fw)} | 5.992 | 6.904 | 6.423 | 6.180 |
| (13) | TLw/fw | 6.490 | 7.232 | 7.141 | 7.134 |
| (14) | TLt/ft | 2.629 | 2.611 | 2.387 | 2.191 |
| (15) | TLt/(ft × tan ωt) | 10.315 | 10.397 | 10.424 | 10.310 |
| (16) | f1/fw | 5.457 | 5.272 | 5.066 | 4.814 |
| (17) | f1/(−f2) | 5.521 | 5.414 | 5.299 | 5.081 |
| (18) | f1/(ft/Fnot) | 4.855 | 4.687 | 4.123 | 3.611 |
| (19) | f1/(fw × ft)^{1/2} | 3.033 | 2.929 | 2.693 | 2.457 |
| (20) | Denw/{(fw × tan ωw) × log (ft/fw)} | 3.151 | 3.274 | 3.094 | 2.968 |
| (21) | Denw/(fw × ft)^{1/2} | 0.836 | 0.878 | 0.851 | 0.831 |
| (22) | d1/(Denw × tan ωw) | 0.065 | 0.061 | 0.060 | 0.059 |
| (23) | fw/Dexw | −0.266 | −0.223 | −0.232 | −0.243 |
| (24) | EDf/EDr | 1.977 | 1.969 | 1.973 | 1.991 |
| (25) | EDf/TLw | 0.473 | 0.419 | 0.425 | 0.425 |
| (26) | ft/fw | 3.237 | 3.240 | 3.539 | 3.839 |
| (27) | NdL1 | 1.884 | 1.923 | 1.923 | 1.923 |
| (28) | νdL1 | 20.81 | 20.88 | 20.88 | 20.88 |
| (29) | NdL1 + 0.01 × νdL1 | 2.092 | 2.132 | 2.132 | 2.132 |
| (30) | NdL2 | 1.487 | 1.593 | 1.593 | 1.593 |
| (31) | νdL2 | 70.44 | 68.63 | 68.63 | 68.63 |
| (32) | NdL2 + 0.01 × νdL2 | 2.192 | 2.279 | 2.279 | 2.279 |
| (33) | \|ffoc/fMt\| | 0.578 | 0.665 | 0.595 | 0.597 |
| (34) | \|(1 − βft²) × βfRt²\| | 3.360 | 2.186 | 2.269 | 2.308 |
| (35) | (1/Rcnf − 1/Rcnr)/(1/Rynf − 1/Rynr) | — | — | — | — |
| (36) | (1/Rcpf − 1/Rcpr)/(1/Rypf − 1/Rypr) | — | — | — | — |
| (37) | (1/Rcsnf − 1/Rcsnr)/(1/Rysnf − 1/Rysnr) | — | — | — | — |
| (38) | (1/Rcipf − 1/Rcipr)/(1/Ryipf − 1/Ryipr) | — | — | — | — |
| (39) | (1/Rcinf − 1/Rcinr)/(1/Ryinf − 1/Ryinr) | — | — | — | — |
| (40) | \|(1/RcEpf − 1/RcEpr)/(1/RyEpf − 1/RyEpr)\| | 1.485 | 1.053 | 1.060 | 1.038 |

TABLE 62

| Expression Number | | Example 5 | Example 6 | Example 7 | Example 8 |
|---|---|---|---|---|---|
| (1) | DDL1STw/TLw | 0.476 | 0.473 | 0.472 | 0.433 |
| (2) | Fnot/(ft/fw) | 0.696 | 0.649 | 0.607 | 0.890 |
| (3) | Bfw/(ft × tan ωt) | 1.456 | 1.440 | 1.452 | 1.018 |
| (4) | fw/(ft × tan ωt) | 1.231 | 1.227 | 1.209 | 1.287 |
| (5) | f1/fL1STw | −3.454 | −3.396 | 3.342 | −5.126 |
| (6) | f1/fL1 | −0.535 | −0.546 | −0.543 | −0.267 |
| (7) | fw/fL1STw | −0.726 | −0.723 | −0.719 | −0.869 |
| (8) | TLw/(ft × tan ωt) | 8.784 | 8.775 | 8.626 | 7.287 |
| (9) | β2t/β2w | 2.248 | 2.440 | 2.640 | 1.775 |
| (10) | \|DDG12w − DDG12t\|/TLt | 0.215 | 0.224 | 0.231 | 0.248 |
| (11) | DDL1STw/f1 | 0.713 | 0.720 | 0.725 | 0.416 |
| (12) | DDL1STw/{(fw × tan ωw) × log (ft/fw)} | 5.880 | 5.562 | 5.195 | 5.122 |
| (13) | TLw/fw | 7.134 | 7.152 | 7.138 | 5.663 |
| (14) | TLt/ft | 2.045 | 1.922 | 1.811 | 2.432 |
| (15) | TLt/(ft × tan ωt) | 10.425 | 10.470 | 10.378 | 10.129 |
| (16) | f1/fw | 4.758 | 4.695 | 4.645 | 5.897 |
| (17) | f1/(−f2) | 5.005 | 4.930 | 4.867 | 6.758 |
| (18) | f1/(ft/Fnot) | 3.310 | 3.045 | 2.822 | 5.246 |
| (19) | f1/(fw × ft)^{1/2} | 2.338 | 2.228 | 2.133 | 3.278 |
| (20) | Denw/{(fw × tan ωw) × log (ft/fw)} | 2.832 | 2.677 | 2.505 | 2.956 |
| (21) | Denw/(fw × ft)^{1/2} | 0.804 | 0.772 | 0.746 | 0.787 |
| (22) | d1/(Denw × tan ωw) | 0.059 | 0.060 | 0.058 | 0.058 |
| (23) | fw/Dexw | −0.250 | −0.252 | −0.253 | −0.329 |
| (24) | EDf/EDr | 1.990 | 1.990 | 1.969 | 2.075 |
| (25) | EDf/TLw | 0.425 | 0.424 | 0.425 | 0.544 |
| (26) | ft/fw | 4.139 | 4.440 | 4.741 | 3.237 |
| (27) | NdL1 | 1.923 | 1.923 | 1.923 | 1.917 |
| (28) | νdL1 | 20.88 | 20.88 | 20.88 | 19.15 |
| (29) | NdL1 + 0.01 × νdL1 | 2.132 | 2.132 | 2.132 | 2.109 |
| (30) | NdL2 | 1.593 | 1.593 | 1.593 | 1.487 |
| (31) | νdL2 | 68.63 | 68.63 | 68.63 | 70.44 |
| (32) | NdL2 + 0.01 × νdL2 | 2.279 | 2.279 | 2.279 | 2.192 |
| (33) | \|ffoc/fMt\| | 0.541 | 0.523 | 0.503 | 0.876 |
| (34) | \|(1 − βft²) × βfRt²\| | 2.339 | 2.299 | 2.331 | 3.469 |
| (35) | (1/Rcnf − 1/Rcnr)/(1/Rynf − 1/Rynr) | — | — | — | — |
| (36) | (1/Rcpf − 1/Rcpr)/(1/Rypf − 1/Rypr) | — | — | — | — |
| (37) | (1/Rcsnf − 1/Rcsnr)/(1/Rysnf − 1/Rysnr) | — | — | — | — |
| (38) | (1/Rcipf − 1/Rcipr)/(1/Ryipf − 1/Ryipr) | — | — | — | — |
| (39) | (1/Rcinf − 1/Rcinr)/(1/Ryinf − 1/Ryinr) | — | — | — | — |
| (40) | \|(1/RcEpf − 1/RcEpr)/(1/RyEpf − 1/RyEpr)\| | 1.037 | 1.053 | 1.076 | 3.594 |

TABLE 63

| Expression Number | | Example 9 | Example 10 | Example 11 | Example 12 |
|---|---|---|---|---|---|
| (1) | DDL1STw/TLw | 0.499 | 0.461 | 0.365 | 0.363 |
| (2) | Fnot/(ft/fw) | 0.890 | 1.061 | 1.168 | 1.064 |
| (3) | Bfw/(ft × tan ωt) | 1.181 | 0.587 | 0.577 | 0.492 |
| (4) | fw/(ft × tan ωt) | 1.258 | 1.207 | 1.284 | 1.177 |
| (5) | f1/fL1STw | −3.330 | −3.079 | −3.991 | −5.084 |
| (6) | f1/fL1 | −0.360 | −0.563 | −0.212 | 0.477 |
| (7) | fw/fL1STw | −0.636 | −0.605 | −0.932 | −0.970 |
| (8) | TLw/(ft × tan ωt) | 7.513 | 6.260 | 6.166 | 5.902 |
| (9) | β2t/β2w | 1.956 | 1.666 | 1.470 | 1.406 |
| (10) | \|DDG12w − DDG12t\|/TLt | 0.242 | 0.225 | 0.165 | 0.169 |
| (11) | DDL1STw/f1 | 0.569 | 0.470 | 0.409 | 0.347 |
| (12) | DDL1STw/{(fw × tan ωw) × log (ft/fw)} | 6.310 | 5.934 | 5.458 | 4.435 |
| (13) | TLw/fw | 5.974 | 5.185 | 4.801 | 5.013 |
| (14) | TLt/ft | 2.279 | 2.353 | 2.424 | 2.374 |
| (15) | TLt/(ft × tan ωt) | 9.279 | 7.795 | 7.783 | 7.671 |
| (16) | f1/fw | 5.236 | 5.092 | 4.281 | 5.243 |
| (17) | f1/(−f2) | 4.779 | 4.313 | 5.471 | 6.989 |
| (18) | f1/(ft/Fnot) | 4.658 | 5.402 | 5.001 | 5.580 |
| (19) | f1/(fw × ft)^{1/2} | 2.910 | 3.075 | 2.708 | 3.165 |
| (20) | Denw/{(fw × tan ωw) × log (ft/fw)} | 3.365 | 3.163 | 3.323 | 3.049 |
| (21) | Denw/(fw × ft)^{1/2} | 0.884 | 0.770 | 0.675 | 0.755 |
| (22) | d1/(Denw × tan ωw) | 0.052 | 0.059 | 0.068 | 0.069 |
| (23) | fw/Dexw | −0.315 | −0.596 | −0.443 | −0.473 |
| (24) | EDf/EDr | 1.971 | 2.160 | 1.663 | 2.061 |
| (25) | EDf/TLw | 0.510 | 0.531 | 0.484 | 0.519 |
| (26) | ft/fw | 3.237 | 2.743 | 2.500 | 2.744 |
| (27) | NdL1 | 1.923 | 1.900 | 1.934 | 1.918 |
| (28) | νdL1 | 20.88 | 20.00 | 18.30 | 19.12 |
| (29) | NdL1 + 0.01 × νdL1 | 2.132 | 2.100 | 2.117 | 2.109 |
| (30) | NdL2 | 1.593 | 1.739 | 1.436 | 1.777 |
| (31) | νdL2 | 68.63 | 55.28 | 90.84 | 51.36 |
| (32) | NdL2 + 0.01 × νdL2 | 2.279 | 2.292 | 2.344 | 2.291 |
| (33) | \|ffoc/fMt\| | 0.730 | 1.006 | 1.062 | 1.865 |
| (34) | \|(1 − βft²) × βfRt²\| | 2.043 | 4.341 | 3.674 | 3.299 |
| (35) | (1/Rcnf − 1/Rcnr)/(1/Rynf − 1/Rynr) | — | — | — | — |
| (36) | (1/Rcpf − 1/Rcpr)/(1/Rypf − 1/Rypr) | — | — | — | — |
| (37) | (1/Rcsnf − 1/Rcsnr)/(1/Rysnf − 1/Rysnr) | 1.000 | 0.960 | 1.029 | — |
| (38) | (1/Rcipf − 1/Rcipr)/(1/Ryipf − 1/Ryipr) | — | — | — | 18.414 |
| (39) | (1/Rcinf − 1/Rcinr)/(1/Ryinf − 1/Ryinr) | — | — | — | — |
| (40) | \|(1/RcEpf − 1/RcEpr)/(1/RyEpf − 1/RyEpr)\| | — | — | — | — |

TABLE 64

| Expression Number | | Example 13 | Example 14 | Example 15 | Example 16 |
|---|---|---|---|---|---|
| (1) | DDL1STw/TLw | 0.362 | 0.373 | 0.400 | 0.398 |
| (2) | Fnot/(ft/fw) | 1.065 | 1.064 | 1.050 | 1.090 |
| (3) | Bfw/(ft × tan ωt) | 0.489 | 0.443 | 0.497 | 0.653 |
| (4) | fw/(ft × tan ωt) | 1.179 | 1.149 | 1.193 | 1.178 |
| (5) | f1/fL1STw | −5.974 | −6.018 | −4.595 | −4.682 |
| (6) | f1/fL1 | −0.416 | −0.440 | −0.530 | −0.431 |
| (7) | fw/fL1STw | −1.188 | −1.104 | −0.895 | −0.839 |
| (8) | TLw/(ft × tan ωt) | 5.581 | 5.296 | 6.040 | 6.212 |
| (9) | β2t/β2w | 1.333 | 1.309 | 1.413 | 1.399 |
| (10) | \|DDG12w − DDG12t\|/TLt | 0.152 | 0.163 | 0.168 | 0.176 |
| (11) | DDL1STw/f1 | 0.341 | 0.315 | 0.394 | 0.376 |
| (12) | DDL1STw/{(fw × tan ωw) × log (ft/fw)} | 4.188 | 4.086 | 4.919 | 5.154 |
| (13) | TLw/fw | 4.736 | 4.609 | 5.064 | 5.275 |
| (14) | TLt/ft | 2.246 | 2.185 | 2.375 | 2.478 |
| (15) | TLt/(ft × tan ωt) | 7.256 | 6.888 | 7.768 | 8.007 |
| (16) | f1/fw | 5.028 | 5.453 | 5.134 | 5.582 |
| (17) | f1/(−f2) | 7.995 | 7.947 | 6.296 | 6.234 |
| (18) | f1/(ft/Fnot) | 5.357 | 5.804 | 5.392 | 6.085 |
| (19) | f1/(fw × ft)^{1/2} | 3.037 | 3.292 | 3.100 | 3.371 |
| (20) | Denw/{(fw × tan ωw) × log (ft/fw)} | 2.990 | 2.905 | 3.173 | 3.122 |
| (21) | Denw/(fw × ft)^{1/2} | 0.740 | 0.737 | 0.788 | 0.768 |
| (22) | d1/(Denw × tan ωw) | 0.071 | 0.072 | 0.052 | 0.058 |
| (23) | fw/Dexw | 0.499 | −0.560 | −0.533 | −0.330 |
| (24) | EDf/EDr | 2.089 | 2.105 | 1.900 | 1.917 |
| (25) | EDf/TLw | 0.549 | 0.584 | 0.504 | 0.520 |
| (26) | ft/fw | 2.741 | 2.743 | 2.742 | 2.743 |
| (27) | NdL1 | 1.822 | 1.846 | 1.806 | 2.001 |
| (28) | νdL1 | 23.92 | 22.69 | 33.34 | 25.46 |
| (29) | NdL1 + 0.01 × νdL1 | 2.061 | 2.073 | 2.140 | 2.255 |
| (30) | NdL2 | 1.487 | 1.487 | 1.487 | 1.774 |
| (31) | νdL2 | 70.32 | 70.32 | 70.32 | 51.71 |
| (32) | NdL2 + 0.01 × νdL2 | 2.191 | 2.191 | 2.191 | 2.291 |
| (33) | \|ffoc/fMt\| | 1.404 | 1.395 | 1.190 | 0.789 |
| (34) | \|(1 − βft²) × βfRt²\| | 6.287 | 6.334 | 1.948 | 6.268 |
| (35) | (1/Rcnf − 1/Rcnr)/(1/Rynf − 1/Rynr) | — | — | — | 0.959 |
| (36) | (1/Rcpf − 1/Rcpr)/(1/Rypf − 1/Rypr) | — | — | −37.927 | — |
| (37) | (1/Rcsnf − 1/Rcsnr)/(1/Rysnf − 1/Rysnr) | — | — | — | — |
| (38) | (1/Rcipf − 1/Rcipr)/(1/Ryipf − 1/Ryipr) | 4.044 | 3.739 | — | — |
| (39) | (1/Rcinf − 1/Rcinr)/(1/Ryinf − 1/Ryinr) | — | — | — | — |
| (40) | \|(1/RcEpf − 1/RcEpr)/(1/RyEpf − 1/RyEpr) | — | — | — | — |

TABLE 65

| Expression Number | | Example 17 | Example 18 | Example 19 | Example 20 |
|---|---|---|---|---|---|
| (1) | DDL1STw/TLw | 0.381 | 0.365 | 0.417 | 0.361 |
| (2) | Fnot/(ft/fw) | 1.054 | 1.050 | 1.202 | 1.064 |
| (3) | Bfw/(ft × tan ωt) | 0.710 | 0.581 | 0.820 | 0.591 |
| (4) | fw/(ft × tan ωt) | 1.109 | 1.200 | 1.222 | 1.223 |
| (5) | f1/fL1STw | −3.749 | −4.572 | −4.140 | −4.583 |
| (6) | f1/fL1 | −0.095 | 0.269 | −0.579 | −0.293 |
| (7) | fw/fL1STw | −0.893 | −0.964 | −1.024 | −0.985 |
| (8) | TLw/(ft × tan ωt) | 5.748 | 6.181 | 6.183 | 6.274 |
| (9) | β2t/β2w | 1.547 | 1.628 | 1.477 | 1.604 |
| (10) | \|DDG12w − DDG12t\|/TLt | 0.159 | 0.199 | 0.136 | 0.196 |
| (11) | DDL1STw/f1 | 0.471 | 0.396 | 0.521 | 0.398 |
| (12) | DDL1STw/{(fw × tan ωw) × log (ft/fw)} | 4.804 | 4.516 | 5.415 | 4.566 |
| (13) | TLw/fw | 5.184 | 5.153 | 5.059 | 5.131 |
| (14) | TLt/ft | 2.344 | 2.489 | 2.403 | 2.421 |
| (15) | TLt/(ft × tan ωt) | 7.128 | 8.193 | 8.060 | 8.122 |
| (16) | f1/fw | 4.198 | 4.743 | 4.043 | 4.654 |
| (17) | f1/(−f2) | 5.438 | 6.149 | 6.038 | 6.183 |
| (18) | f1/(ft/Fnot) | 4.423 | 4.978 | 4.861 | 4.954 |
| (19) | f1/(fw × ft)^{1/2} | 2.535 | 2.863 | 2.440 | 2.810 |
| (20) | Denw/{(fw × tan ωw) × log (ft/fw)} | 3.182 | 2.768 | 3.335 | 2.840 |
| (21) | Denw/(fw × ft)^{1/2} | 0.791 | 0.695 | 0.784 | 0.696 |
| (22) | d1/(Denw × tan ωw) | 0.054 | 0.062 | 0.060 | 0.063 |
| (23) | fw/Dexw | −0.289 | 0.281 | −0.411 | −0.363 |
| (24) | EDf/EDr | 1.730 | 1.755 | 1.761 | 1.751 |
| (25) | EDf/TLw | 0.508 | 0.518 | 0.484 | 0.519 |
| (26) | ft/fw | 2.743 | 2.744 | 2.744 | 2.743 |
| (27) | NdL1 | 1.806 | 1.899 | 1.891 | 1.890 |
| (28) | νdL1 | 33.34 | 20.03 | 20.44 | 20.51 |
| (29) | NdL1 + 0.01 × νdL1 | 2.140 | 2.100 | 2.096 | 2.095 |
| (30) | NdL2 | 1.487 | 1.550 | 1.699 | 1.558 |
| (31) | νdL2 | 70.32 | 73.59 | 42.76 | 72.39 |
| (32) | NdL2 + 0.01 × νdL2 | 2.191 | 2.286 | 2.127 | 2.282 |
| (33) | \|ffoc/fMt\| | 1.034 | 2.193 | 1.989 | 1.381 |
| (34) | \|(1 − βft²) × βfRt²\| | 4.069 | 1.725 | 2.428 | 0.700 |
| (35) | (1/Rcnf − 1/Rcnr)/(1/Rynf − 1/Rynr) | 0.455 | — | — | — |
| (36) | (1/Rcpf − 1/Rcpr)/(1/Rypf − 1/Rypr) | — | — | — | — |
| (37) | (1/Rcsnf − 1/Rcsnr)/(1/Rysnf − 1/Rysnr) | — | — | — | — |
| (38) | (1/Rcipf − 1/Rcipr)/(1/Ryipf − 1/Ryipr) | — | — | — | — |
| (39) | (1/Rcinf − 1/Rcinr)/(1/Ryinf − 1/Ryinr) | — | 0.836 | 1.071 | 0.815 |
| (40) | \|(1/RcEpf − 1/RcEpr)/(1/RyEpf − 1/RyEpr)\| | — | — | — | — |

The variable magnification optical systems of Examples 1 to 20 have an F-number less than or equal to 3.3 in the entire magnification range and implement a small F-number while being configured to be reduced in size. Particularly, in a part of the examples, the F-number is less than or equal to 3 in the entire magnification range. The variable magnification optical systems of Examples 1 to 20 maintain high optical performance by favorably correcting various aberrations in the entire magnification range.

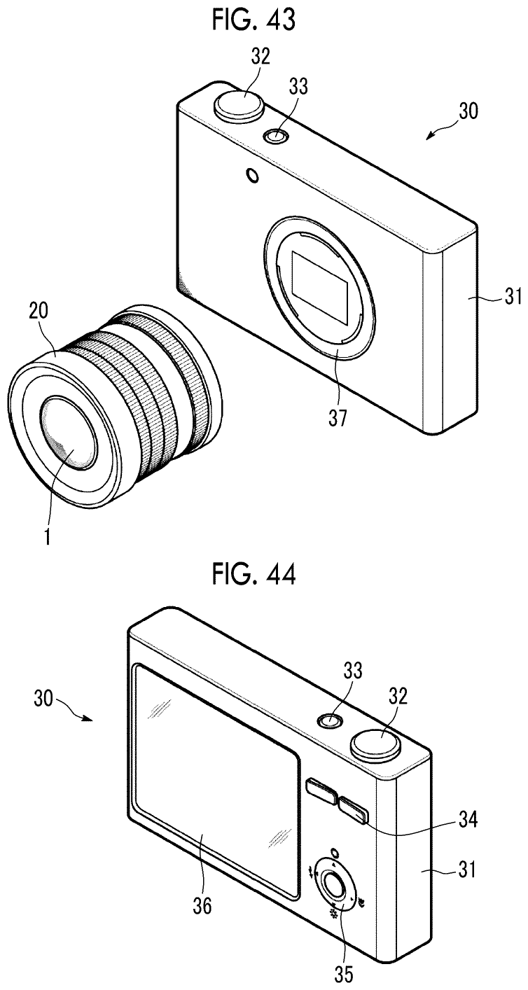

Next, an imaging apparatus according to the embodiment of the present disclosure will be described. FIGS. 43 and 44 illustrate external views of a camera 30 that is the imaging apparatus according to one embodiment of the present disclosure. FIG. 43 illustrates a perspective view of the camera 30 seen from a front surface side, and FIG. 44 illustrates a perspective view of the camera 30 seen from a rear surface side. The camera 30 is a so-called mirrorless type digital camera on which an interchangeable lens 20 can be attachably and detachably mounted. The interchangeable lens 20 is configured to include a variable magnification optical system 1 according to one embodiment of the present disclosure accommodated in a lens barrel.

The camera 30 comprises a camera body 31, and a shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before capturing.

An imaging opening on which light from an imaging target is incident is provided in a center portion of a front surface of the camera body 31, and a mount 37 is provided at a position corresponding to the imaging opening. The interchangeable lens 20 is mounted on the camera body 31 through the mount 37.

An imaging element such as a charge coupled device (CCD) or a complementary metal oxide semiconductor (CMOS) that outputs an imaging signal corresponding to a subject image formed by the interchangeable lens 20, a signal processing circuit that processes the imaging signal output from the imaging element to generate an image, a recording medium for recording the generated image, and the like are provided in the camera body 31. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples and can be subjected to various modifications. For example, the curvature radius, the surface spacing, the refractive index, the Abbe number, and the aspherical coefficient of each lens are not limited to the values shown in each example and may have other values.

The imaging apparatus according to the embodiment of the present disclosure is also not limited to the examples and can have various aspects of, for example, a camera of a type other than a mirrorless type, a film camera, a video camera, and a security camera.

The following appendices are further disclosed with respect to the embodiment and the examples described above.

### APPENDIX 1

A variable magnification optical system consisting of, in order from an object side to an image side, a first lens group having a positive refractive power, a second lens group having a negative refractive power, an intermediate group, and a final lens group having a refractive power, in which the intermediate group consists of one or more and five or fewer lens groups, during changing magnification, a spacing between the first lens group and the second lens group changes, a spacing between the second lens group and the intermediate group changes, and a spacing between the intermediate group and the final lens group changes, in a case where the intermediate group consists of a plurality of lens groups, all spacings between adjacent lens groups in the intermediate group change during changing the magnification, an aperture stop is disposed between a lens surface of the second lens group closest to the image side and a lens surface of the final lens group closest to the object side, the first lens group includes, in consecutive order from a position closest to the object side to the image side, a first lens that is a negative lens, and a second lens that is a positive lens, and in a case where a distance on an optical axis from a surface of the first lens on the object side to the aperture stop in a state where an infinite distance object is in focus at a wide angle end is denoted by DDL1STw, a sum of a distance on the optical axis from the surface of the first lens on the object side to a lens surface of the final lens group closest to the image side and a back focus of the entire system as an air conversion distance in the state where the infinite distance object is in focus at the wide angle end is denoted by TLw, an open F-number in a state where the infinite distance object is in focus at a telephoto end is denoted by Fnot, a focal length of the entire system in the state where the infinite distance object is in focus at the telephoto end is denoted by ft, a focal length of the entire system in the state where the infinite distance object is in focus at the wide angle end is denoted by fw, the back focus of the entire system as the air conversion distance at the wide angle end is denoted by Bfw, and a maximum half angle of view in the state where the infinite distance object is in focus at the telephoto end is denoted by ot, Conditional Expressions (1), (2), and (3) are satisfied, which are represented by

$$0 < DDL 1 STw / TLw < 0.5 \qquad ( 1 )$$

$$0.5 < Fnot / ( ft / fw ) < 1.3 , and \qquad ( 2 )$$

$$0.15 < Bfw / ( ft \times tan ω t ) < 2. \qquad ( 3 )$$

### APPENDIX 2

The variable magnification optical system according to Appendix 1, in which Conditional Expression (4) is satisfied, which is represented by

$$1 < fw / ( ft \times tan ω t ) < 1.4 . \qquad ( 4 )$$

### APPENDIX 3

The variable magnification optical system according to Appendix 1 or 2, in which, in a case where a focal length of the first lens group is denoted by f1, and a combined focal length of an optical system from the first lens to the aperture stop in the state where the infinite distance object is in focus at the wide angle end is denoted by fL1STw, Conditional Expression (5) is satisfied, which is represented by

$$- 6.6 < f 1 / fL 1 STw < - 1.5 . \qquad ( 5 )$$

### APPENDIX 4

The variable magnification optical system according to any one of Appendices 1 to 3, in which, in a case where a focal length of the first lens group is denoted by f1, and a focal length of the first lens is denoted by fL1, Conditional Expression (6) is satisfied, which is represented by

$$- 0.9 < f 1 / fL 1 < - 0.05 . \qquad ( 6 )$$

### APPENDIX 5

The variable magnification optical system according to any one of Appendices 1 to 4, in which, in a case where a combined focal length of an optical system from the first lens to the aperture stop in the state where the infinite distance object is in focus at the wide angle end is denoted by fL1STw, Conditional Expression (7) is satisfied, which is represented by

$$- 1.4 < fw / fL 1 STw < - 0.3 . \qquad ( 7 )$$

### APPENDIX 6

The variable magnification optical system according to Appendix 1, in which, in a case where a combined focal length of an optical system from the first lens to the aperture stop in the state where the infinite distance object is in focus at the wide angle end is denoted by fL1STw, a focal length of the first lens group is denoted by f1, and a focal length of the first lens is denoted by fL1, Conditional Expressions (4), (5), (6), and (7) are satisfied, which are represented by

$$1 < fw / ( ft \times tan ω t ) < 1.4 , \qquad ( 4 )$$

$$- 6.6 < f 1 / fL 1 STw < - 1.5 , \qquad ( 5 )$$

$$- 0.9 < f 1 / fL 1 < - 0.05 , and \qquad ( 6 )$$

$$- 1.4 < fw / fL 1 STw < - 0.3 . \qquad ( 7 )$$

### APPENDIX 7

The variable magnification optical system according to any one of Appendices 1 to 6, in which Conditional Expression (8) is satisfied, which is represented by

$$2 < TLw / ( ft \times tan ω t ) < 9. \qquad ( 8 )$$

### APPENDIX 8

The variable magnification optical system according to any one of Appendices 1 to 7, in which, in a case where a lateral magnification of the second lens group in the state where the infinite distance object is in focus at the telephoto end is denoted by β2t, and a lateral magnification of the second lens group in the state where the infinite distance object is in focus at the wide angle end is denoted by β2w, Conditional Expression (9) is satisfied, which is represented by

$$1.1 < β 2 t / β 2 w < 3. \qquad ( 9 )$$

### APPENDIX 9

The variable magnification optical system according to any one of Appendices 1 to 8, in which, in a case where a spacing on the optical axis between the first lens group and the second lens group in the state where the infinite distance object is in focus at the wide angle end is denoted by DDG12w, a spacing on the optical axis between the first lens group and the second lens group in the state where the infinite distance object is in focus at the telephoto end is denoted by DDG12t, and a sum of the distance on the optical axis from the surface of the first lens on the object side to the lens surface of the final lens group closest to the image side and the back focus of the entire system as the air conversion distance in the state where the infinite distance object is in focus at the telephoto end is denoted by TLt, Conditional Expression (10) is satisfied, which is represented by

$$0.1 < \vert DDG 12 w - DDG 12 t \vert / TLt < 0.3 . \qquad ( 10 )$$

### APPENDIX 10

The variable magnification optical system according to any one of Appendices 1 to 9, in which, in a case where a focal length of the first lens group is denoted by f1, Conditional Expression (11) is satisfied, which is represented by

$$0.2 < DDL 1 STw / f 1 < 0.8 . \qquad ( 11 )$$

### APPENDIX 11

The variable magnification optical system according to any one of Appendices 1 to 10, in which, in a case where a maximum half angle of view in the state where the infinite distance object is in focus at the wide angle end is denoted by ow, Conditional Expression (12) is satisfied, which is represented by

$$3 < DDL 1 STw / \{ ( fw \times tan ω w ) \times log ( ft / fw ) \} < 9. \qquad ( 12 )$$

### APPENDIX 12

The variable magnification optical system according to any one of Appendices 1 to 11, in which Conditional Expression (13) is satisfied, which is represented by

$$3 < TLw / fw < 8. \qquad ( 13 )$$

### APPENDIX 13

The variable magnification optical system according to any one of Appendices 1 to 12, in which, in a case where a sum of the distance on the optical axis from the surface of the first lens on the object side to the lens surface of the final lens group closest to the image side and the back focus of the entire system as the air conversion distance in the state where the infinite distance object is in focus at the telephoto end is denoted by TLt, Conditional Expression (14) is satisfied, which is represented by

$$1.5 < TLt / ft < 3. \qquad ( 14 )$$

### APPENDIX 14

The variable magnification optical system according to any one of Appendices 1 to 13, in which, in a case where a sum of the distance on the optical axis from the surface of the first lens on the object side to the lens surface of the final lens group closest to the image side and the back focus of the entire system as the air conversion distance in the state where the infinite distance object is in focus at the telephoto end is denoted by TLt, Conditional Expression (15) is satisfied, which is represented by

$$5 < TLt / ( ft \times tan ω t ) < 11. \qquad ( 15 )$$

### APPENDIX 15

The variable magnification optical system according to any one of Appendices 1 to 14, in which, in a case where a focal length of the first lens group is denoted by f1, Conditional Expression (16) is satisfied, which is represented by

$$3 < f 1 / fw < 7. \qquad ( 16 )$$

### APPENDIX 16

The variable magnification optical system according to any one of Appendices 1 to 15, in which, in a case where a focal length of the first lens group is denoted by f1, and a focal length of the second lens group is denoted by f2, Conditional Expression (17) is satisfied, which is represented by

$$3 < f 1 / ( - f 2 ) < 9. \qquad ( 17 )$$

### APPENDIX 17

The variable magnification optical system according to any one of Appendices 1 to 16, in which, in a case where a focal length of the first lens group is denoted by f1, Conditional Expression (18) is satisfied, which is represented by

$$2 < f 1 / ( ft / Fnot ) < 7. \qquad ( 18 )$$

### APPENDIX 18

The variable magnification optical system according to any one of Appendices 1 to 17, in which, in a case where a focal length of the first lens group is denoted by f1, Conditional Expression (19) is satisfied, which is represented by

$$1.8 < f 1 / {( fw \times ft )}^{1 / 2} < 4.2 . \qquad ( 19 )$$

### APPENDIX 19

The variable magnification optical system according to any one of Appendices 1 to 18, in which, in a case where a distance on the optical axis from the surface of the first lens on the object side to a paraxial entrance pupil position in the state where the infinite distance object is in focus at the wide angle end is denoted by Denw, and a maximum half angle of view in the state where the infinite distance object is in focus at the wide angle end is denoted by ow, Conditional Expression (20) is satisfied, which is represented by

$$2 < Denw / \{ ( fw \times tan ω w ) \times log ( ft / fw ) \} < 4.5 . \qquad ( 20 )$$

### APPENDIX 20

The variable magnification optical system according to any one of Appendices 1 to 19, in which, in a case where a distance on the optical axis from the surface of the first lens on the object side to a paraxial entrance pupil position in the state where the infinite distance object is in focus at the wide angle end is denoted by Denw, Conditional Expression (21) is satisfied, which is represented by

$$0.5 < Denw / {( fw \times ft )}^{1 / 2} < 1. \qquad ( 21 )$$

### APPENDIX 21

The variable magnification optical system according to any one of Appendices 1 to 20, in which, in a case where a center thickness of the first lens is denoted by dl, a distance on the optical axis from the lens surface of the first lens group closest to the object side to a paraxial entrance pupil position in the state where the infinite distance object is in focus at the wide angle end is denoted by Denw, and a maximum half angle of view in the state where the infinite distance object is in focus at the wide angle end is denoted by ow, Conditional Expression (22) is satisfied, which is represented by

$$0.04 < d 1 / ( Denw \times tan ω w ) < 0.09 . \qquad ( 22 )$$

### APPENDIX 22

The variable magnification optical system according to any one of Appendices 1 to 21, in which, in a case where a distance on the optical axis from an image plane to a paraxial exit pupil position in the state where the infinite distance object is in focus at the wide angle end is denoted by Dexw, a sign of Dexw is positive for the distance on the image side and is negative for the distance on the object side with reference to the image plane, and in a case where an optical member not having a refractive power is disposed between the image plane and the paraxial exit pupil position, and Dexw is calculated using the air conversion distance for the optical member, Conditional Expression (23) is satisfied, which is represented by

$$- 0.65 < fw / Dexw < - 0.2 . \qquad ( 23 )$$

### APPENDIX 23

The variable magnification optical system according to any one of Appendices 1 to 22, in which, in a case where an effective diameter of the surface of the first lens on the object side is denoted by EDf, and an effective diameter of the lens surface of the final lens group closest to the image side is denoted by EDr, Conditional Expression (24) is satisfied, which is represented by

$$1.5 < EDf / EDr < 3. \qquad ( 24 )$$

### APPENDIX 24

The variable magnification optical system according to any one of Appendices 1 to 23, in which, in a case where an effective diameter of the surface of the first lens on the object side is denoted by EDf, Conditional Expression (25) is satisfied, which is represented by

$$0.35 < EDf / TLw < 0.65 . \qquad ( 25 )$$

### APPENDIX 25

The variable magnification optical system according to any one of Appendices 1 to 24, in which Conditional Expression (26) is satisfied, which is represented by

$$2.2 < ft / fw < 4.8 . \qquad ( 26 )$$

### APPENDIX 26

The variable magnification optical system according to any one of Appendices 1 to 25, in which, in a case where a refractive index with respect to a d line for the first lens is denoted by NdL1, and an Abbe number based on the d line for the first lens is denoted by νdL1, Conditional Expressions (27), (28), and (29) are satisfied, which are represented by

$$1.8 < NdL 1 < 2.01 , \qquad ( 27 )$$

$$15 < vdL 1 < 45 , and \qquad ( 28 )$$

$$2 < NdL 1 + 0.01 \times vdL 1 < 2.5 . \qquad ( 29 )$$

### APPENDIX 27

The variable magnification optical system according to any one of Appendices 1 to 26, in which, in a case where a refractive index with respect to a d line for the second lens is denoted by NdL2, and an Abbe number based on the d line for the second lens is denoted by νdL2, Conditional Expressions (30), (31), and (32) are satisfied, which are represented by

$$1.43 < NdL 2 < 1.81 , \qquad ( 30 )$$

$$45 < vdL 2 < 96 , and \qquad ( 31 )$$

$$2 < NdL 2 + 0.01 \times vdL 2 < 2.5 . \qquad ( 32 )$$

### APPENDIX 28

The variable magnification optical system according to any one of Appendices 1 to 27, in which the variable magnification optical system includes at least one focus group that moves during changing the magnification and during focusing, and in a case where a focal length of a focus group having a smallest absolute value of a focal length among the focus groups included in the variable magnification optical system is denoted by ffoc, and a focal length of the intermediate group in the state where the infinite distance object is in focus at the telephoto end is denoted by fMt, Conditional Expression (33) is satisfied, which is represented by

$$0.3 < \vert ffoc / fMt \vert < 4. \qquad ( 33 )$$

### APPENDIX 29

The variable magnification optical system according to any one of Appendices 1 to 28, in which the variable magnification optical system includes at least one focus group that moves during changing the magnification and during focusing, and in a case where a lateral magnification of a focus group having a largest absolute value of a focal length among the focus groups included in the variable magnification optical system in the state where the infinite distance object is in focus at the telephoto end is denoted by βft, and a combined lateral magnification of all lenses on the image side with respect to the focus group having the largest absolute value of the focal length in the state where the infinite distance object is in focus at the telephoto end is denoted by βfRt, Conditional Expression (34) is satisfied, which is represented by

$$1 < \vert ( 1 - β {ft}^{2} ) \times β {fRt}^{2} \vert < 8. \qquad ( 34 )$$

### APPENDIX 30

The variable magnification optical system according to any one of Appendices 1 to 29, in which one lens group among the lens groups included in the intermediate group is a focus group that moves during changing the magnification and during focusing.

### APPENDIX 31

The variable magnification optical system according to Appendix 30, in which the focus group consists of one positive lens and two negative lenses.

### APPENDIX 32

The variable magnification optical system according to Appendix 31, in which a negative lens closest to the image side in the focus group is an aspherical lens, and in a case where a paraxial curvature radius of a surface of the aspherical lens on the object side is denoted by Rcnf, a paraxial curvature radius of a surface of the aspherical lens on the image side is denoted by Rcnr, a curvature radius of the surface of the aspherical lens on the object side at a position of a maximum effective diameter is denoted by Rynf, and a curvature radius of the surface of the aspherical lens on the image side at a position of a maximum effective diameter is denoted by Rynr, Conditional Expression (35) is satisfied, which is represented by

$$0.1 < ( 1 / Rcnf - 1 / Rcnr ) / ( 1 / Rynf - 1 / Rynr ) < 3. \qquad ( 35 )$$

### APPENDIX 33

The variable magnification optical system according to Appendix 30, in which the focus group consists of one negative lens and two positive lenses.

### APPENDIX 34

The variable magnification optical system according to Appendix 33, in which a positive lens closest to the image side in the focus group is an aspherical lens, and in a case where a paraxial curvature radius of a surface of the aspherical lens on the object side is denoted by Rcpf, a paraxial curvature radius of a surface of the aspherical lens on the image side is denoted by Rcpr, a curvature radius of the surface of the aspherical lens on the object side at a position of a maximum effective diameter is denoted by Rypf, and a curvature radius of the surface of the aspherical lens on the image side at a position of a maximum effective diameter of the image side surface is Rypr, Conditional Expression (36) is satisfied, which is represented by

$$- 120 < ( 1 / Rcpf - 1 / Rcpr ) / ( 1 / Rypf - 1 / Rypr ) < - 3. \qquad ( 36 )$$

### APPENDIX 35

The variable magnification optical system according to Appendix 30, in which the focus group consists of one positive lens and one negative lens.

### APPENDIX 36

The variable magnification optical system according to Appendix 30, in which the focus group consists of one negative lens.

### APPENDIX 37

The variable magnification optical system according to Appendix 36, in which the negative lens of the focus group is an aspherical lens, and in a case where a paraxial curvature radius of a surface of the aspherical lens on the object side is denoted by Rcsnf, a paraxial curvature radius of a surface of the aspherical lens on the image side is Rcsnr, a curvature radius of the surface of the aspherical lens on the object side at a position of a maximum effective diameter is denoted by Rysnf, and a curvature radius of the surface of the aspherical lens on the image side at a position of a maximum effective diameter is denoted by Rysnr, Conditional Expression (37) is satisfied, which is represented by

$$0.1 < ( 1 / Rcsnf - 1 / Rcsnr ) / ( 1 / Rysnf - 1 / Rysnr ) < 3.5 . \qquad ( 37 )$$

### APPENDIX 38

The variable magnification optical system according to any one of Appendices 1 to 29, in which two lens groups among the lens groups included in the intermediate group are focus groups that move by changing a mutual spacing during changing the magnification and during focusing.

### APPENDIX 39

The variable magnification optical system according to Appendix 38, in which, in a case where, out of the two lens groups, a lens group disposed on the object side is referred to as an object side focus group, and a lens group disposed on the image side is referred to as an image side focus group, the object side focus group consists of one negative lens and one positive lens, and the image side focus group consists of one positive lens.

### APPENDIX 40

The variable magnification optical system according to Appendix 39, in which the positive lens of the image side focus group is an aspherical lens, and in a case where a paraxial curvature radius of a surface of the aspherical lens on the object side is denoted by Rcipf, a paraxial curvature radius of a surface of the aspherical lens on the image side is denoted by Rcipr, a curvature radius of the surface of the aspherical lens on the object side at a position of a maximum effective diameter is denoted by Ryipf, and a curvature radius of the surface of the aspherical lens on the image side at a position of a maximum effective diameter is denoted by Ryipr, Conditional Expression (38) is satisfied, which is represented by

$$1 < ( 1 / Rcipf - 1 / Rcipr ) / ( 1 / Ryipf - 1 / Ryipr ) < 100. \qquad ( 38 )$$

### APPENDIX 41

The variable magnification optical system according to Appendix 38, in which, in a case where, out of the two lens groups, a lens group disposed on the object side is referred to as an object side focus group, and a lens group disposed on the image side is referred to as an image side focus group, the object side focus group consists of one positive lens and one negative lens, and the image side focus group consists of one negative lens.

### APPENDIX 42

The variable magnification optical system according to Appendix 41, in which the negative lens of the image side focus group is an aspherical lens, and in a case where a paraxial curvature radius of a surface of the aspherical lens on the object side is denoted by Rcinf, a paraxial curvature radius of a surface of the aspherical lens on the image side is Rcinr, a curvature radius of the surface of the aspherical lens on the object side at a position of a maximum effective diameter is denoted by Ryinf, and a curvature radius of the surface of the aspherical lens on the image side at a position of a maximum effective diameter is denoted by Ryinr, Conditional Expression (39) is satisfied, which is represented by

$$0.1 < ( 1 / Rcinf - 1 / Rcinr ) / ( 1 / Ryinf - 1 / Ryinr ) < 3.5 . \qquad ( 39 )$$

### APPENDIX 43

The variable magnification optical system according to any one of Appendices 1 to 42, in which the variable magnification optical system includes a plurality of lens groups that move on the same moving path during changing the magnification from the wide angle end to the telephoto end.

### APPENDIX 44

The variable magnification optical system according to any one of Appendices 1 to 43, in which the intermediate group includes the aperture stop at the position closest to the object side.

### APPENDIX 45

The variable magnification optical system according to any one of Appendices 1 to 44, in which the intermediate group consists of, in order from the object side to the image side, a lens group having a positive refractive power, and a lens group having a negative refractive power, and the final lens group has a positive refractive power.

### APPENDIX 46

The variable magnification optical system according to Appendix 45, in which the final lens group is fixed with respect to an image plane during changing the magnification.

### APPENDIX 47

The variable magnification optical system according to Appendix 46, in which the final lens group consists of one positive lens that is an aspherical lens, and in a case where a paraxial curvature radius of a surface of the aspherical lens on the object side is denoted by RcEpf, a paraxial curvature radius of a surface of the aspherical lens on the image side is denoted by RcEpr, a curvature radius of the surface of the aspherical lens on the object side at a position of a maximum effective diameter is denoted by RyEpf, and a curvature radius of the surface of the aspherical lens on the image side at a position of a maximum effective diameter is denoted by RyEpr, Conditional Expression (40) is satisfied, which is represented by

$$0.1 < \vert ( 1 / RcEpf - 1 / RcEpr ) / ( 1 / RyEpf - 1 / RyEpr ) \vert < 5. \qquad ( 40 )$$

### APPENDIX 48

The variable magnification optical system according to Appendix 45, in which the final lens group moves during changing the magnification.

### APPENDIX 49

The variable magnification optical system according to any one of Appendices 1 to 44, in which the intermediate group consists of, in order from the object side to the image side, a lens group having a positive refractive power, a lens group having a positive refractive power, and a lens group having a negative refractive power, and the final lens group has a positive refractive power.

### APPENDIX 50

The variable magnification optical system according to any one of Appendices 1 to 44, in which the intermediate group consists of, in order from the object side to the image side, a lens group having a positive refractive power, a lens group having a positive refractive power, and a lens group having a positive refractive power, and the final lens group has a negative refractive power.

### APPENDIX 51

The variable magnification optical system according to any one of Appendices 1 to 44, in which the intermediate group consists of, in order from the object side to the image side, a lens group having a positive refractive power, a lens group having a negative refractive power, and a lens group having a negative refractive power, and the final lens group has a positive refractive power.

### APPENDIX 52

The variable magnification optical system according to any one of Appendices 1 to 44, in which the intermediate group consists of, in order from the object side to the image side, a lens group having a positive refractive power, a lens group having a positive refractive power, a lens group having a positive refractive power, and a lens group having a positive refractive power, and the final lens group has a negative refractive power.

### APPENDIX 53

The variable magnification optical system according to any one of Appendices 1 to 44, in which the intermediate group consists of, in order from the object side to the image side, a lens group having a positive refractive power, a lens group having a positive refractive power, a lens group having a negative refractive power, and a lens group having a positive refractive power, and the final lens group has a negative refractive power.

### APPENDIX 54

The variable magnification optical system according to any one of Appendices 1 to 44, in which the intermediate group consists of, in order from the object side to the image side, a lens group having a positive refractive power, a lens group having a positive refractive power, a lens group having a negative refractive power, and a lens group having a negative refractive power, and the final lens group has a positive refractive power.

### APPENDIX 55

The variable magnification optical system according to any one of Appendices 1 to 44, in which the intermediate group consists of, in order from the object side to the image side, a lens group having a positive refractive power, a lens group having a positive refractive power, a lens group having a negative refractive power, a lens group having a negative refractive power, and a lens group having a positive refractive power, and the final lens group has a negative refractive power.

### APPENDIX 56

The variable magnification optical system according to any one of Appendices 49 to 55, in which the final lens group moves during changing the magnification.

### APPENDIX 57

An imaging apparatus comprising the variable magnification optical system according to any one of Appendices 1 to 56.

All documents, patent applications, and technical standards described in the present specification are incorporated in the present specification by reference to the same extent as in a case where individual documents, patent applications, and technical standards are specifically and individually indicated to be incorporated by reference.

What is claimed is:

1. A variable magnification optical system consisting of, in order from an object side to an image side, a first lens group having a positive refractive power, a second lens group having a negative refractive power, an intermediate group, and a final lens group having a refractive power,
wherein the intermediate group consists of one or more and five or fewer lens groups,
during changing magnification, a spacing between the first lens group and the second lens group changes, a spacing between the second lens group and the intermediate group changes, and a spacing between the intermediate group and the final lens group changes,
in a case where the intermediate group consists of a plurality of lens groups, all spacings between adjacent lens groups in the intermediate group change during changing the magnification,
an aperture stop is disposed between a lens surface of the second lens group closest to the image side and a lens surface of the final lens group closest to the object side,
the first lens group includes, in consecutive order from a position closest to the object side to the image side, a first lens that is a negative lens, and a second lens that is a positive lens, and
in a case where a distance on an optical axis from a surface of the first lens on the object side to the aperture stop in a state where an infinite distance object is in focus at a wide angle end is denoted by DDL1STw,
a sum of a distance on the optical axis from the surface of the first lens on the object side to a lens surface of the final lens group closest to the image side and a back focus of the variable magnification optical system as an air conversion distance in the state where the infinite distance object is in focus at the wide angle end is denoted by TLw,
an open F-number in a state where the infinite distance object is in focus at a telephoto end is denoted by Fnot,
a focal length of the variable magnification optical system in the state where the infinite distance object is in focus at the telephoto end is denoted by ft,
a focal length of the variable magnification optical system in the state where the infinite distance object is in focus at the wide angle end is denoted by fw,
the back focus of the variable magnification optical system as the air conversion distance at the wide angle end is denoted by Bfw, and
a maximum half angle of view in the state where the infinite distance object is in focus at the telephoto end is denoted by ot,
Conditional Expressions (1), (2), and (3) are satisfied, which are represented by
$$0 < DDL 1 STw / TLw < 0.5 , \qquad ( 1 )$$
$$0.5 < Fnot / ( ft / fw ) < 1.3 , and \qquad ( 2 )$$
$$0.15 < Bfw / ( ft \times tan ω t ) < 2. \qquad ( 3 )$$

2. The variable magnification optical system according to claim 1,
wherein, in a case where a focal length of the first lens group is denoted by f1, and
a combined focal length of an optical system from the first lens to the aperture stop in the state where the infinite distance object is in focus at the wide angle end is denoted by fL1STw,
Conditional Expression (5) is satisfied, which is represented by
$$- 6.6 < f 1 / fL 1 STw < - 1.5 . \qquad ( 5 )$$

3. The variable magnification optical system according to claim 1,
wherein, in a case where a focal length of the first lens group is denoted by f1, and
a focal length of the first lens is denoted by fL1,
Conditional Expression (6) is satisfied, which is represented by
$$- 0.9 < f 1 / fL 1 < - 0.05 . \qquad ( 6 )$$

4. The variable magnification optical system according to claim 1,
wherein, in a case where a combined focal length of an optical system from the first lens to the aperture stop in the state where the infinite distance object is in focus at the wide angle end is denoted by fL1STw,
Conditional Expression (7) is satisfied, which is represented by
$$- 1.4 < fw / fL 1 STw < - 0.3 . \qquad ( 7 )$$

5. The variable magnification optical system according to claim 1,
wherein, in a case where a spacing on the optical axis between the first lens group and the second lens group in the state where the infinite distance object is in focus at the wide angle end is denoted by DDG12w,
a spacing on the optical axis between the first lens group and the second lens group in the state where the infinite distance object is in focus at the telephoto end is denoted by DDG12t, and
a sum of the distance on the optical axis from the surface of the first lens on the object side to the lens surface of the final lens group closest to the image side and the back focus of the variable magnification optical system as the air conversion distance in the state where the infinite distance object is in focus at the telephoto end is denoted by TLt,
Conditional Expression (10) is satisfied, which is represented by
$$0.1 < \vert DDG 12 w - DDG 12 t \vert / TL t < 0.3 . \qquad ( 10 )$$

6. The variable magnification optical system according to claim 1,
wherein, in a case where a focal length of the first lens group is denoted by f1,
Conditional Expression (11) is satisfied, which is represented by
$$0.2 < DDL 1 STw / f 1 < 0.8 . \qquad ( 11 )$$

7. The variable magnification optical system according to claim 1,
wherein Conditional Expression (13) is satisfied, which is represented by
$$3 < TLw / fw < 8. \qquad ( 13 )$$

8. The variable magnification optical system according to claim 1,
wherein, in a case where a sum of the distance on the optical axis from the surface of the first lens on the object side to the lens surface of the final lens group closest to the image side and the back focus of the variable magnification optical system as the air conversion distance in the state where the infinite distance object is in focus at the telephoto end is denoted by TLt,
Conditional Expression (14) is satisfied, which is represented by
$$1.5 < TLt / ft < 3. \qquad ( 14 )$$

9. The variable magnification optical system according to claim 1,
wherein, in a case where a focal length of the first lens group is denoted by f1,
Conditional Expression (16) is satisfied, which is represented by
$$3 < f 1 / fw < 7. \qquad ( 16 )$$

10. The variable magnification optical system according to claim 1,
wherein, in a case where a focal length of the first lens group is denoted by f1, and
a focal length of the second lens group is denoted by f2,
Conditional Expression (17) is satisfied, which is represented by
$$3 < f 1 / ( - f 2 ) < 9. \qquad ( 17 )$$

11. The variable magnification optical system according to claim 1,
wherein, in a case where a focal length of the first lens group is denoted by f1,
Conditional Expression (19) is satisfied, which is represented by
$$1.8 < f 1 / {( fw \times ft )}^{1 / 2} < 4.2 . \qquad ( 19 )$$

12. The variable magnification optical system according to claim 1,
wherein Conditional Expression (26) is satisfied, which is represented by
$$2.2 < ft / fw < 4.8 . \qquad ( 26 )$$

13. The variable magnification optical system according to claim 1,
wherein, in a case where a refractive index with respect to a d line for the first lens is denoted by NdL1, and
an Abbe number based on the d line for the first lens is denoted by νdL1,
Conditional Expressions (27), (28), and (29) are satisfied, which are represented by
$$1.8 < NdL 1 < 2.01 , \qquad ( 27 )$$
$$15 < vdL 1 < 45 , and \qquad ( 28 )$$
$$2 < NdL 1 + 0.01 \times vdL 1 < 2.5 . \qquad ( 29 )$$

14. The variable magnification optical system according to claim 1,
wherein, in a case where a refractive index with respect to a d line for the second lens is denoted by NdL2, and
an Abbe number based on the d line for the second lens is denoted by νdL2,
Conditional Expressions (30), (31), and (32) are satisfied, which are represented by
$$1.43 < NdL 2 < 1.81 , \qquad ( 30 )$$
$$45 < vdL 2 < 96 , and \qquad ( 31 )$$
$$2 < NdL 2 + 0.01 \times vdL 2 < 2.5 . \qquad ( 32 )$$

15. The variable magnification optical system according to claim 1,
wherein the variable magnification optical system includes at least one focus group that moves during changing the magnification and during focusing, and
in a case where a focal length of a focus group having a smallest absolute value of a focal length among the focus groups included in the variable magnification optical system is denoted by ffoc, and
a focal length of the intermediate group in the state where the infinite distance object is in focus at the telephoto end is denoted by fMt,
Conditional Expression (33) is satisfied, which is represented by
$$0.3 < \vert ffoc / fMt \vert < 4. \qquad ( 33 )$$

16. The variable magnification optical system according to claim 1,
wherein one lens group among the lens groups included in the intermediate group is a focus group that moves during changing the magnification and during focusing.

17. The variable magnification optical system according to claim 1,
wherein two lens groups among the lens groups included in the intermediate group are focus groups that move by changing a mutual spacing during changing the magnification and during focusing.

18. The variable magnification optical system according to claim 1,
wherein the variable magnification optical system includes a plurality of lens groups that move on the same moving path during changing the magnification from the wide angle end to the telephoto end.

19. The variable magnification optical system according to claim 1,
wherein the intermediate group includes the aperture stop at the position closest to the object side.

20. The variable magnification optical system according to claim 1,
wherein the intermediate group consists of, in order from the object side to the image side, a lens group having a positive refractive power, and a lens group having a negative refractive power, and
the final lens group has a positive refractive power.

21. The variable magnification optical system according to claim 1,
wherein the intermediate group consists of, in order from the object side to the image side, a lens group having a positive refractive power, a lens group having a positive refractive power, and a lens group having a negative refractive power, and
the final lens group has a positive refractive power.

22. The variable magnification optical system according to claim 1,
wherein the intermediate group consists of, in order from the object side to the image side, a lens group having a positive refractive power, a lens group having a positive refractive power, and a lens group having a positive refractive power, and
the final lens group has a negative refractive power.

23. The variable magnification optical system according to claim 1,
wherein the intermediate group consists of, in order from the object side to the image side, a lens group having a positive refractive power, a lens group having a negative refractive power, and a lens group having a negative refractive power, and
the final lens group has a positive refractive power.

24. The variable magnification optical system according to claim 1,
wherein the intermediate group consists of, in order from the object side to the image side, a lens group having a positive refractive power, a lens group having a positive refractive power, a lens group having a positive refractive power, and a lens group having a positive refractive power, and
the final lens group has a negative refractive power.

25. The variable magnification optical system according to claim 1,
wherein the intermediate group consists of, in order from the object side to the image side, a lens group having a positive refractive power, a lens group having a positive refractive power, a lens group having a negative refractive power, and a lens group having a positive refractive power, and
the final lens group has a negative refractive power.

26. The variable magnification optical system according to claim 1,
wherein the intermediate group consists of, in order from the object side to the image side, a lens group having a positive refractive power, a lens group having a positive refractive power, a lens group having a negative refractive power, and a lens group having a negative refractive power, and
the final lens group has a positive refractive power.

27. A variable magnification optical system consisting of, in order from an object side to an image side, a first lens group having a positive refractive power, a second lens group having a negative refractive power, an intermediate group, and a final lens group having a refractive power,
wherein the intermediate group consists of, in order from the object side to the image side, a lens group having a positive refractive power, a lens group having a positive refractive power, a lens group having a negative refractive power, a lens group having a negative refractive power, and a lens group having a positive refractive power,
the final lens group has a negative refractive power.
during changing magnification, a spacing between the first lens group and the second lens group changes, a spacing between the second lens group and the intermediate group changes, a spacing between the intermediate group and the final lens group changes, and all spacings between adjacent lens groups in the intermediate group change,
an aperture stop is disposed between a lens surface of the second lens group closest to the image side and a lens surface of the final lens group closest to the object side,
the first lens group includes, in consecutive order from a position closest to the object side to the image side, a first lens that is a negative lens, and a second lens that is a positive lens,
the final lens group moves during changing the magnification, and
in a case where a distance on an optical axis from a surface of the first lens on the object side to the aperture stop in a state where an infinite distance object is in focus at a wide angle end is denoted by DDL1STw,
a sum of a distance on the optical axis from the surface of the first lens on the object side to a lens surface of the final lens group closest to the image side and a back focus of the variable magnification optical system as an air conversion distance in the state where the infinite distance object is in focus at the wide angle end is denoted by TLw,
an open F-number in a state where the infinite distance object is in focus at a telephoto end is denoted by Fnot,
a focal length of the variable magnification optical system in the state where the infinite distance object is in focus at the telephoto end is denoted by ft,
a focal length of the variable magnification optical system in the state where the infinite distance object is in focus at the wide angle end is denoted by fw,
the back focus of the variable magnification optical system as the air conversion distance at the wide angle end is denoted by Bfw, and
a maximum half angle of view in the state where the infinite distance object is in focus at the telephoto end is denoted by ot,
Conditional Expressions (1), (2), and (3) are satisfied, which are represented by
$$0 < DDL 1 STw / TL w < 0.5 , \qquad ( 1 )$$
$$0.5 < Fnot / ( ft / fw ) < 1.3 , and \qquad ( 2 )$$
$$0.15 < Bfw / ( ft \times tan ω t ) < 2. \qquad ( 3 )$$

28. An imaging apparatus comprising:
the variable magnification optical system according to claim 1.

29. An imaging apparatus comprising:
the variable magnification optical system according to claim 27.
